(19) United States
(12) Patent Application Publication
(10) Pub. No.: US 2018/0121888 A1
(43) Pub. Date: May 3, 2018

(54) System and method for improved vehicle collision damage estimating and repair

(71) Applicant: Patrick Richard O'Reilly, League City, TX (US)

(72) Inventor: Patrick Richard O'Reilly, League City, TX (US)

(21) Appl. No.: 15/732,754

(22) Filed: Dec. 20, 2017

(51) Int. Cl. G06Q 10/00; G06Q 30/02; G06Q 40/08; G06F 17/30; G10L 15/22; G10L 15/26; G10L 15/30

(52) U.S. Cl. CPC G06Q 10/20; G06Q 30/0283; G06Q 40/08; G06F 17/3056; G10L 2015/223; G10L 15/22; G10L 15/265; G10L 15/30; G06F 17/30283

(57) ABSTRACT

A system and method is disclosed for reducing the time to estimate and repair a vehicle damaged in a collision. The system comprises a computer network where at least one component of the network is a portable computing device installed with software for speech activated data entry whereby an outside adjuster makes the estimate by speaking into the device. The method combines speech activated data entry with an iterative and incremental process resulting in real-time comparison of a first estimate to actual repair data for same or similar vehicles suffering same or similar damage under same or similar circumstances. The actual repair data, in the form of the parts and labor hours for the repair, provides a benchmark against which the outside adjuster can compare the first estimate and make an immediate update in the form of a final estimate. The resulting accuracy of the final estimate shortens the time for repair by reducing, or even eliminating, the need for supplemental estimates. After the final estimate is prepared, the damaged vehicle is repaired. The now-repaired vehicle, with its actual parts and labor hours to make the repair, is added to the set of vehicles comprising those suffering same or similar damage under same or similar circumstances to another vehicle that may be damaged sometime in the future; thereby implementing the incremental nature of the invention.

### (A) TITLE OF THE INVENTION

A System and Method for Improved Vehicle Collision Damage Estimating and Repair.

### (B) CROSS-REFERENCES RELATED APPLICATIONS

Not applicable.

### (C) STATEMENT REGARDING FEDERALLY SPONSORED RESEARCH OR DEVELOPMENT

Not applicable.

### (D) NAMES OF THE PARTIES TO A JOINT RESEARCH AGREEMENT

Not applicable.

### (E) REFERENCE TO A “SEQUENCE LISTING”

Not applicable.

### (F) STATEMENT REGARDING PRIOR DISCLOSURES BY THE INVENTOR OR A JOINT INVENTOR

Not applicable.

### (G) BACKGROUND OF THE INVENTION

### 1. Field of the Invention

This invention relates to a system and method for improving the art of estimating the cost to repair vehicle collision damage by eliminating the need for supplemental estimates leading to more economical, efficient, and uniform estimates and reduced time for repairs.

This invention further relates to data entry by speech recognition technology to portable computing devices.

This invention still further relates to computer networks and software for the management of databases which contain text and image data being entered at one or more of a plurality of computer workstations.

This invention still further relates to incremental and iterative data processing to achieve vehicle collision repair estimates of ever increasing accuracy.

### 2. The Current State of the Art

Depending on how the various components of a typical automobile are counted, the number of parts range from about 1,800 to as many as 30,000. Among the 1,800 parts, some are large components, such as the engine, which is installed as a unit during the car-making process but contains thousands of individual pieces itself. For this invention, the number of parts is closer to the 1,800. These are the minor to major parts or assemblage-of-parts, such as a complete engine, a bumper, a fender, or grille, that might be damaged in a collision and repaired or replaced as a component.

The largest component of the cost of auto insurance is the cost of accidents; i.e., the cost for repairing or replacing the damaged property and/or vehicle, and medical care for bodily injury. In addition to the cost to repair or replace the damaged vehicle and for medical care, insurers also must pay for preparing the initial estimate and any supplements. Insurers seek ways to reduce the cost of preparing the initial estimate and supplements. Supplemental estimates occur for many reasons; including insurance adjusters under-estimating claims based on their initial inspections of damaged vehicles. Insurance companies train their adjusters to estimate the repair only on what they see; “if you can't see it, don't write it.” This leads to a significant number of supplements due to unseen damage that the repair shop discovers in the course of tearing down the vehicle for repair.

To reduce cost, some industry commentators have proposed making the estimate after the vehicle is taken to the repair shop. The shop would take photographs, write a preliminary estimate based on a thorough teardown, make a comprehensive parts list, document the unseen damage, and determine the labor hours required to make the repair. After the repair shop made its comprehensive estimate, only then would an adjuster examine the vehicle, perform a post-tear down inspection, and make an independent estimate. This method has the disadvantage of burdening the repair shop with making the initial estimate, extending the time for the determination of repair costs, and causing the insured or owner to wait longer for repair.

In a continuing effort to reduce repair costs, insurance companies often authorize outside adjusters to make their estimates using aftermarket, A/M, or aftermarket certified, A/M Certified, or like kind and quality (LKQ) replacement parts rather than original equipment manufacturer (OEM) parts. Industry experts report that as of 2017, the cost of aftermarket automobile parts are about 25-30 percent less than the same OEM part and LKQ parts as much as 50 percent less.

To reduce cost, industry-wide resources are available, such as subscriber-based publications, which list makes and models of cars and the parts, labor, and materials needed to fix certain areas of the vehicle. Companies such as Certified Collateral Corporation, Chicago, Ill., ALL DATA, LLC, Elk Grove, Calif., Web-Est Inc., Oldsmar, Fla., and Mitchell International, Inc., San Diego, Calif., provide software to assist outside adjusters and repair shops in estimating collision repairs. While helpful, they have deficiencies. They are built on the foundation of conventional repair estimation; fitting all types of damage into one set of estimations. It is cumbersome to have to refer to such publications and then complete the estimate. Although such systems promote more uniformity for those that rely on the same publication, the publications lag behind the introduction of new models or production changes, at least until the publisher has the chance to update and publish a new version.

The policy of only estimating what can be seen leads to a significant number of supplements due to unseen or unforeseeable damage that the repair shop discovers in the course of tearing down the vehicle for repair. Supplements are a continuing source of additional cost for automobile insurers and consumers. Industry data shows that over the past few years the percentage of collision estimate supplements has remained constant with only about 50-55% of estimates requiring no supplement, 30-35% requiring one supplement, and some 10-20% requiring two or more supplements before the repair is completed. Cost for supplements contribute to the number of total loss vehicles increasing over the recent past due to aging vehicles and market pricing, including the cost of estimation, unfavorable to repair versus total loss.

The insurance industry tracks and summarizes claim costs for various makes and models of motor vehicles. Claim costs are collected for hundreds of passenger vehicles and averaged by vehicle class and curb weight. Vehicular insurance loss experts have determined that similar vehicle makes and models, even across manufacturers, can generally be expected to have similar losses under similar damage-causing circumstances.

Air-bag deployment can be used as a bench-mark for the severity of a collision. Front air bags are generally designed to deploy in moderate to severe frontal or near-frontal crashes, which are defined as crashes that are equivalent to hitting a solid, fixed barrier at 8 to 14 mph or higher. This is equivalent to striking a parked car of similar size at about 16 to 28 mph or higher. Assuming no abnormality in their triggering mechanisms, the air-bags failure to deploy can be used to compare the severity of a collision when vehicles have similar curb weights and the collision circumstances are similar.

An important consideration in estimating repair cost is determining the damaged vehicle's condition before the collision. Insurers are obligated to restore the damaged vehicle to its condition just before the collision, and no more. A pre-collision condition determination must always be done as part of a collision repair estimate.

Estimating the cost for repair of vehicle collision damage typically involves the outside adjuster walking around the vehicle to see what is visibly damaged or to assess its condition. While doing so, the outside adjuster takes note of body, electrical, mechanical, and structural damage that he or she can see and enters the data into a portable or desk top computer using traditional point-and-click technology. The process is slow and subject to error because the outside adjuster must visualize the damage, determine the required repairs, identify part sources, and estimate labor hours while simultaneously ensuring that he or she is entering the data into the correct fields.

Speech recognition technology is a practical means of data entry where hands and eyes must remain free to do a primary task. It permits data entry without the worker having to look down at a keypad, keyboard, or screen. By adding speech as an input option, outside adjusters can be freed from the dependence of touch screen or mouse and keyboard data entry.

There are two types of speech recognition software applications. The first is command and control. This application is used to recognize a command. An example is one in which the speaker says a particular phrase or number and the computer takes the correct action or enters the correct data. The second is dictation. Here, the application converts spoken words into text; for example, like dictation. This invention uses speech activated data entry in a command and control format. Nevertheless, the dictation format could be used to practice the invention as described herein.

Speech activated data entry software based on command and control type speech is well-known to those skilled in the art of software applications. Among the many applications available for use with handheld and portable computers are: Nuance Dragon® NaturallySpeaking Premium 12; Windows Speech Recognition; Google Voice Search; Dragon® NaturallySpeaking Premium; Tazti by Voice Tech Group, Inc.

There is heretofore an untapped source of actual repair data; including, but not limited to, parts list, parts sources, parts costs, labor hours for repair, labor hours for refinishing, and total repair cost, for every vehicle repaired by a reputable shop after collision damage. The larger repair shops routinely list every part used in the repair, breakdown the repair hours for each major repaired component, and do the same for the refinishing hours. In light of the industry's guidance, “if you can't see it, don't write it,” for identical or similar vehicles suffering identical or similar damage under identical or similar circumstances the actual repair data can serve as a benchmark for the outside adjuster to immediately and iteratively update his or her collision repair estimate. It is understood that the parts costs and hourly labor rates used in any actual repair must be updated to current and regional costs.

As more and more vehicles are repaired, the source of actual repair data is incrementally increased and over time will result in a database containing identical vehicles suffering identical damage under identical circumstances as compared to the vehicle being currently estimated. For the outside adjuster, this provides an ever increasingly accurate and detailed source of actual repair data for which to compare collision repair estimates.

Heretofore there has been no motivation to combine speech recognition data entry and incremental and iterative data processing to increase the accuracy of the cost estimates for vehicle collision repair, reduce the time for repair, reduce, or even eliminate, the need for supplements, and to overall decrease the time and cost of repair.

Although there are many systems and methods for estimating the cost of repairing vehicle collision damage, there is a need in the art for more consistency, efficiency, and uniformity in estimations, less time consuming and cumbersome repair estimation, as well as easier, quicker, and less expensive methodology, including training. All having the goal of reducing, or even eliminating, the need for supplements.

### 3. Description of the Related Art Including Information Disclosed Under 37 C.F.R. 1.97 and 1.98

Although U.S. patents and published patent applications are known which disclose various apparatus, methods, and systems for preparing cost estimates for the repair of collision damage to vehicles, none of them disclose using speech recognition technology for data entry combined with incremental and iterative interactive databases to accurately, efficiently, and economically enter the information required to estimate the repair parts and labor, calculate the total repair cost, guide the craftsman, and to prepare a report for the customer, insurer, or repair facility. No prior art anticipates, nor in combination renders obvious, the invention described herein.

### (H) BRIEF SUMMARY OF THE INVENTION

It is an object of this invention to provide a system and method to quickly, efficiently, and accurately estimate the cost to repair a vehicle's collision damage in the first instance, which system and method do not have the disadvantages of the prior art. In particular, it is an object of the present invention to provide a system and method by which an outside adjuster can quickly, efficiently, and accurately estimate the cost to repair collision damage to a vehicle using speech recognition technology for data entry; including, assessing the parts required, the source of the parts, i.e., OEM, A/M, A/M Certified, or LKQ, and estimating the parts cost and labor time for repairing the damage. Then passing the report to the repair shop, and having the shop repair the vehicle. After the outside adjuster's estimation report is passed to the repair shop, the shop makes the repair thereby resulting in an actual cost for the repair. The actual parts, labor and cost for the repairs are entered into a database for use by future outside adjusters.

It is a further object of this invention to build a vehicle estimating database whereby an inside adjuster's previously entered data—VIN, make, model, year of manufacture, curb weight, odometer reading, velocity of impact, whether or not one or more of the air-bags deployed, the type of collision, the location of damage, such as without limitation, the fender, door, hood, or other vehicle body part, and collision severity—is combined with; (1) the outside adjuster's estimate of the repair; including, but not limited to, the parts required, the source of the parts, i.e., OEM, A/M, A/M Certified, or LKQ, the parts cost and labor type and time for repairing the damage of the car and, (2) a repair shop's experiential repair results and the actual cost for the repair.

It is still a further object of this invention to permit an outside adjuster to compare his or her collision damage repair estimate in real-time to the historical data contained in the vehicle estimating database, to allow the outside adjuster to iteratively amend the estimate, thereby reducing or eliminating the need for supplements.

It is still a further object of this invention to use an incremental process to build an ever more comprehensive vehicle estimating database, which is updated as claims data and collision details are entered by the inside adjuster, estimates are created by the outside adjusters using speech recognition technology for data entry and, in real-time, compared to the historical repair estimate and adjusted accordingly, and then the revised estimates are entered into the database by the outside adjusters. The corresponding actual experiential repair data and costs are also entered into the database by shop technicians, and this data entry is repeated iteratively with the aim of approaching the desired goal of supplement-free collision damage repair estimating.

It is still a further object of this invention that the outside adjuster's first repair estimate is uploaded to a database. The database also contains the actual repairs parts, labor, and cost of repair for a number of repaired vehicles cross-referenced to each repaired vehicle's make, model, year, curb weight, odometer reading, speed of impact, whether or not the air-bags deployed, and location of damage, such as without limitation, the fender, door, hood, or other vehicle body part. Utilizing a ranking system, an algorithm objectively ranks the vehicles with prior actual repairs to the damaged vehicle being estimated. The objective ranking creates a set of identical or similar vehicles suffering identical or similar damage under identical or similar circumstances. The objective ranking is a number ranging from 0 to 100; with 0 being no similarity in physical attributes, damage, and circumstances and 100 being an identical vehicle suffering identical damage under identical circumstances.

It is still a further object of this invention that in real-time, the system then offers one or more of the vehicles with the closest physical attributes and collision history and with actual parts, labor, and repair costs to the vehicle being estimated by the outside adjuster. The outside adjuster then updates the first repair estimate, in real-time, based on the actual repair parts, labor, and costs of one or more of identical or similar vehicles suffering identical or similar damage under identical or similar circumstances, thus permitting the outside adjuster to make immediate corrections, so as to insure a higher level of estimating accuracy as compared to the current state of the art. The updated estimate becomes the final repair estimate.

In the preferred embodiment, a person skilled in the art of vehicle damage repair estimation enters data to a portable computing device by speech recognition software in a structured form that is used by other software to accurately, uniformly, and efficiently identify and determine the replacement parts required for the repair, the activities and labor necessary to make the repair, the total shop time, thereby creating a first estimate of the cost for the repair. The software then immediately compares the first estimate results to a database containing actual repair costs for other vehicles, giving the outside adjuster the opportunity to create a final estimate more accurate than the first estimate, and then makes the final estimate for repair of the vehicle in less time and at less cost.

The invention described herein will substantially reduce or even eliminate the need for estimating supplements; thereby resulting in more economical, efficient, and timely restoration of a vehicle to its condition before the event leading to damage.

### (I) BRIEF DESCRIPTION OF THE SEVERAL VIEWS OF THE DRAWINGS

FIG. 1 shows an outside adjuster using speech activated data entry to enter the data required for his collision repair estimate.

FIG. 2 is a depiction of the preferred embodiment of the system for estimating the cost to repair a damaged vehicle resulting in a repair with few or no supplemental estimates.

FIG. 3 is a flow chart showing the method of speech activated data entry collision estimating.

FIG. 4 is a number of commercially available vehicles that could serve as Comparator Vehicles for the hypothetical 2017 O'Reilly Limited 4-Door Sedan.

FIG. 5 shows a group of parts comprising the bumper for the hypothetical 2017 O'Reilly Limited 4-Door Sedan.

FIG. 5A is a price list for the OEM, A/M Certified, and LKQ replacement parts of the automobile body components comprising the bumper shown in FIG. 5.

FIG. 6 shows a group of parts comprising the front grille for the hypothetical 2017 O'Reilly Limited 4-Door Sedan.

FIG. 6A is a price list for the OEM, A/M Certified, and LKQ replacement parts of the automobile body components comprising the grille shown in FIG. 6.

FIG. 7 shows a group of parts comprising the hood for the hypothetical 2017 O'Reilly Limited 4-Door Sedan.

FIG. 7A is a price list for the OEM, A/M Certified, and LKQ replacement parts of the automobile body components comprising the hood shown in FIG. 7.

FIG. 8 shows a group of parts comprising the front headlight assemblies for the hypothetical 2017 O'Reilly Limited 4-Door Sedan.

FIG. 8A is a price list for the OEM, A/M Certified, and LKQ replacement parts of the automobile body components comprising the front headlight assemblies shown in FIG. 8.

FIG. 9 shows a group of parts comprising the front suspension for the hypothetical 2017 O'Reilly Limited 4-Door Sedan.

FIG. 9A is a price list for the OEM, A/M Certified, and LKQ replacement parts of the automobile body components comprising the front suspension shown in FIG. 9.

FIG. 10 shows the first page of a repair estimate report for the hypothetical 2017 O'Reilly Limited 4-Door Sedan according to the prior art.

FIG. 10A shows the second page of a repair estimate report for the hypothetical 2017 O'Reilly Limited 4-Door Sedan according to the prior art.

FIG. 10B shows the third page of a repair estimate report for the hypothetical 2017 O'Reilly Limited 4-Door Sedan according to the prior art.

FIG. 10C shows the fourth page of a repair estimate report for the hypothetical 2017 O'Reilly Limited 4-Door Sedan according to the prior art.

FIG. 11 shows the first page of a repair estimate report for the hypothetical 2017 O'Reilly Limited 4-Door Sedan according to the system and method described by the invention herein.

FIG. 11A shows the second page of a repair estimate report for the hypothetical 2017 O'Reilly Limited 4-Door Sedan according to the system and method described by the invention herein.

FIG. 11B shows the third page of a repair estimate report for the hypothetical 2017 O'Reilly Limited 4-Door Sedan according to the system and method described by the invention herein.

FIG. 11C shows the fourth page of a repair estimate report for the hypothetical 2017 O'Reilly Limited 4-Door Sedan according to the system and method described by the invention herein.

FIG. 11D shows the fifth page of a repair estimate report for the hypothetical 2017 O'Reilly Limited 4-Door Sedan according to the system and method described by the invention herein.

FIG. 11E shows the sixth page of a repair estimate report for the hypothetical 2017 O'Reilly Limited 4-Door Sedan according to the system and method described by the invention herein.

FIG. 11F shows the seventh page of a repair estimate report for the hypothetical 2017 O'Reilly Limited 4-Door Sedan according to the system and method described by the invention herein.

FIG. 11G shows the eighth page of a repair estimate report for the hypothetical 2017 O'Reilly Limited 4-Door Sedan according to the system and method described by the invention herein.

FIG. 12 shows the criteria for ranking a comparator vehicle against a vehicle whose damage is being estimated to repair.

FIG. 13 shows the comparative data and the calculated rank for 6 comparator vehicles relative to the 2017 O'Reilly Limited 4-Door Sedan.

FIG. 14 shows the 2017 O'Reilly Limited 4-Door Sedan before and after repair.

FIG. 15 shows the first page of the report for the actual parts, labor and cost to repair the 2016 Comparator 3 Luxury 4-Door Sedan.

FIG. 15A shows the second page of the report for the actual parts, labor and cost to repair the 2016 Comparator 3 Luxury 4-Door Sedan.

FIG. 15B shows the third page of the report for the actual parts, labor and cost to repair the 2016 Comparator 3 Luxury 4-Door Sedan.

FIG. 15C shows the fourth page of the report for the actual parts, labor and cost to repair the 2016 Comparator 3 Luxury 4-Door Sedan.

FIG. 15D shows the fifth page of the report for the actual parts, labor and cost to repair the 2016 Comparator 3 Luxury 4-Door Sedan.

FIG. 15E shows the sixth page of the report for the actual parts, labor and cost to repair the 2016 Comparator 3 Luxury 4-Door Sedan.

FIG. 15F shows the seventh page of the report for the actual parts, labor and cost to repair the 2016 Comparator 3 Luxury 4-Door Sedan.

FIG. 15G shows the eighth page of the report for the actual parts, labor and cost to repair the 2016 Comparator 3 Luxury 4-Door Sedan.

FIG. 16 shows a group of parts comprising the bumper for the 2016 Comparator 3 Luxury 4-Door Sedan.

FIG. 16A is a price list for the OEM, A/M Certified, and LKQ replacement parts of the automobile body components comprising the bumper shown in FIG. 16.

FIG. 17 shows a group of parts comprising the front grille for the 2016 Comparator 3 Luxury 4-Door Sedan.

FIG. 17A is a price list for the OEM, A/M Certified, and LKQ replacement parts of the automobile body components comprising the grille shown in FIG. 17.

FIG. 18 shows a group of parts comprising the hood for the 2016 Comparator 3 Luxury 4-Door Sedan.

FIG. 18A is a price list for the OEM, A/M Certified, and LKQ replacement parts of the automobile body components comprising the hood shown in FIG. 18.

FIG. 19 shows a group of parts comprising the front headlight assemblies for the 2016 Comparator 3 Luxury 4-Door Sedan.

FIG. 19A is a price list for the OEM, A/M Certified, and LKQ replacement parts of the automobile body components comprising the front headlight assemblies shown in FIG. 19.

FIG. 20 shows a group of parts comprising the front suspension for the 2016 Comparator 3 Luxury 4-Door Sedan.

FIG. 20A is a price list for the OEM, A/M Certified, and LKQ replacement parts of the automobile body components comprising the front suspension shown in FIG. 20.

FIG. 21 shows typical Repair Work Descriptions, corresponding Repair Work Abbreviations, Collision Estimating Labor Rates for 2017, Collision Repair Labor Rates for 2017, and typical Repair Operations and corresponding Repair Operation Abbreviations.

FIG. 22 shows the first page of the report for the actual parts, labor and cost to repair the 2017 O'Reilly Limited 4-Door Sedan.

FIG. 22A shows the second page of the report for the actual parts, labor and cost to repair the 2017 O'Reilly Limited 4-Door Sedan.

FIG. 22B shows the third page of the report for the actual parts, labor and cost to repair the 2017 O'Reilly Limited 4-Door Sedan.

FIG. 22C shows the fourth page of the report for the actual parts, labor and cost to repair the 2017 O'Reilly Limited 4-Door Sedan.

FIG. 22D shows the fifth page of the report for the actual parts, labor and cost to repair the 2017 O'Reilly Limited 4-Door Sedan.

FIG. 22E shows the sixth page of the report for the actual parts, labor and cost to repair the 2017 O'Reilly Limited 4-Door Sedan.

FIG. 22F shows the seventh page of the report for the actual parts, labor and cost to repair the 2017 O'Reilly Limited 4-Door Sedan.

FIG. 22G shows the eighth page of the report for the actual parts, labor and cost to repair the 2017 O'Reilly Limited 4-Door Sedan.

FIG. 23 is an image of the “Home Page” screen for speech activated collision estimating.

FIG. 23A is an image of the “Estimating Phrases” Screen.

FIG. 23B is an image of the “Labor Cost” Screen.

FIG. 24 is an image of the “Contacts” Screen.

FIG. 25 is an image of the “Insurance” Screen.

FIG. 26 is an image of the “Vehicle” Screen.

FIG. 27 is an image of the “VIN Check” Screen.

FIG. 28 is an image of the “VIN Expander” Screen.

FIG. 29 is an image of the first page of the “Vehicle Options” Screen.

FIG. 29A is an image of the second page of the “Vehicle Options” Screen.

FIG. 30 is an image of the “Vehicle Condition” Screen.

FIG. 31 is an image of the “Collision Details” Screen.

FIG. 32 is an image of the “Damage Location” Screen.

FIG. 33 is an image of the “Damage Severity” Screen.

FIG. 34 is an image of the “Damaged Areas” Screen.

FIG. 35 is an image of the “Expand Damaged Areas” Screen.

FIG. 36 is an image of the “Expand Components” Screen.

FIG. 37 is an image of the “Bumper & Components” Screen for a 2017 O'Reilly Limited 4-Door Sedan.

FIG. 38 is an image of the “Grille & Components” Screen for a 2017 O'Reilly Limited 4-Door Sedan.

FIG. 39 is an image of the “Hood & Components” Screen for a 2017 O'Reilly Limited 4-Door Sedan.

FIG. 40 is an image of the “Headlamp Components” Screen for a 2017 O'Reilly Limited 4-Door Sedan.

FIG. 41 is an image of the “Suspension Components” Screen for a 2017 O'Reilly Limited 4-Door Sedan.

FIG. 42 is an image of the “Repair Estimate” Screen for a 2017 O'Reilly Limited 4-Door Sedan.

FIG. 43 is an image of the “Bumper Repair Estimate” Screen for a 2017 O'Reilly Limited 4-Door Sedan.

FIG. 44 is an image of the “Grille Repair Estimate” Screen for a 2017 O'Reilly Limited 4-Door Sedan.

FIG. 45 is an image of the “Headlamp Repair Estimate” Screen for a 2017 O'Reilly Limited 4-Door Sedan.

FIG. 46 is an image of the “Hood Repair Estimate” Screen for a 2017 O'Reilly Limited 4-Door Sedan.

FIG. 47 is an image of the first page of the “First Estimate Report” Screen for a 2017 O'Reilly Limited 4-Door Sedan.

FIG. 47A is an image of the second page of the “First Estimate Report” Screen for a 2017 O'Reilly Limited 4-Door Sedan.

FIG. 47B is an image of the third page of the “First Estimate Report” Screen for a 2017 O'Reilly Limited 4-Door Sedan.

FIG. 47C is an image of the fourth page of the “First Estimate Report” Screen for a 2017 O'Reilly Limited 4-Door Sedan.

FIG. 48 is an image of the “Comparator Vehicles” Screen for a 2017 O'Reilly Limited 4-Door Sedan.

FIG. 49 is an image of the first page of the “Comparator Repair Cost” Screen for a 2016 Comparator 3 Luxury 4-Door Sedan.

FIG. 49A is an image of the second page of the “Comparator Repair Cost” Screen for a 2016 Comparator 3 Luxury 4-Door Sedan.

FIG. 49B is an image of the third page of the “Comparator Repair Cost” Screen for a 2016 Comparator 3 Luxury 4-Door Sedan.

FIG. 49C is an image of the fourth page of the “Comparator Repair Cost” Screen for a 2016 Comparator 3 Luxury 4-Door Sedan.

FIG. 49D is an image of the fifth page of the “Comparator Repair Cost” Screen for a 2016 Comparator 3 Luxury 4-Door Sedan.

FIG. 49E is an image of the sixth page of the “Comparator Repair Cost” Screen for a 2016 Comparator 3 Luxury 4-Door Sedan.

FIG. 49F is an image of the seventh page of the “Comparator Repair Cost” Screen for a 2016 Comparator 3 Luxury 4-Door Sedan.

FIG. 49G is an image of the eighth page of the “Comparator Repair Cost” Screen for a 2016 Comparator 3 Luxury 4-Door Sedan.

FIG. 50 is an image of the “Final Bumper Repair Estimate” Screen for a 2017 O'Reilly Limited 4-Door Sedan.

FIG. 51 is an image of the “Final Grille Repair Estimate” Screen for a 2017 O'Reilly Limited 4-Door Sedan.

FIG. 52 is an image of the “Final Headlamp Repair Estimate” Screen for a 2017 O'Reilly Limited 4-Door Sedan.

FIG. 53 is an image of the “Final Hood Repair Estimate” Screen for a 2017 O'Reilly Limited 4-Door Sedan.

FIG. 54 is an image of the “Final Suspension Repair Estimate” Screen for a 2017 O'Reilly Limited 4-Door Sedan.

FIG. 55 is an image of the first page of the “Final Estimate Report” Screen for a 2017 O'Reilly Limited 4-Door Sedan.

FIG. 55A is an image of the second page of the “Final Estimate Report” Screen for a 2017 O'Reilly Limited 4-Door Sedan.

FIG. 55B is an image of the third page of the “Final Estimate Report” Screen for a 2017 O'Reilly Limited 4-Door Sedan.

FIG. 55C is an image of the fourth page of the “Final Estimate Report” Screen for a 2017 O'Reilly Limited 4-Door Sedan.

FIG. 55D is an image of the fifth page of the “Final Estimate Report” Screen for a 2017 O'Reilly Limited 4-Door Sedan.

FIG. 55E is an image of the sixth page of the “Final Estimate Report” Screen for a 2017 O'Reilly Limited 4-Door Sedan.

FIG. 55F is an image of the seventh page of the “Final Estimate Report” Screen for a 2017 O'Reilly Limited 4-Door Sedan.

FIG. 56 is an image of the first page of the “Collision Repair Report” Screen for a 2017 O'Reilly Limited 4-Door Sedan.

FIG. 56A is an image of the second page of the “Collision Repair Report” Screen for a 2017 O'Reilly Limited 4-Door Sedan.

FIG. 56B is an image of the third page of the “Collision Repair Report” Screen for a 2017 O'Reilly Limited 4-Door Sedan.

FIG. 56C is an image of the fourth page of the “Collision Repair Report” Screen for a 2017 O'Reilly Limited 4-Door Sedan.

FIG. 56D is an image of the fifth page of the “Collision Repair Report” Screen for a 2017 O'Reilly Limited 4-Door Sedan.

FIG. 56E is an image of the sixth page of the “Collision Repair Report” Screen for a 2017 O'Reilly Limited 4-Door Sedan.

FIG. 56F is an image of the seventh page of the “Collision Repair Report” Screen for a 2017 O'Reilly Limited 4-Door Sedan.

FIG. 56G is an image of the eighth page of the “Collision Repair Report” Screen for a 2017 O'Reilly Limited 4-Door Sedan.

### (J) DETAILED DESCRIPTION OF THE INVENTION

1. Glossary

As used herein, unless used otherwise, the terms or abbreviations in this Glossary have the following meanings:
2016 Comparator 3 Luxury 4-Door Sedan or 2016 Comparator 3: A hypothetical vehicle repaired after suffering same or similar damage to the hypothetical 2017 O'Reilly Limited 4-Door Sedan under same or similar circumstances.
2017 O'Reilly Limited 4-Door Sedan or 2017 O'Reilly: A hypothetical vehicle suffering damage in a front-end in a collision.
Aftermarket Parts: New replacement parts not made by an Original Equipment Manufacturer.
Algorithm: As used herein, an algorithm is a set of well-defined steps for performing the task in the manner described in the specification and claims.
A/M: Abbreviation for Aftermarket parts.
A/M Certified: Aftermarket parts certified for suitability and quality by organizations such as the Certified Automotive Parts Association (CAPA) or NSF International (NSF).
Claim: Any request or demand for payment under the terms of the insurance policy to cover an incurred loss.
Comparator Vehicle: A vehicle actually repaired after suffering collision damage. The parts, parts costs, parts types, labor hours, and labor costs are known.
Estimate: Based on inspection of a damaged vehicle, the written estimate made by an adjuster regarding the cost required to restore the vehicle to its condition immediately prior to the loss.
Inside Adjuster: A person employed by an insurance company as an employee or independent contractor stationed in the office who typically takes information online or by telephone relating to an insured's claim.
LKQ: An abbreviation for Like Kind and Quality. LKQ refers to parts salvaged from a vehicle.
OEM: Abbreviation for Original Equipment Manufacturer. Refers to replacement parts produced and distributed by the vehicle manufacturer.
Outside Adjuster: A person employed by an insurance company either as an employee or independent contractor that investigates and evaluates claims in the field for vehicle collision damage brought by policyholders and then estimates the cost for parts and labor to repair the damage.
Software: As used herein, software refers to a computer program that executes a set of instructions causing a computing device to perform in the manner as described in the specification and claims.
VIN: An acronym for Vehicle Identification Number, a number unique for every vehicle produced. It identifies a specific vehicle and contains coded information that indicates, among other things, the vehicle's country of origin, manufacturing plant, trim code, drive train, and interior and exterior color. The VIN aids the repair shop in ordering the correct replacement parts and paint color for each car.

2. Overview of the System and Method.

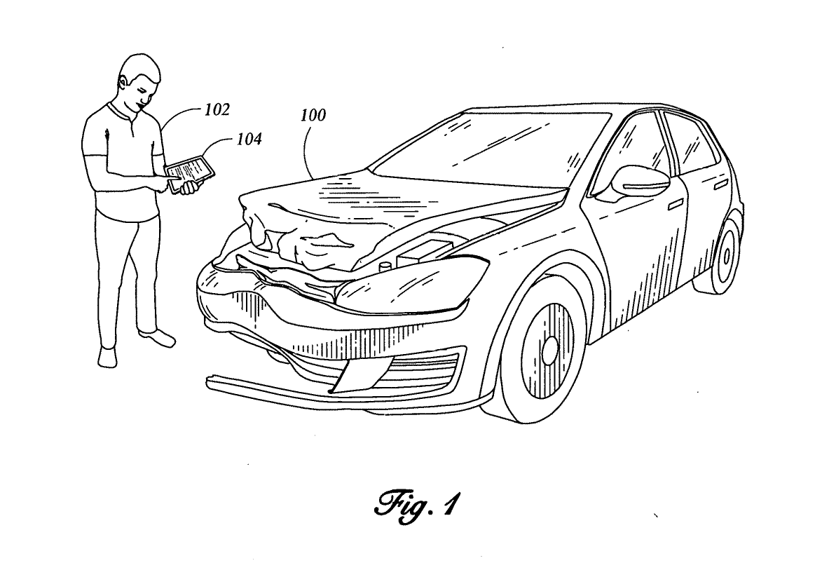

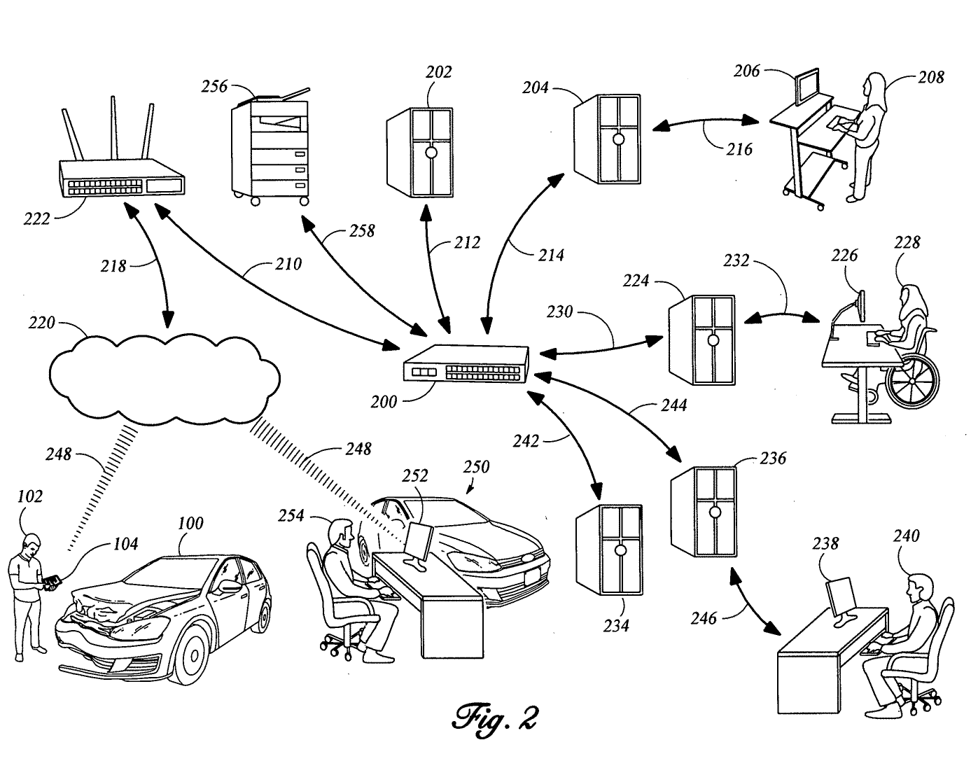

The method of using the system described herein is depicted in FIG. 1, which shows an outside adjuster 102 speaking into a portable computing device 104 installed with speech activated data entry software to estimate the repair cost of vehicle 100 which has been damaged in a front end collision.

3. Detailed Description of the System.

The configuration of a system known to those skilled in the digital networking arts to enable the invention described herein is shown in FIG. 2. An Outside Adjuster 102 is estimating the cost of repair collision damage to vehicle 100 using portable computing device 104. Item 104 is installed with speech activated data entry software, known to persons of skill in the relevant art, to enter the data required to estimate the collision repair costs for Item 100. As further described below, after Outside Adjuster 102 completes his estimate, the estimate is compared in real time to the actual repair costs for identical or similar vehicles suffering identical or similar damage under identical or similar circumstances, thereby providing Outside Adjuster 102 with information needed to immediately correct his estimate based on actual repair costs for past collision repairs.

Referring to FIG. 2, in the preferred embodiment the collision estimating system comprises five computer servers connected in a star topology with associated computer workstations, network switch, internet router, network cables, and portable computing devices as more fully described below.

The five servers are connected as depicted in FIG. 2. The star topology is represented by Network Switch 200 forming a hub. The five servers are connected to Item 200 as follows; Vehicle Information Server 204 is connected to Item 200 by network cable 214, Parts Server 224 is connected to Item 200 with network cable 230, Shop Server 234 is connected to Item 200 with network cable 242, Vehicle Estimating Server 202 is connected to Item 200 with network cable 212, and Labor Server 236 is connected to Item 200 with network cable 244.

Continuing to refer to FIG. 2, Inside Adjuster Workstation 206 is connected to Vehicle Information Server 204 by network cable 216. Parts Workstation 226 is connected to Parts Server 224 by network cable 232. Labor Workstation 238 is connected to Labor Server 236 by network cable 246. Additional hardware permits wireless communication with the collision estimating system. Router 222 is connected to Item 200 by network cable 210. Item 222 is further connected to the Internet 220 by internet provider cable 218.

In the preferred embodiment, the collision estimating system further comprises computing hardware connected to Item 200 using wireless technology known to those skilled in the art. Portable Computing Device 104 and Shop Workstation 252 are connected to Item 220 via wireless connection 248.

The computing devices in the collision estimating system are installed with a network operating system and with database management software. For the preferred embodiment, the invention described herein can be practiced with Microsoft Windows Server as the operating system. The database management software may be any one of IBM DB2, Microsoft Access, Microsoft SQL Server, or Oracle RDBMS. For the preferred embodiment, Microsoft Access is the database management software. Portable computing devices are installed with any one of Nuance Dragon® NaturallySpeaking Premium 12; Windows Speech Recognition; Google Voice Search; Dragon® NaturallySpeaking Premium; or Tazti by Voice Tech Group, Inc. In the preferred embodiment, the portable computing devices are loaded with Windows Speech Recognition software. The individual servers are further populated with a series of data sets and algorithms required to estimate the cost to repair a damaged vehicle by speech activated data entry and the iterative and incremental method described herein. The data sets and algorithms are described more fully below.

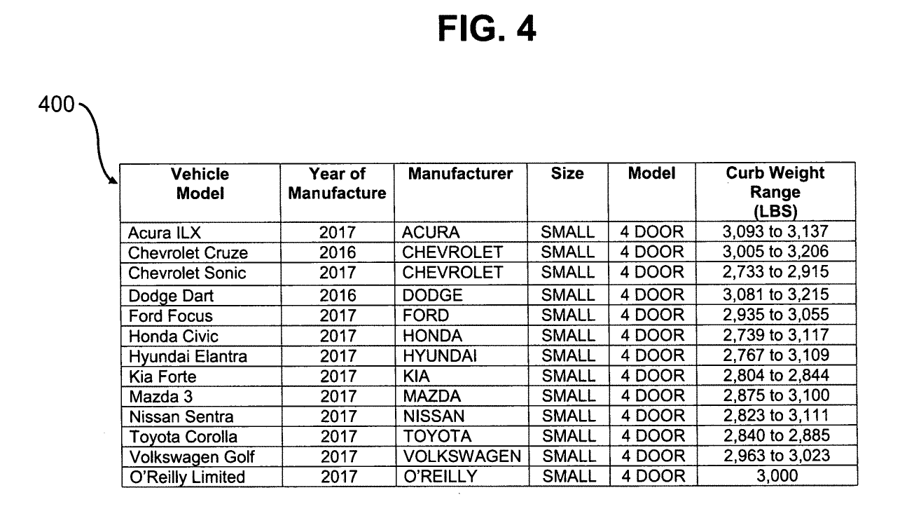

Vehicle Information Server 204 is preloaded with a first data set which comprises a table containing OEMs' models of automobiles they manufacture currently and over the past several years. Industry data shows there are currently some 38 OEMs selling about 650 automobile models in the Unites States. Table 400 in FIG. 4 lists 12 models of automobiles sold by 11 of the OEMs. Table 400 shows the vehicles' model, year of manufacture or model year, manufacturer's name, size, and curb weight range in pounds. Table 400 also shows a thirteenth vehicle; a hypothetical 2017 O'Reilly Limited 4-Door Sedan, manufactured by the hypothetical manufacturer O'Reilly Motors, LLC. The hypothetical 2017 O'Reilly Limited 4-Door Sedan is used throughout the disclosure to show the system and method of estimating the cost to repair an automobile according to the invention described herein. Although Table 400 shows only 11 OEMs and 12 automobile models, it is understood there are at least 38 OEMs selling about 650 models of automobiles in the Unites States and the actual table would contain data for many more vehicles than is shown here. It is also to be understood that the first data set is regularly updated as makes and models are added to a manufacturer's line. The first data set in Table 400 may be entered by Inside Adjuster 208 using Item 206. The data are saved to Item 204 through Item 216.

A second data set is entered by Parts Clerk 228 using Parts Workstation 226 and saved to Parts Server 224. The second data set comprises numerous tables containing images of parts and parts costs in current dollars for each of the manufacturers' vehicle makes, models, and model years, saved in the first data set. FIGS. 5 and 5A show one image and its corresponding table in the second data set. FIG. 5 shows an image of the parts comprising the bumper for the 2017 O'Reilly. Table 538 in FIG. 5A is the parts list and prices for the front bumper and components corresponding to FIG. 5. Table 538 shows the parts' Reference Number, Item Description, and Parts List Price in current dollars for OEM, A/M Certified, and LKQ parts. The parts stored in the second data set for the front bumper of a 2017 O'Reilly are the Front Absorber 500, Bolt, Filler Panel 502, Bracket, Upper 504, Harness 506, Bracket, Lower 508, Bumper Cover 510, Bar, Upper Impact 512, Bar, Lower Impact 514, Bolt, Lower Deflector 516, Retainer, Lamp Bezel 518, Screw, Fog Lamp 520, Trim Cover, Inner 522, Trim Cover, Outer 524, Retainer, Side Bracket 526, Bolt, Lower Impact Bar 528, Lower Deflector 530, Spacer, Lower Deflector 532, Rivet, Side Retainer 534 and Side Retainer 536.

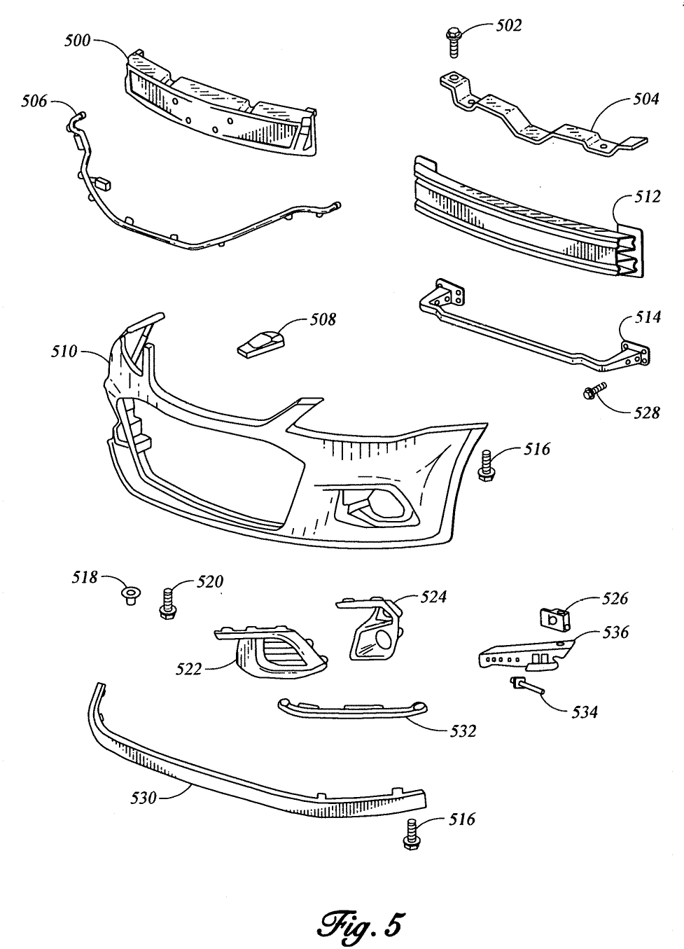

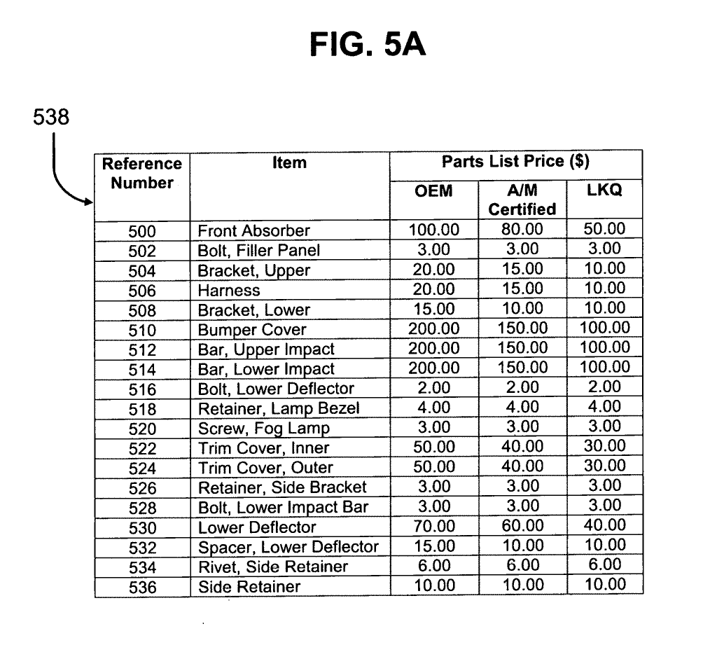

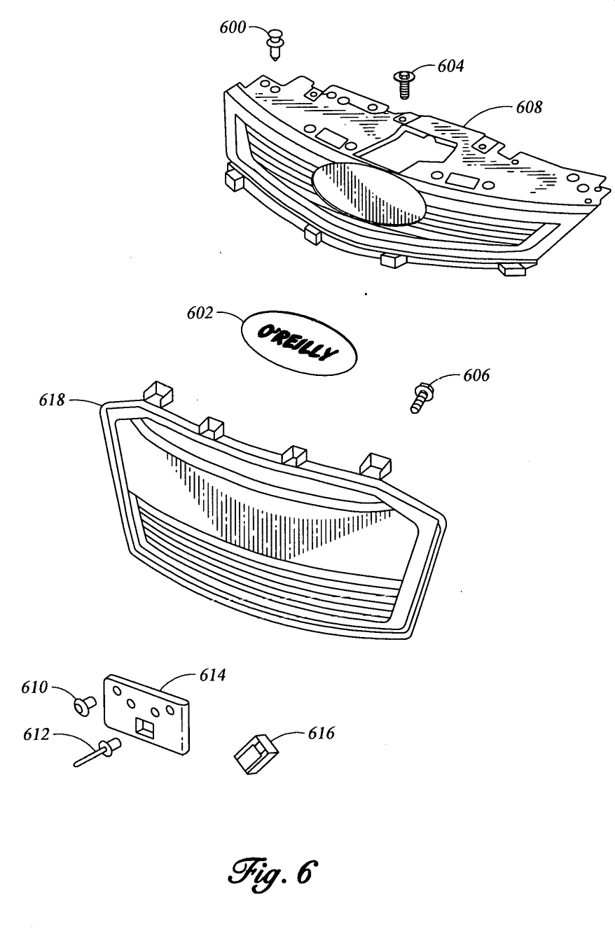

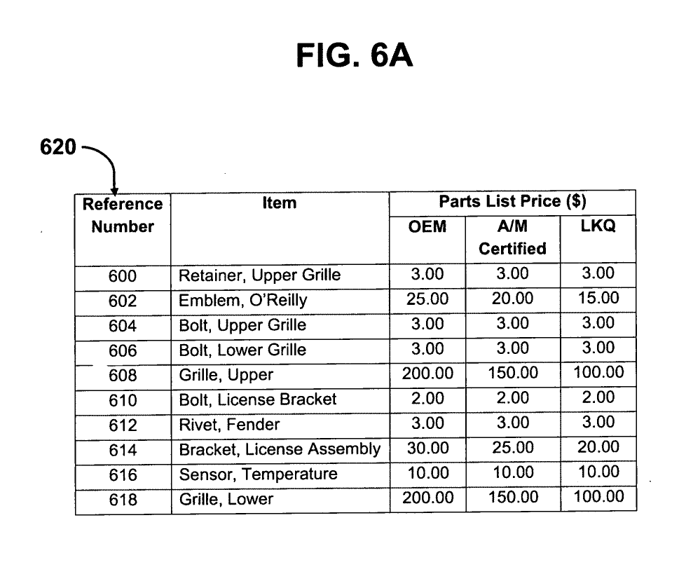

FIGS. 6 and 6A show a second image and its corresponding table in the second data set. FIG. 6 shows an image of the parts comprising the front grille of the 2017 O'Reilly. Table 620 in FIG. 6A is the parts list and prices for the front grille and components corresponding to FIG. 6. Table 620 shows the parts' Reference Number, Item Description, and Parts List Price in current dollars for OEM, A/M Certified, and LKQ parts. The parts stored in the second data set for the front grille of a 2017 O'Reilly are the Retainer, Upper Grille 600, Emblem, O'Reilly 602, Bolt, Upper Grille 604, Bolt, Lower Grille 606, Grille, Upper 608, Bolt, License Bracket 610, Rivet, Fender 612, Bracket, License Assembly 614, Sensor, Temperature 616, and Grille, Lower 618.

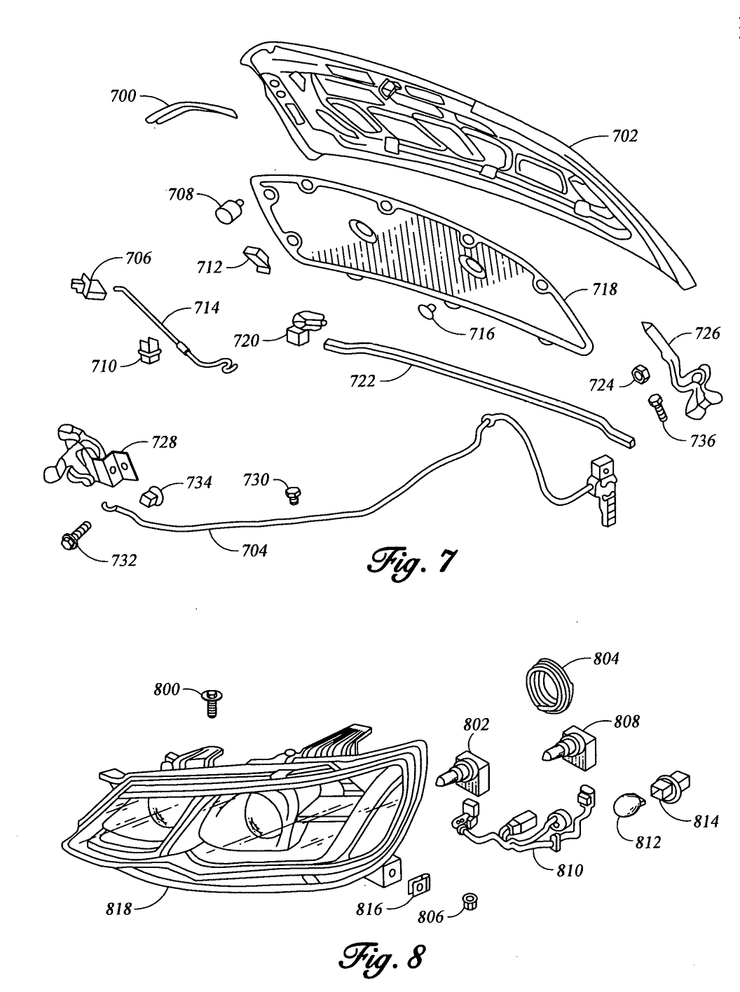

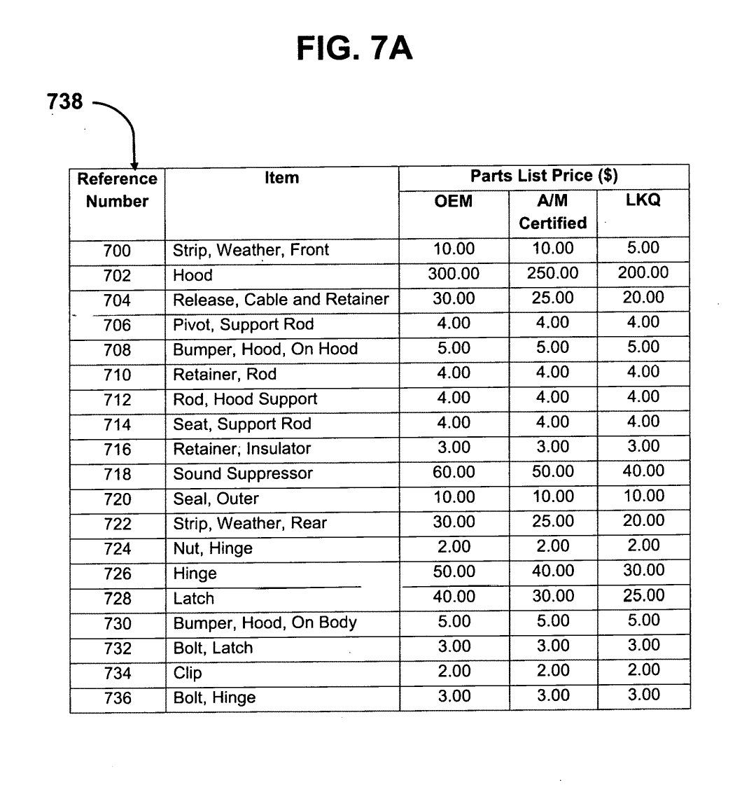

FIGS. 7 and 7A show a third image and its corresponding table in the second data set. FIG. 7 shows an image of the parts comprising the hood and components of the 2017 O'Reilly. Table 738 in FIG. 7A is the parts list and prices for the hood and components corresponding to FIG. 7. Table 738 shows the parts' Reference Number, Item Description, and Parts List Price in current dollars for OEM, A/M Certified, and LKQ parts. The parts stored in the second data set for the hood of a 2017 O'Reilly are the Strip, Weather, Front 700, Hood 702, Release, Cable and Retainer 704, Pivot, Support Rod 706, Bumper, Hood, On Hood 708, Retainer, Rod 710, Rod, Hood Support 712, Seat, Support Rod 714, Retainer, Insulator 716, Sound Suppressor 718, Seal, Outer 720, Strip, Weather, Rear 722, Nut, Hinge 724, Hinge 726, Latch 728, Bumper, Hood, On Body 730, Bolt, Latch 732, Clip 734, and Bolt, Hinge 736.

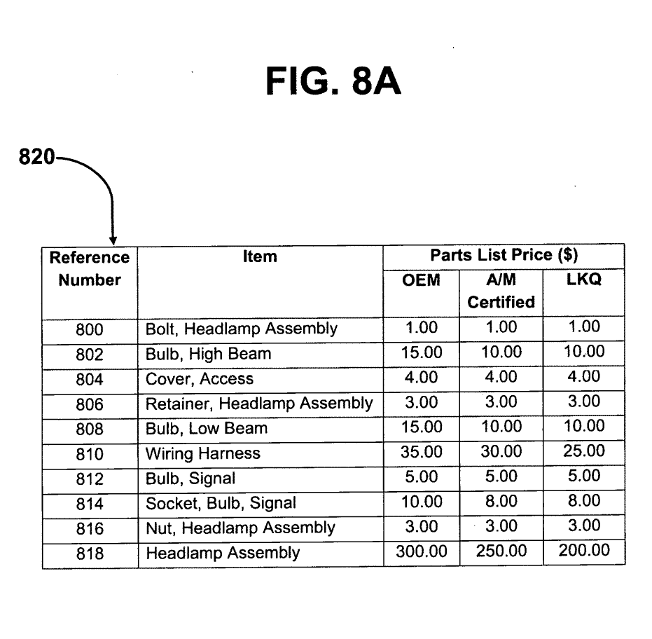

FIGS. 8 and 8A show a fourth image and its corresponding table in the second data set. FIG. 8 shows an image of the parts comprising the headlamp assembly of the 2017 O'Reilly. Table 820 in FIG. 8A is the parts list and prices for the headlamp corresponding to FIG. 8. Table 820 shows the parts' Reference Number, Item Description, and Parts List Price in current dollars for OEM, A/M Certified, and LKQ parts. The parts stored in the second data set for the headlamp of a 2017 O'Reilly are the Bolt, Headlamp Assembly 800, Bulb, High Beam 802, Cover, Access 804, Retainer, Headlamp Assembly 806, Bulb, Low Beam 808, Wiring Harness 810, Bulb, Signal 812, Socket, Bulb, Signal 814, Nut, Headlamp Assembly 816, and Headlamp Assembly 818.

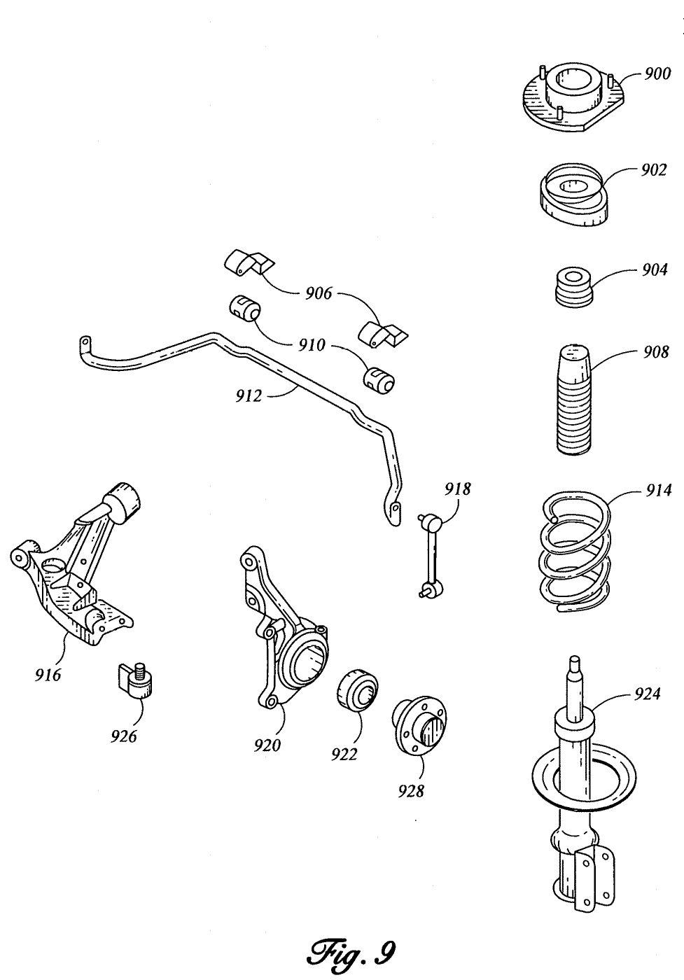

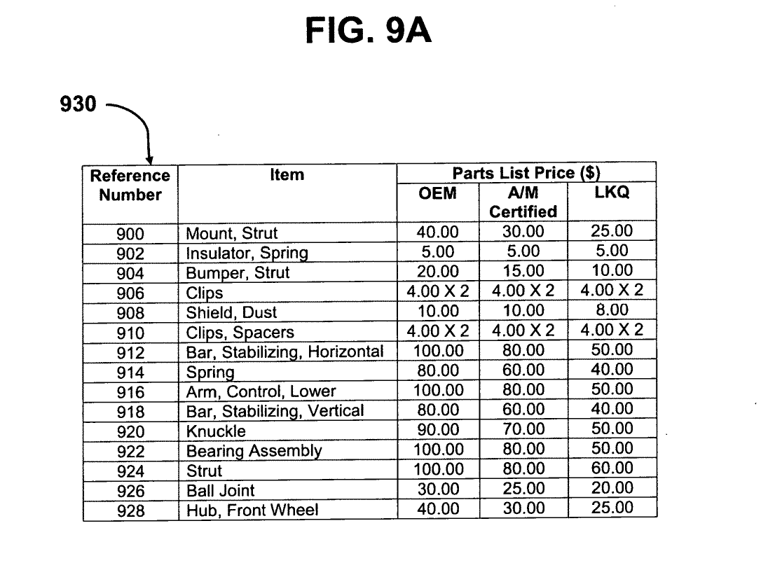

FIGS. 9 and 9A show a fifth image and its corresponding table in the second data set. FIG. 9 shows an image of the parts comprising the front suspension components of the 2017 O'Reilly. Table 930 in FIG. 9A is the parts list and prices for the front suspension components corresponding to FIG. 9. Table 930 shows the parts' Reference Number, Item Description, and Parts List Price in current dollars for OEM, A/M Certified, and LKQ parts. The parts stored in the second data set for the front suspension of a 2017 O'Reilly are the Mount, Strut 900, Insulator, Spring 902, Bumper, Strut 904, Clips 906, Shield, Dust 908, Clips, Spacers 910, Bar, Stabilizing, Horizontal 912, Spring 914, Arm, Control, Lower 916, Bar, Stabilizing, Vertical 918, Knuckle 920, Bearing Assembly 922, Strut 924, Ball Joint 926, and Hub, Front Wheel 928.

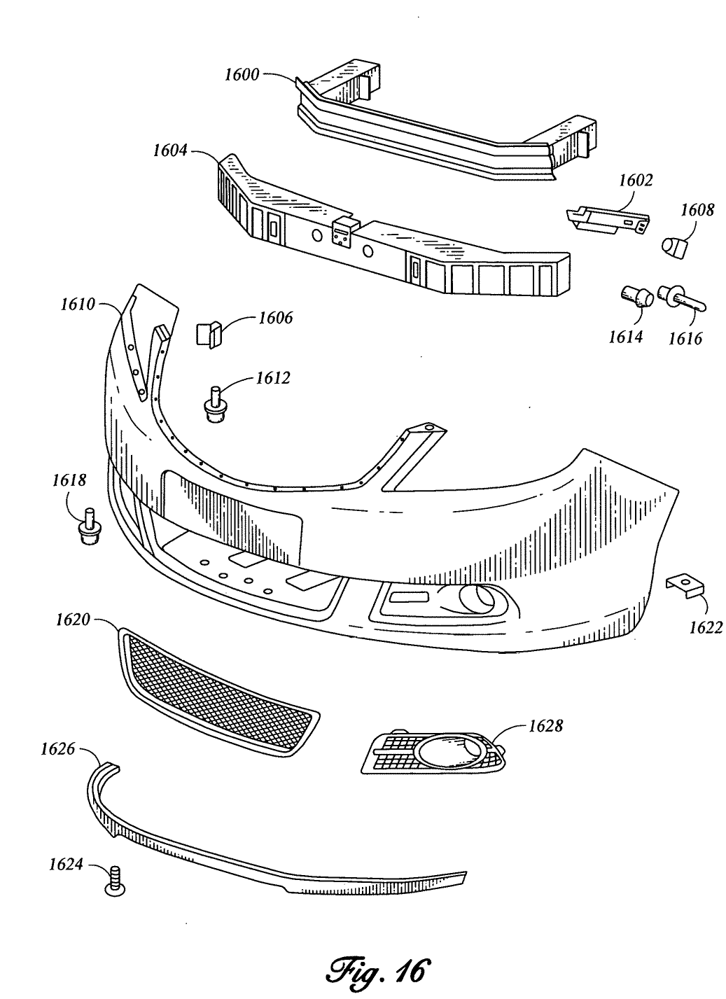

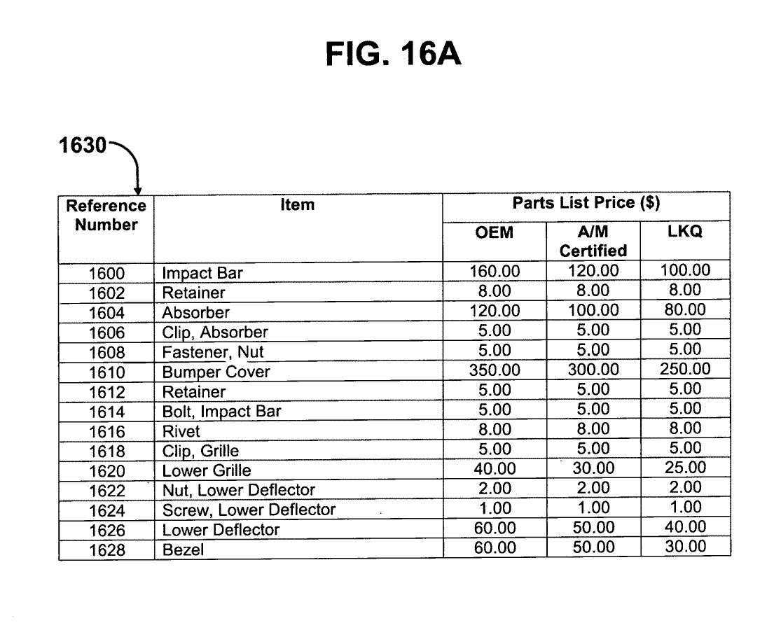

A third data set is entered by Shop Technician 254 using Shop Workstation 252 and saved to Shop Server 234. The third data set comprises numerous tables containing images of parts and parts costs in dollars for each of the manufacturers' vehicle makes, models, and model years, saved in the first data set, but are entered by Shop Technician 254 as vehicles are repaired. FIGS. 16 and 16A show one image and its corresponding table in the third data set. FIG. 16 shows an image of the parts comprising the bumper for a hypothetical 2016 Comparator 3 Luxury 4-Door Sedan. Table 1630 in FIG. 16A is the parts list and prices for the front bumper and components corresponding to FIG. 16. Table 1630 shows the parts' Reference Number, Item Description, and Parts List Price in current dollars for OEM, A/M Certified, and LKQ parts. The parts stored in the third data set for the front bumper of the 2016 Comparator 3 are the Impact Bar 1600, Retainer 1602, Absorber 1604, Clip, Absorber 1606, Fastener, Nut 1608, Bumper Cover 1610, Retainer 1612, Bolt, Impact Bar 1614, Rivet 1616, Clip, Grille 1618, Lower Grille 1620, Nut, Lower Deflector 1622, Screw, Lower Deflector 1624, Lower Deflector 1626, and Bezel 1628.

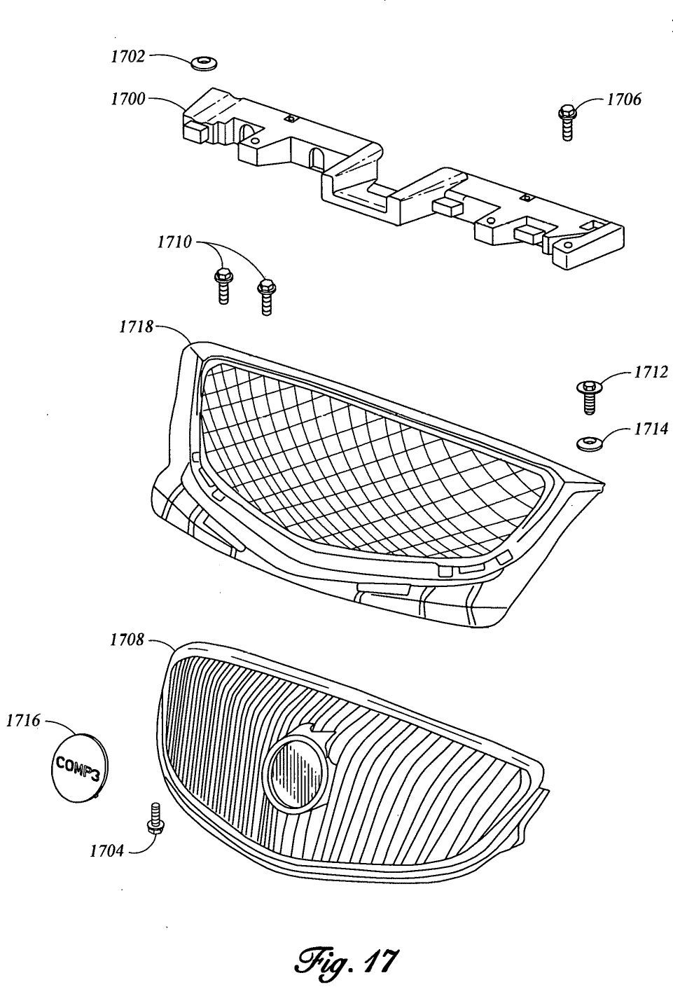

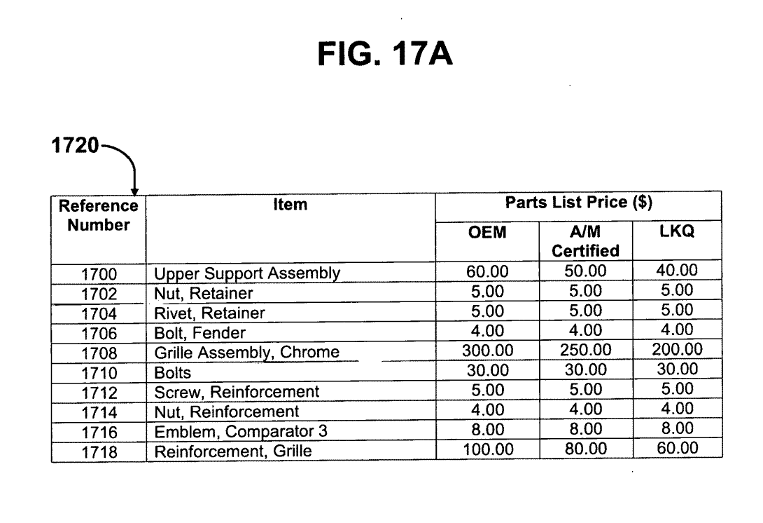

FIGS. 17 and 17A show a second image and its corresponding table in the third data set. FIG. 17 shows an image of the parts comprising the front grille of the 2016 Comparator 3. Table 1720 in FIG. 17A is the parts list and prices for the front grille and components corresponding to FIG. 17.

Table 1720 shows the parts' Reference Number, Item Description, and Parts List Price in current dollars for OEM, A/M Certified, and LKQ parts. The parts stored in the third data set for the front grille of the 2016 Comparator 3 are the Upper Support Assembly 1700, Nut, Retainer 1702, Rivet, Retainer 1704, Bolt, Fender 1706, Grille Assembly, Chrome 1708, Bolts 1710, Screw, Reinforcement 1712, Nut, Reinforcement 1714, Emblem, Comparator 3 1716, and Reinforcement, Grille 1718.

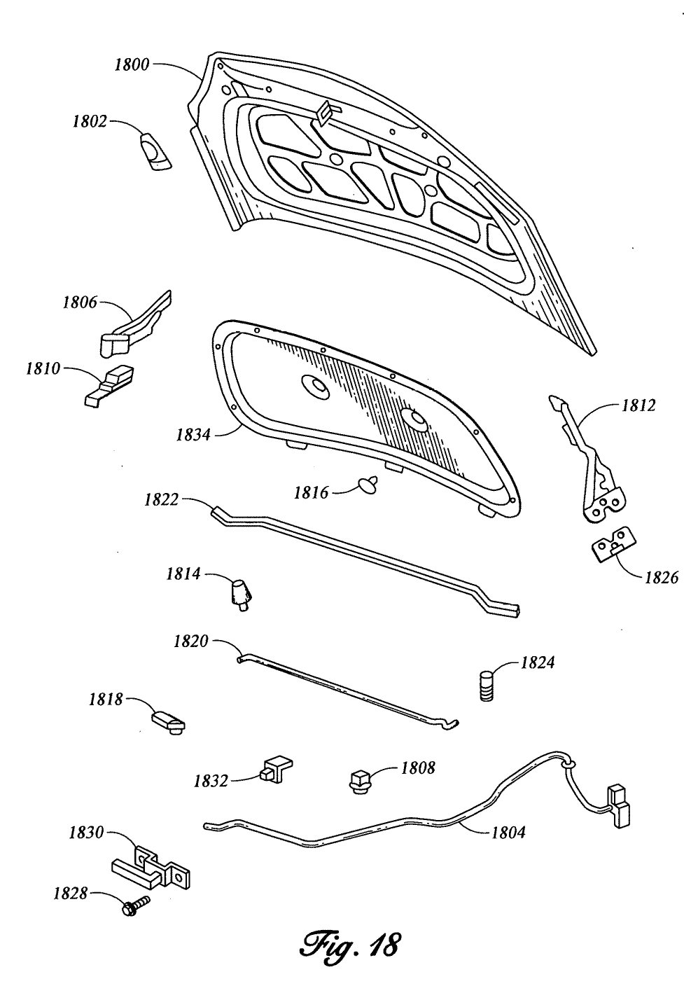

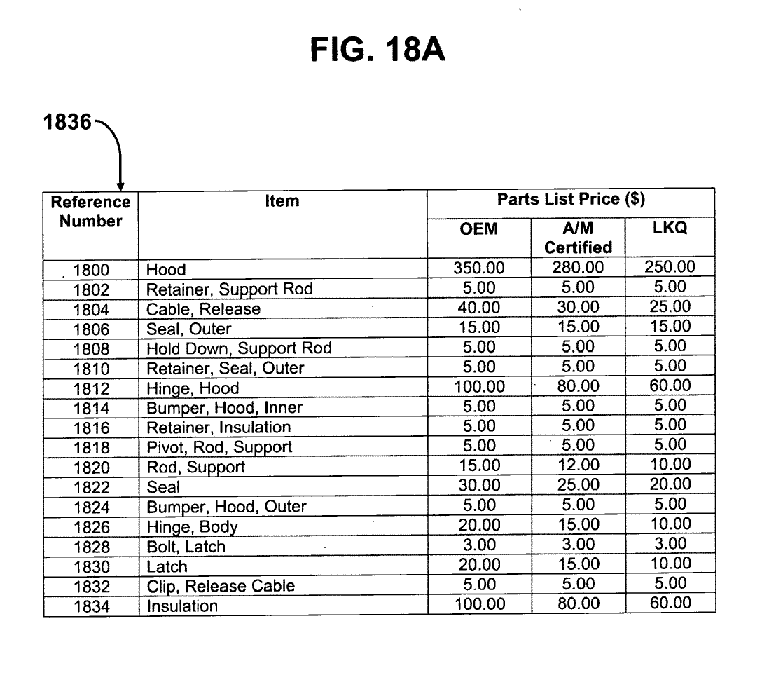

FIGS. 18 and 18A show a third image and its corresponding table in the third data set. FIG. 18 shows an image of the parts comprising the hood of the 2016 Comparator 3. Table 1836 in FIG. 18A is the parts list and prices for the hood and components corresponding to FIG. 18. Table 1836 shows the parts' Reference Number, Item Description, and Parts List Price in current dollars for OEM, A/M Certified, and LKQ parts. The parts stored in the third data set for the hood of the 2016 Comparator 3 are the Hood 1800, Retainer, Support Rod 1802, Cable, Release 1804, Seal, Outer 1806, Hold Down, Support Rod 1808, Retainer, Seal, Outer 1810, Hinge, Hood 1812, Bumper, Hood, Inner 1814, Retainer, Insulation 1816, Pivot, Rod, Support 1818, Rod, Support 1820, Seal 1822, Bumper, Hood, Outer 1824, Hinge, Body 1826, Bolt, Latch 1828, Latch 1830, Clip, Release Cable 1832, and Insulation 1834.

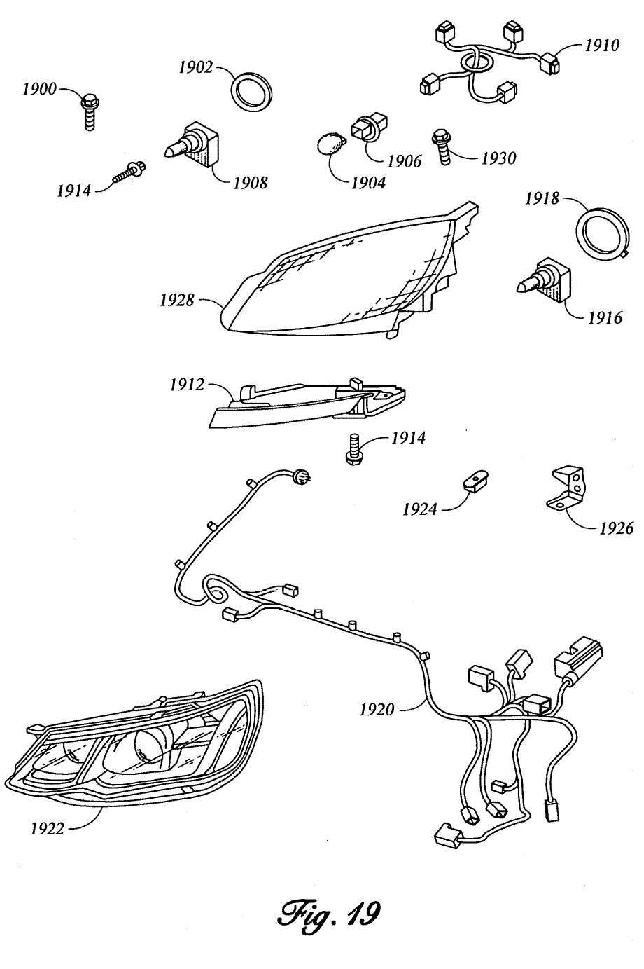

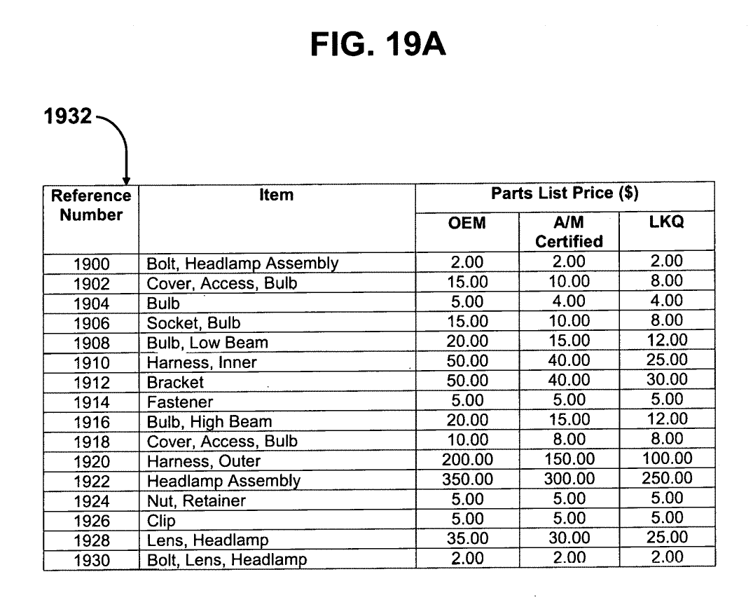

FIGS. 19 and 19A show a fourth image and its corresponding table in the third data set. FIG. 19 shows an image of the parts comprising the headlamp of the 2016 Comparator 3. Table 1932 in FIG. 19A is the parts list and prices for the headlamp components corresponding to FIG. 19. Table 1932 shows the parts' Reference Number, Item Description, and Parts List Price in current dollars for OEM, A/M Certified, and LKQ parts. The parts stored in the third data set of the headlamp for the 2016 Comparator 3 Luxury 4-Door Sedan are the Bolt, Headlamp Assembly 1900, Cover, Access, Bulb 1902, Bulb 1904, Socket, Bulb 1906, Bulb, Low Beam 1908, Harness, Inner 1910, Bracket 1912, Fastener 1914, Bulb, High Beam 1916, Cover, Access, Bulb 1918, Harness, Outer 1920, Headlamp Assembly 1922, Nut, Retainer 1924, Clip 1926, Lens, Headlamp 1928, and Bolt, Lens, Headlamp 1930.

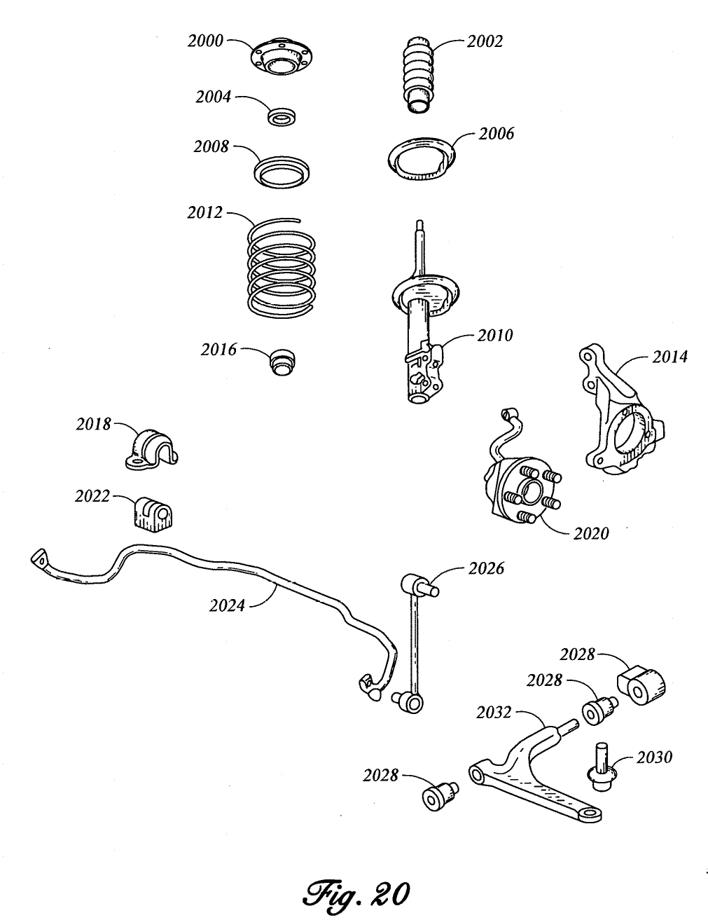

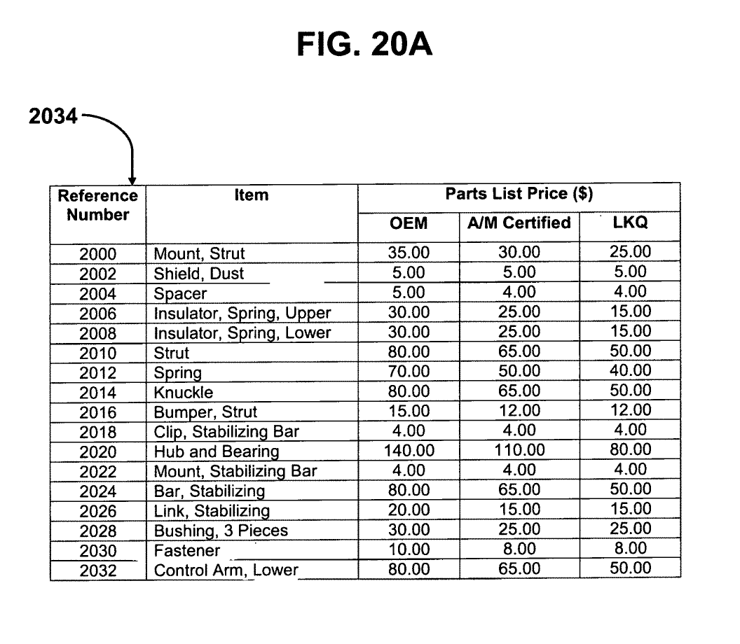

FIGS. 20 and 20A show a fifth image and its corresponding table in the third data set. FIG. 20 shows an image of the parts comprising the front suspension components of the 2016 Comparator 3. Table 2034 in FIG. 20A is the parts list and prices for the front suspension components corresponding to FIG. 20. Table 2034 shows the parts' Reference Number, Item Description, and Parts List Price in current dollars for OEM, A/M Certified, and LKQ parts. The parts stored in the third data set for the front suspension of the 2016 Comparator 3 are the Mount, Strut 2000, Shield, Dust 2002, Spacer 2004, Insulator, Spring, Upper 2006, Insulator, Spring, Lower 2008, Strut 2010, Spring 2012, Knuckle 2014, Bumper, Strut 2016, Clip, Stabilizing Bar 2018, Hub and Bearing 2020, Mount, Stabilizing Bar 2022, Bar, Stabilizing 2024, Link, Stabilizing 2026, Bushing, 3 Pieces 2028, Fastener 2030, and Control Arm 2032.

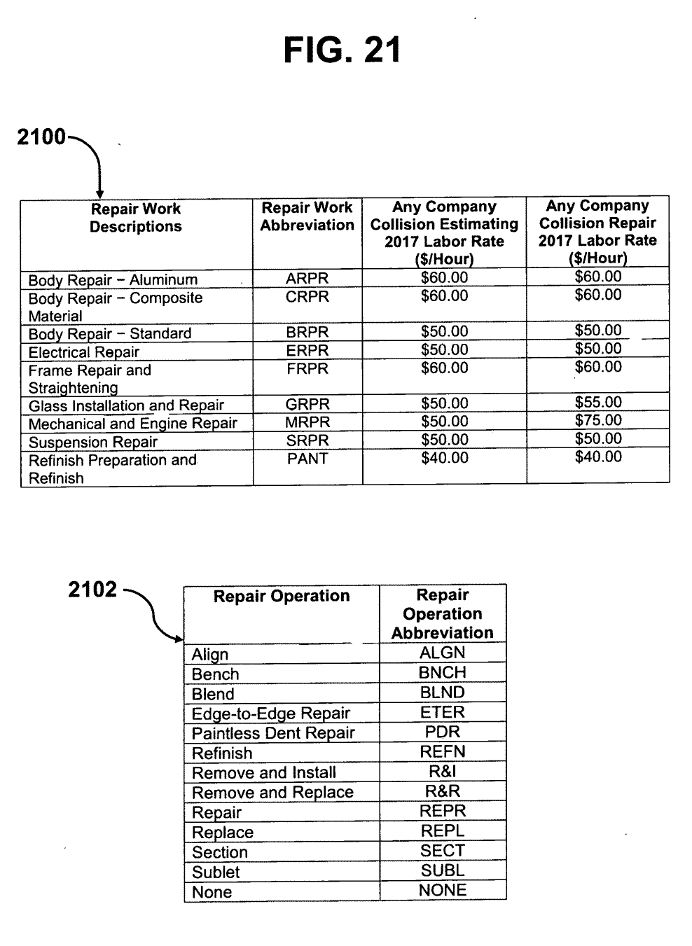

A fourth data set is entered by Labor Clerk 240 using Labor Workstation 238 and saved to Labor Server 236 through Item 246. The fourth data set comprises numerous tables containing descriptions of repair work commonly associated with collision damage repair, corresponding abbreviations used in estimating reports for the repair work, operations commonly associated with each repair work, and estimating and individual shop labor rates for repair and refinishing. By way of example, Table 2100 in FIG. 21 shows descriptions of repair work, corresponding repair work abbreviations, and labor rates in dollars per hour for the hypothetical Any Company Collision Estimating and the hypothetical Any Company Collision Repair Shop, both for year 2017. Table 2100 specifically shows Repair Work Descriptions comprising Body Repair, Composite Material or Aluminum Repair, Electrical Repair, Frame Repair and Straightening, Glass Installation and Repair, Mechanical and Suspension Repair, and Refinish Preparation and Refinish and corresponding labor rates in dollars per hour for the hypothetical Any Company Collision Estimating and the hypothetical Any Company Collision Repair Shop, both for year 2017. Table 2102 in FIG. 21 comprises the Repair Operations that may be performed for a particular Repair Work Description in Table 2100. Table 2100 further shows the abbreviations that are used for Repair Work Description that may be reported in a repair estimate or an actual repair. Table 2102 further shows the abbreviations that are used for the Repair Operations that may be reported in a repair estimate or an actual repair. It is to be understood that the Repair Work Descriptions and Repair Operations disclosed here in the fourth data set are shown as examples. There may be many more repair work descriptions and operations not listed that are within the disclosure made herein. It is to be further understood that the fourth data set is regularly updated with regional labor rates and individual shop labor rates and may contain thousands of labor rates.

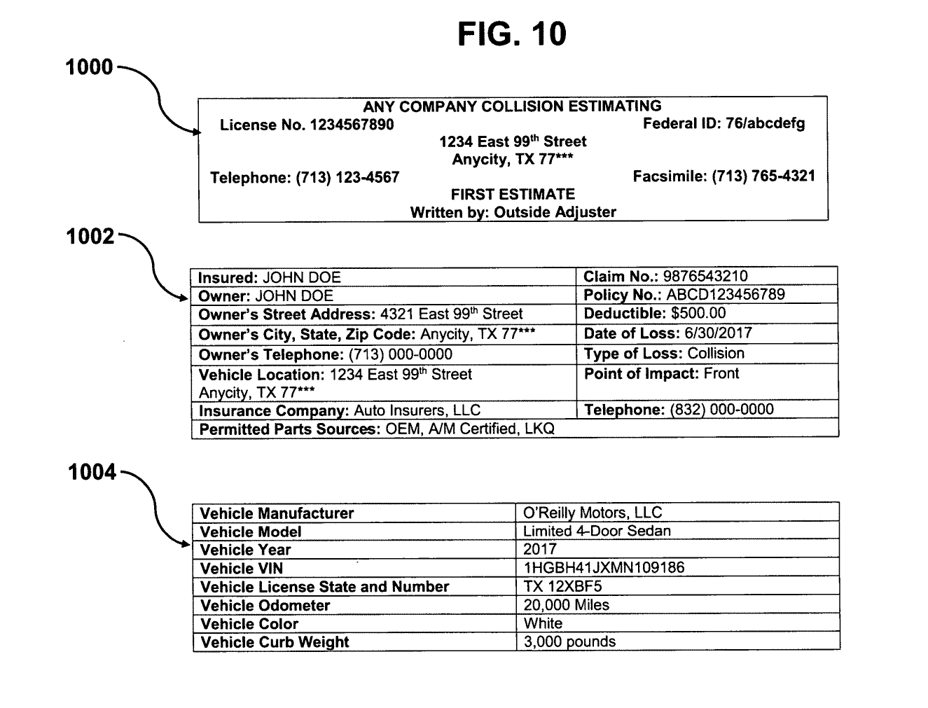

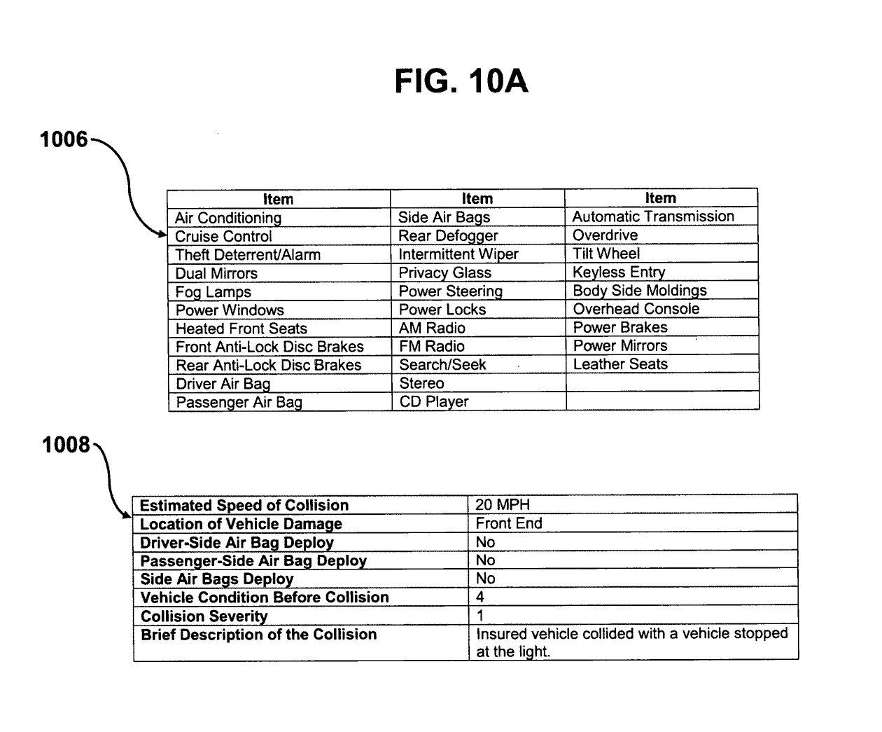

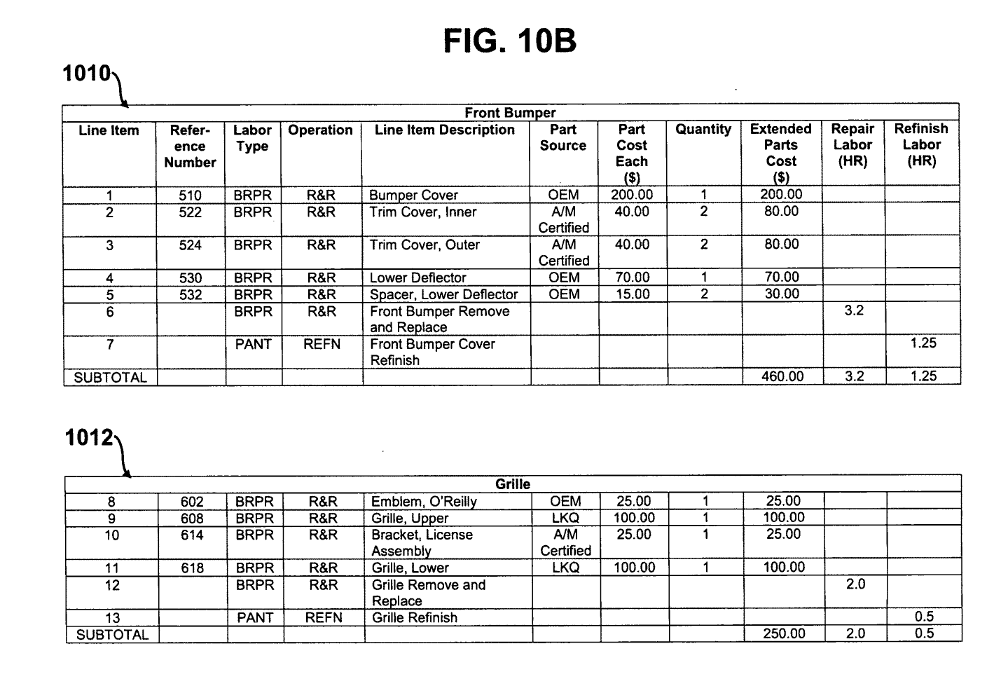

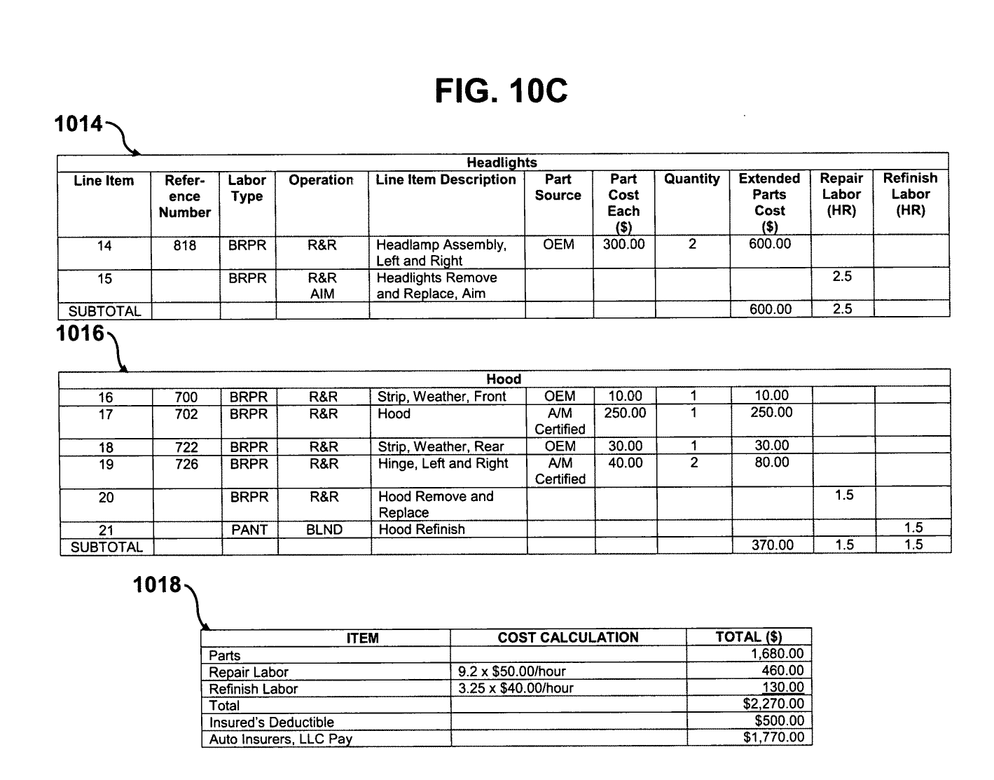

A fifth data set comprises tables containing an insured's information when an insured's claim is entered. The data are entered by Inside Adjuster 208 using Inside Adjuster Workstation 206 and saved to Vehicle Information Server 204. By way of example, the hypothetical company making the estimate is shown in Table 1000 in FIG. 10. Table 1002 in FIG. 10 shows a table of data resident in the fifth data set for a hypothetical insured; specifically: Insured: JOHN DOE; Vehicle Owner: JOHN DOE; Owner's Street Address: 4321 East 99th Street; Owner's City, State, Zip Code: Anycity, TX 77***; Owner's Telephone: (713) 000-0000; Vehicle Location: 1234 East 99th Street. Anycity, TX 77***; Insurance Company: Auto Insurers, LLC; Insurance Company Telephone: (832) 000-0000; Claim No.: 9876543210; Policy No.: ABCD123456789; Deductible: $500.00; Date of Loss: Jun. 30, 2017; Type of Loss: Collision; Point of Impact: Front; and Permitted Parts Sources: OEM, A/M Certified, LKQ. It is to be understood that the Insured's Information disclosed here in the table in the fifth data set is shown as an example. There will be many more of such tables in the fifth data set as additional claims are added.

A sixth data set comprises tables containing details regarding the vehicle whose collision damage is to be repaired. The data are entered by Inside Adjuster 208 using Inside Adjuster Workstation 206 and saved to Vehicle Information Server 204. By way of example, Table 1004 in FIG. 10 shows a table of data resident in the sixth data set for the hypothetical insured and owner in Table 1002; specifically: Vehicle Manufacturer: O'Reilly Motors, LLC; Vehicle Model: Limited 4-Door Sedan; Vehicle Year: 2017; Vehicle VIN: 1HGBH41JXMN109186; Vehicle License State and Number: TX 12XBF5; Vehicle Odometer: 20,000 Miles; Vehicle Color: White; and Vehicle Curb Weight: 3,000 pounds. It is to be understood that the Vehicle Details disclosed here in the table in the sixth data set is shown as an example. There will be many more of such tables in the sixth data set as additional claims are added.

A seventh data set comprises tables containing the options available on the vehicle whose collision damage is to be repaired. The data are entered by Inside Adjuster 208 using Inside Adjuster Workstation 206 and saved to Vehicle Information Server 204. By way of example, Table 1006 in FIG. 10A shows a table of data resident in the seventh data set for the hypothetical vehicle in Table 1002. 31 options are shown in Table 1006. They are: Air Conditioning; Cruise Control; Theft Deterrent/Alarm; Dual Mirrors; Fog Lamps; Power Windows; Heated Front Seats; Front Anti-Lock Disc Brakes; Rear Anti-Lock Disc Brakes; Driver Air Bag; Passenger Air Bag; Side Air Bags; Rear Defogger; Intermittent Wiper; Privacy Glass; Power Steering; Power Locks; AM Radio; FM Radio; Search/Seek; Stereo; CD Player; Automatic Transmission; Overdrive; Tilt Wheel; Keyless Entry; Body Side Moldings; Overhead Console; Power Brakes; Power Mirrors; and Leather Seats. It is to be understood that the Vehicle Options disclosed here in the table in the seventh data set is shown as an example. There will be many more of such tables in the seventh data set as additional claims are added.

An eighth data set comprises tables containing the details of the collision, a preliminary assessment of the vehicle's condition before the collision, and an estimate of the collision severity, for the vehicle whose collision damage is to be repaired. The data are entered by Inside Adjuster 208 using Inside Adjuster Workstation 206 and saved to Vehicle Information Server 204. By way of example, Table 1008 in FIG. 10A shows a table of data resident in the eighth data set for the hypothetical vehicle in Table 1002. Specifically, the Collision Details are: Estimated Speed of Collision: 20 MPH; Location of Vehicle Damage: Front End; Driver-Side Air Bag Deploy: No; Passenger-Side Air Bag Deploy: No; Side Air Bags Deploy: No; Vehicle Condition Before Collision: 4; Collision Severity: 1; and Brief Description of the Collision: Insured vehicle collided with a vehicle stopped at the light. It is to be understood that the Collision Details disclosed here in the table in the eighth data set is shown as an example. There will be many more of such tables in the eighth data set as additional claims are added.

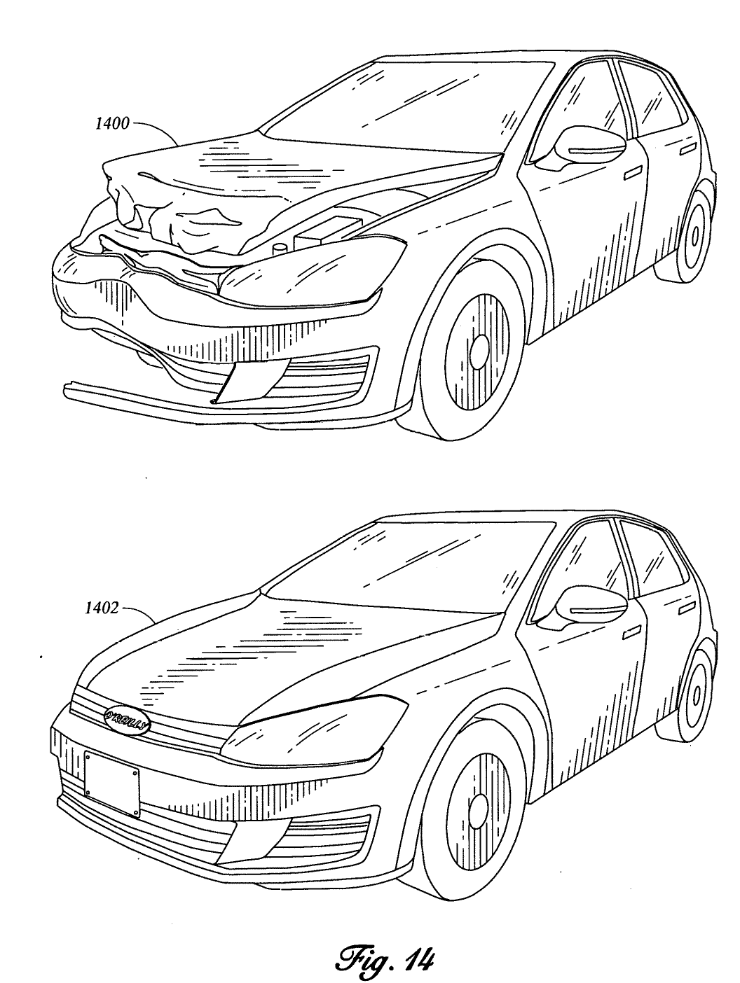

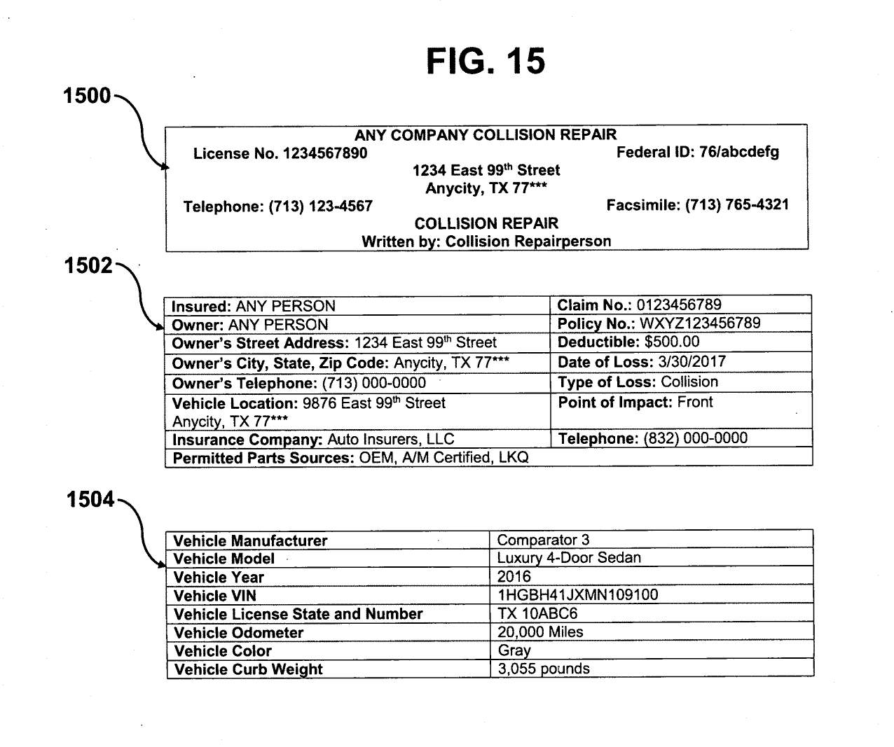

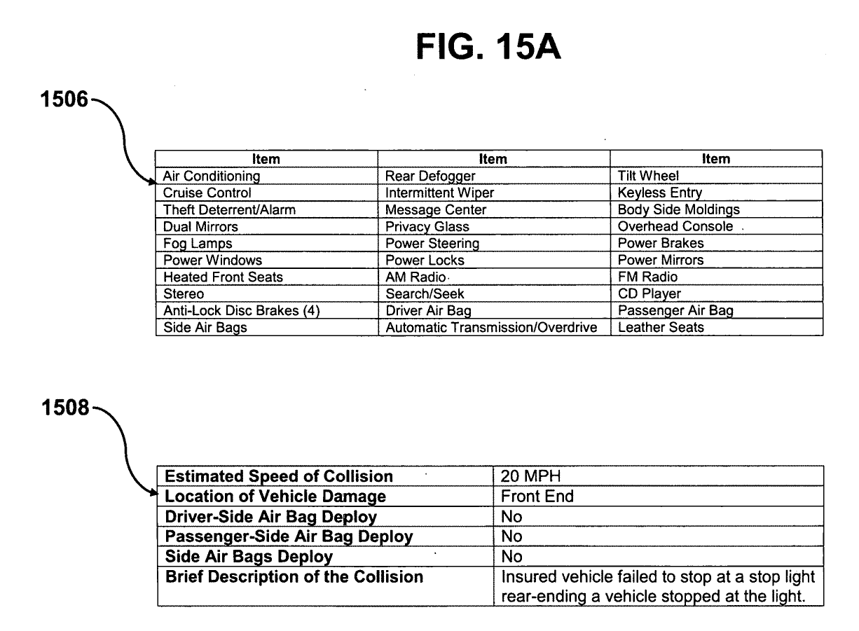

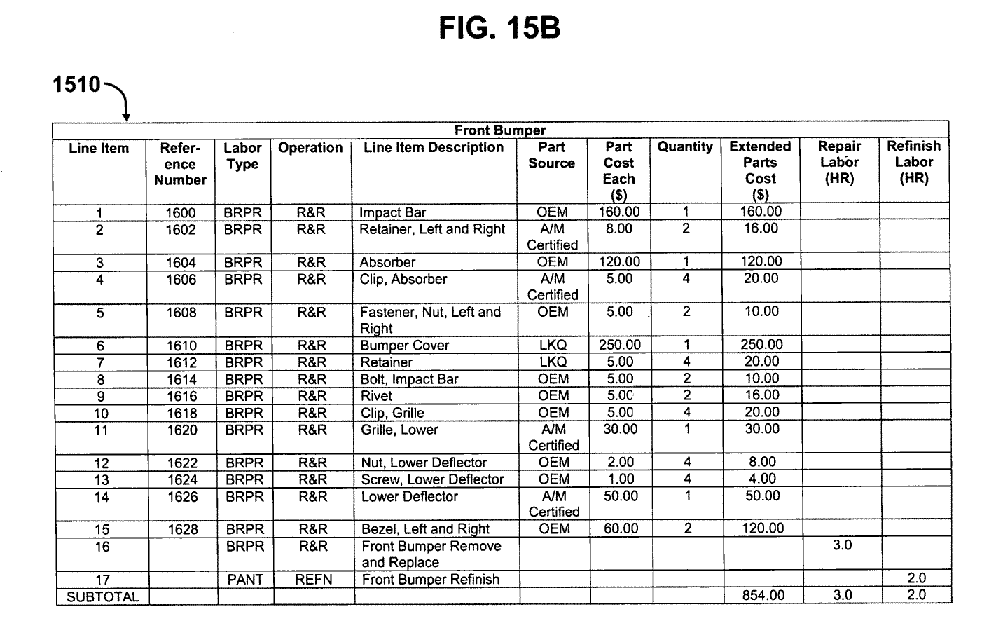

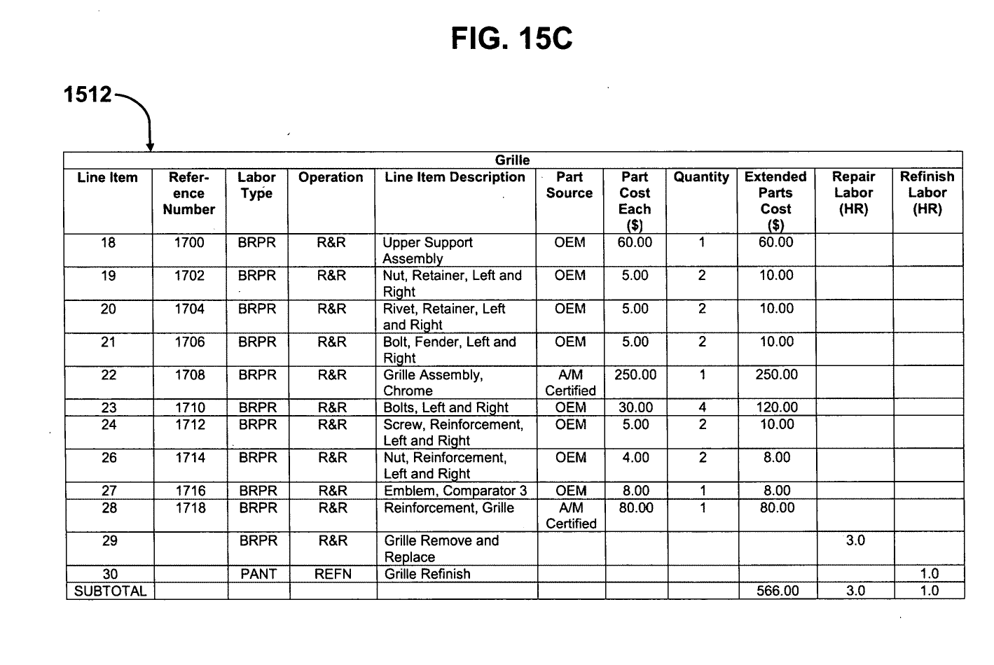

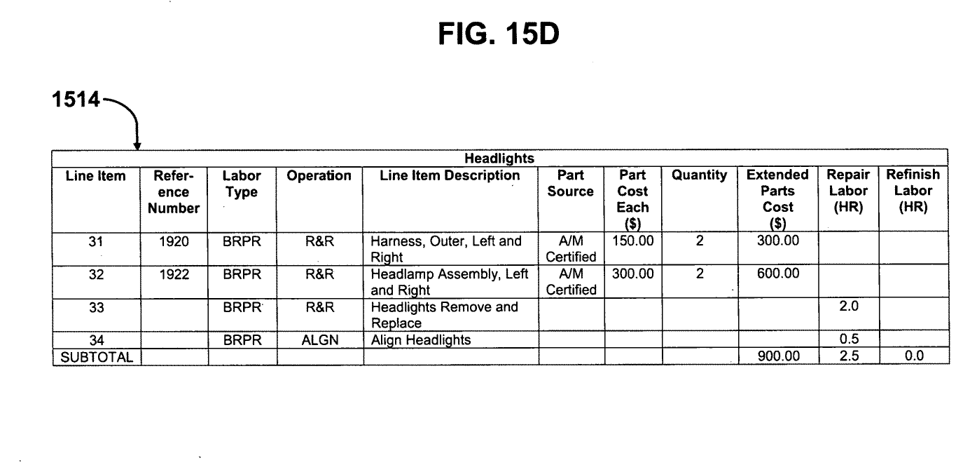

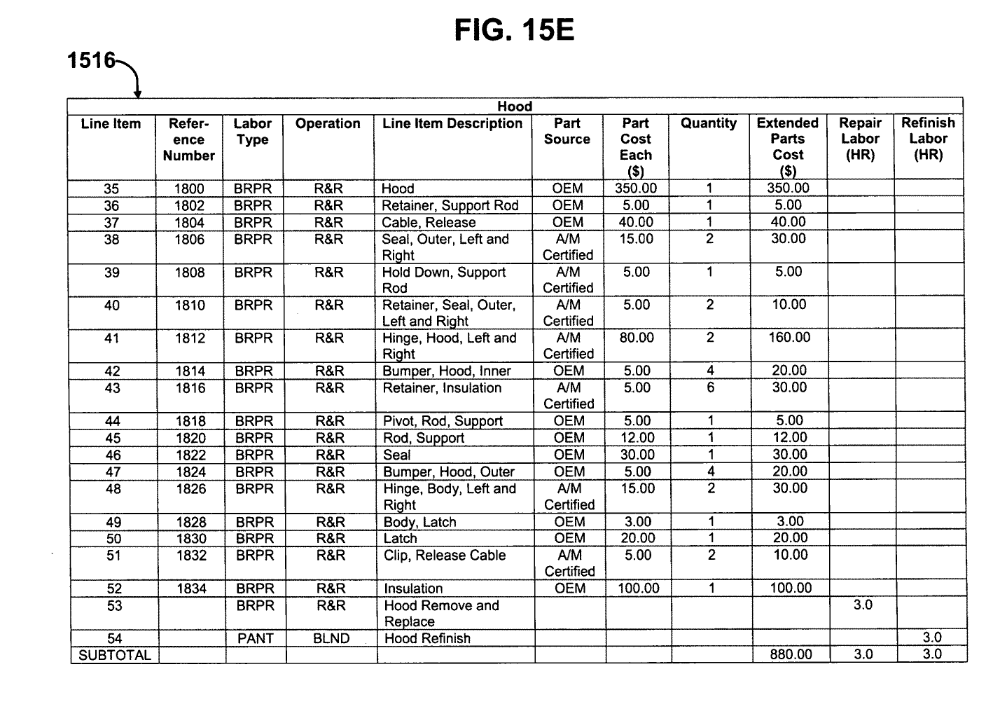

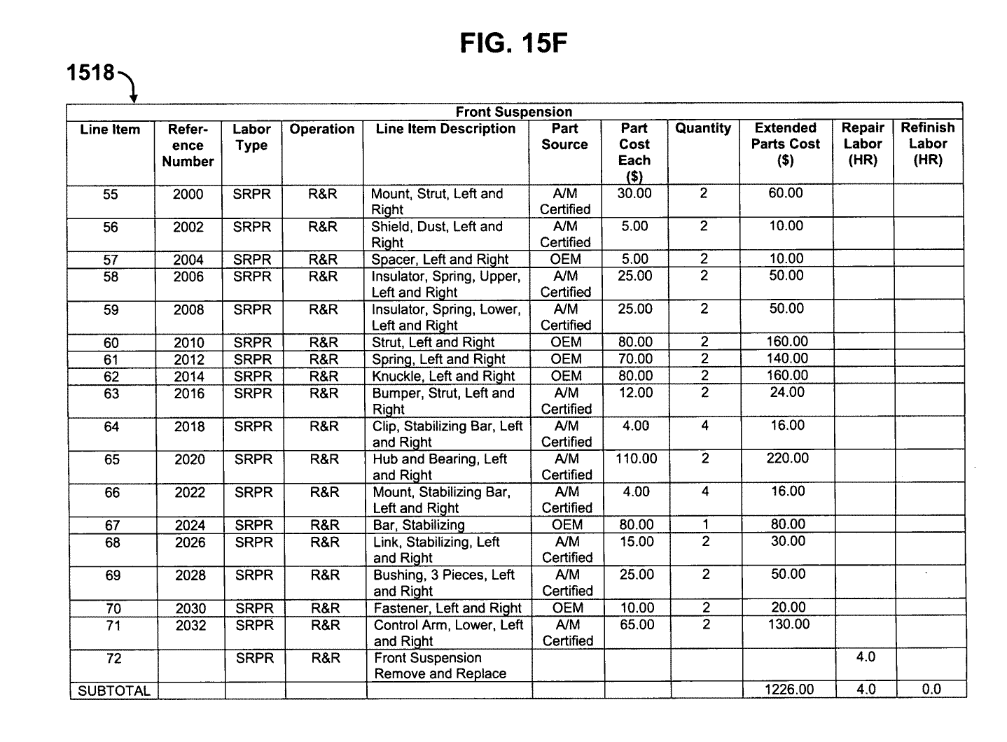

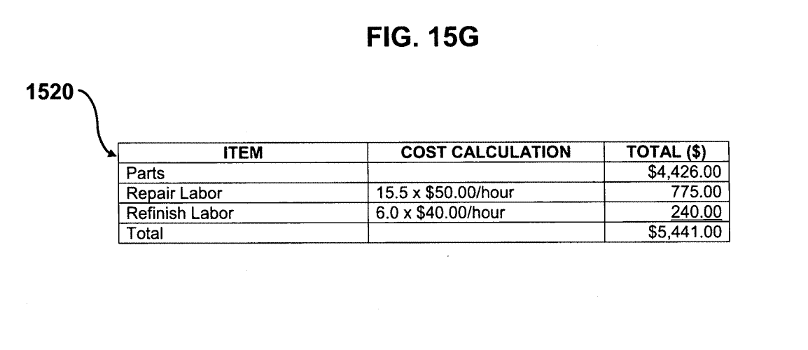

A ninth data set comprises tables containing details regarding the claim for the vehicle whose collision damage has been repaired; the 2016 Comparator 3 Luxury 4-Door Sedan. The data are entered by Shop Technician 254 using Shop Workstation 252 and saved to Shop Server 234. By way of example, the hypothetical repair shop contact information is shown in Table 1500 in FIG. 15. Table 1502 in FIG. 15 shows a table of data for a hypothetical insured; specifically: Insured: ANY PERSON; Owner: ANY PERSON; Owner's Street Address: 1234 East 99th Street; Owner's City, State, Zip Code: Anycity, TX 77***; Owner's Telephone: (713) 000-0000; Vehicle Location: 9876 East 99th Street, Anycity, TX 77***; Insurance Company: Auto Insurers, LLC; Insurance Company Telephone: (832) 000-0000; Claim No.: 0123456789; Policy No.: WXYZ123456789; Deductible: $500.00; Date of Loss: Mar. 30, 2017; Type of Loss: Collision; Point of Impact: Front; and Permitted Parts Sources: OEM, A/M Certified, LKQ. It is to be understood that the Insured's Information disclosed here in the table in the ninth data set is shown as an example. There will be many more of such tables in the ninth data set as additional vehicles are repaired.

A tenth data set comprises tables containing details regarding the vehicle whose collision damage has been repaired; the 2016 Comparator 3 Luxury 4-Door Sedan. The data are entered by Shop Technician 254 using Shop Workstation 252 and saved to Shop Server 234. By way of example, Table 1504 in FIG. 15 shows a table of data for the hypothetical insured and owner in Table 1502; specifically: Vehicle Manufacturer: Comparator 3; Vehicle Model: Luxury 4-Door Sedan; Vehicle Year: 2016; Vehicle VIN: 1HGBH41JXMN109100; Vehicle License State and Number: TX 10ABC6; Vehicle Odometer: 20,000 Miles; Vehicle Color: Gray; Vehicle Curb Weight: 3,055 pounds. It is to be understood that the Vehicle Details disclosed here in the table in the tenth data set is shown as an example. There will be many more of such tables in the tenth data set as additional vehicles are repaired.

An eleventh data set comprises tables containing the options available on the vehicle whose collision damage has been repaired; the 2016 Comparator 3 Luxury 4-Door Sedan. The data are entered by Shop Technician 254 using Shop Workstation 252 and saved to Shop Server 234. By way of example, Table 1506 in FIG. 15A shows a table of data for the hypothetical vehicle in Table 1502. 30 options are shown in Table 1506. They are: Air Conditioning; Cruise Control; Theft Deterrent/Alarm; Dual Mirrors; Fog Lamps; Power Windows; Heated Front Seats; Stereo; Anti-Lock Disc Brakes (4); Side Air Bags; Rear Defogger; Intermittent Wiper; Message Center; Privacy Glass; Power Steering; Power Locks; AM Radio; Search/Seek; Driver Air Bag; Automatic Transmission/Overdrive; Tilt Wheel; Keyless Entry; Body Side Moldings; Overhead Console; Power Brakes; Power Mirrors; FM Radio; CD Player; Passenger Air Bag; and Leather Seats. It is to be understood that the Vehicle Options disclosed here in the table in the twelfth data set is shown as an example. There will be many more of such tables in the eleventh data set as additional vehicles are repaired.

A twelfth data set comprises tables containing the details of the collision, a preliminary assessment of the vehicle's condition before the collision, and an estimate of the collision severity, for the vehicle whose collision damage has been repaired; the 2016 Comparator 3 Luxury 4-Door Sedan. The data are entered by Shop Technician 254 using Shop Workstation 252 and saved to Shop Server 234. By way of example, Table 1508 in FIG. 15A shows a table of data for the hypothetical vehicle in Table 1502. Specifically, the Collision Details are: Estimated Speed of Collision: 20 MPH; Location of Vehicle Damage: Front End; Driver-Side Air Bag Deploy: No; Passenger-Side Air Bag Deploy: No; Side Air Bags Deploy: No; and Brief Description of the Collision: Insured vehicle failed to stop at a stop light rear-ending a vehicle stopped at the light. It is to be understood that the Collision Details disclosed here in the table in the thirteenth data set is shown as an example. There will be many more of such tables in the twelfth data set as additional vehicles are repaired.

A thirteenth data set comprises tables containing the actual parts used in the repair, the parts costs, the labor hours and labor rates for repair, painting, and other repair services, and the total cost for the repair for vehicles whose collision damage has been repaired. By way of example, one table in the thirteenth data set comprises the parts, the parts sources, the parts costs, the labor hours and labor rates for repair and refinishing, and the total cost to repair the 2016 Comparator 3 Luxury 4-Door Sedan. The data are entered by Shop Technician 254 using Shop Workstation 252 and saved to Shop Server 234. The exemplar table in the thirteenth data set comprises the data shown in Table 1510 in FIG. 15B, the repair parts, parts source, and labor hours for repair and refinishing the front bumper; the data shown in Table 1512 in FIG. 15C, the same for the grille; the data shown in Table 1514 in FIG. 15D, the same for the headlights; the data shown in Table 1516 in FIG. 15E, the same for the hood; the data shown in Table 1518 in FIG. 15F, the same for the front suspension; and the data shown in Table 1520 in FIG. 15G, which show the total repair cost.

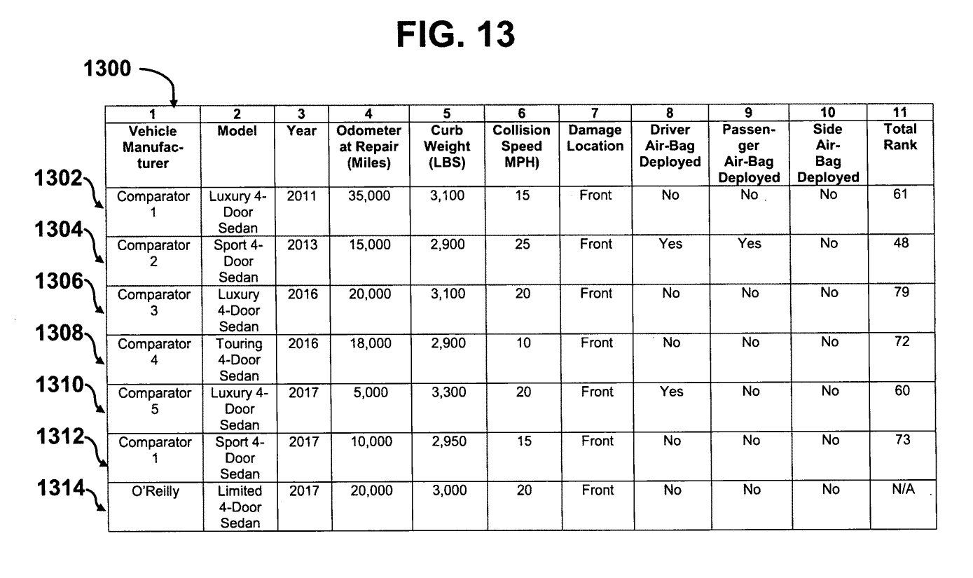

A fourteenth data set comprises tables populated by a first algorithm resident in Vehicle Estimating Server 202. The first algorithm immediately populates the fourteenth data set with tables as claims data are entered and vehicles are repaired. The tables are saved in Vehicle Estimating Server 202. By way of example of the preferred embodiment, the first algorithm populates the fourteenth data set with data selected from the sixth data set, the eighth data set, the tenth data set, and the twelfth data set. Table 1300 in FIG. 13 shows 7 tables resident in the fourteenth data set depicted as seven rows of data. The first 6 rows, Rows 1302, 1304, 1306, 1308, 1310, and 1312 in Table 1300, are created by selected data for 6 models of vehicles manufactured by 5 manufacturers that have been repaired. Referring to the first 6 rows of data in Table 1300, the columns labeled, “Vehicle Manufacturer,” “Model Year,” “Odometer at Repair (Miles),” “Curb Weight (LBS),” and “Damage Location,” comprise data taken from tables in the tenth data set. Continuing to refer to the first 6 rows in Table 1300, the columns labeled, “Collision Speed,” “Driver Air-Bag Deployed,” “Passenger Air-Bag Deployed,” and “Side Air-Bag Deployed,” comprise data taken from tables in the twelfth data set. The seventh row of data in Table 1300, Row 1314, is the same data taken from tables in the sixth data set and the eighth data set for the 2017 O'Reilly.

A fifteenth data set comprises tables containing the major damaged areas, the parts to repair each damaged area, the parts costs, the labor types, the operations, the labor hours and labor rates for repair, painting, and other repair services, and the total cost of the First Estimate for the repair of a damaged vehicle. All tables with data related to a particular vehicle are linked via the vehicle's unique VIN. The data are entered by Outside Adjuster 102 with speech activated data entry using portable computing device 104 and saved to Vehicle Estimating Server 202. By way of example, Tables 1010 and 1012 in FIG. 10B show the first estimate to repair the front bumper and grille, respectively, of the 2017 O'Reilly. Tables 1014 and 1016 in FIG. 10C show the first estimate to repair the headlamps and hood, respectively, of the same vehicle. Table 1016 shows the summary of the First Estimate.

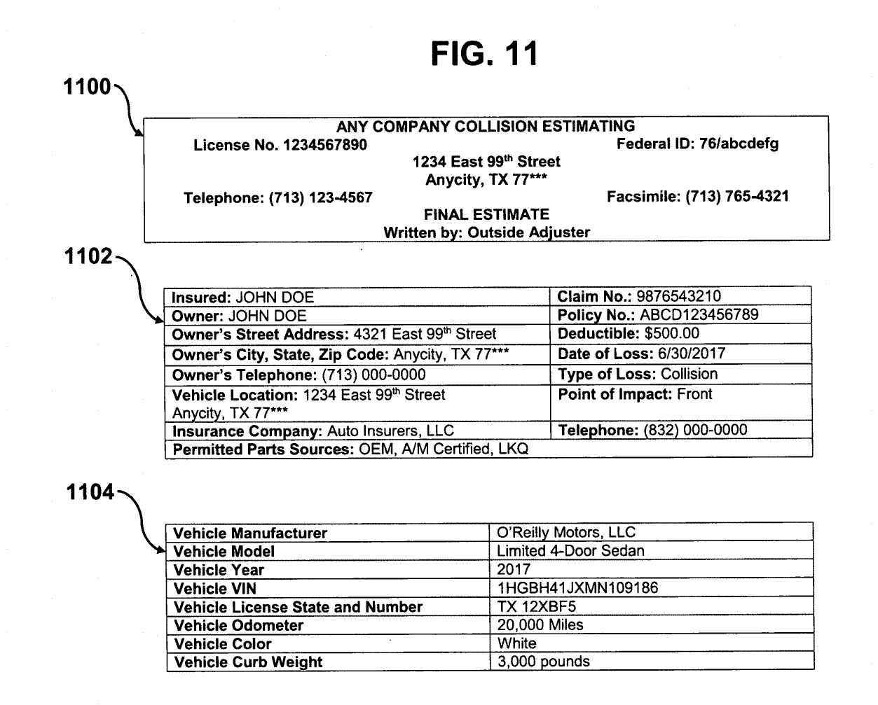

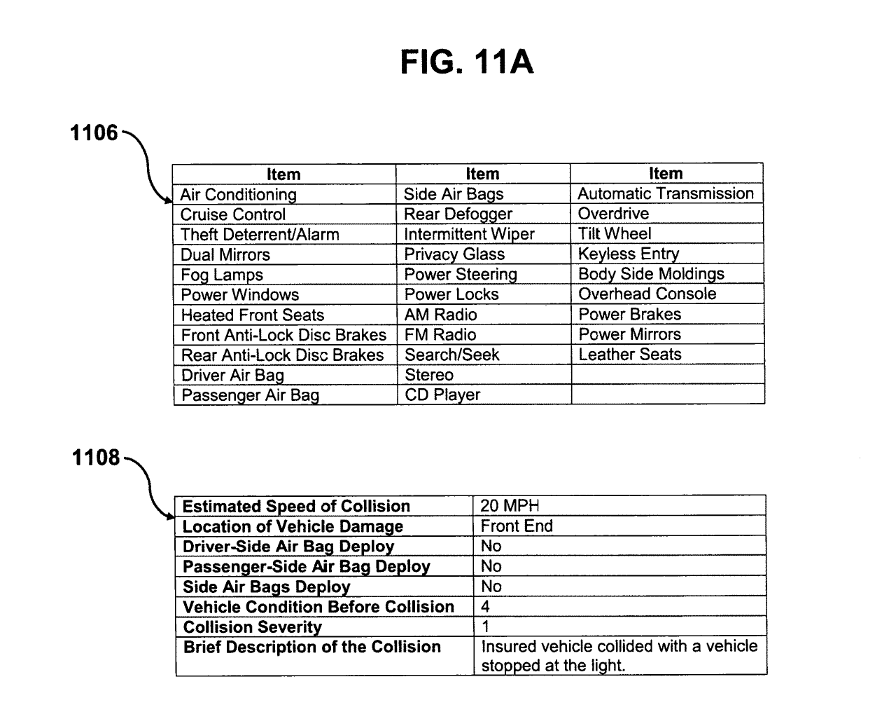

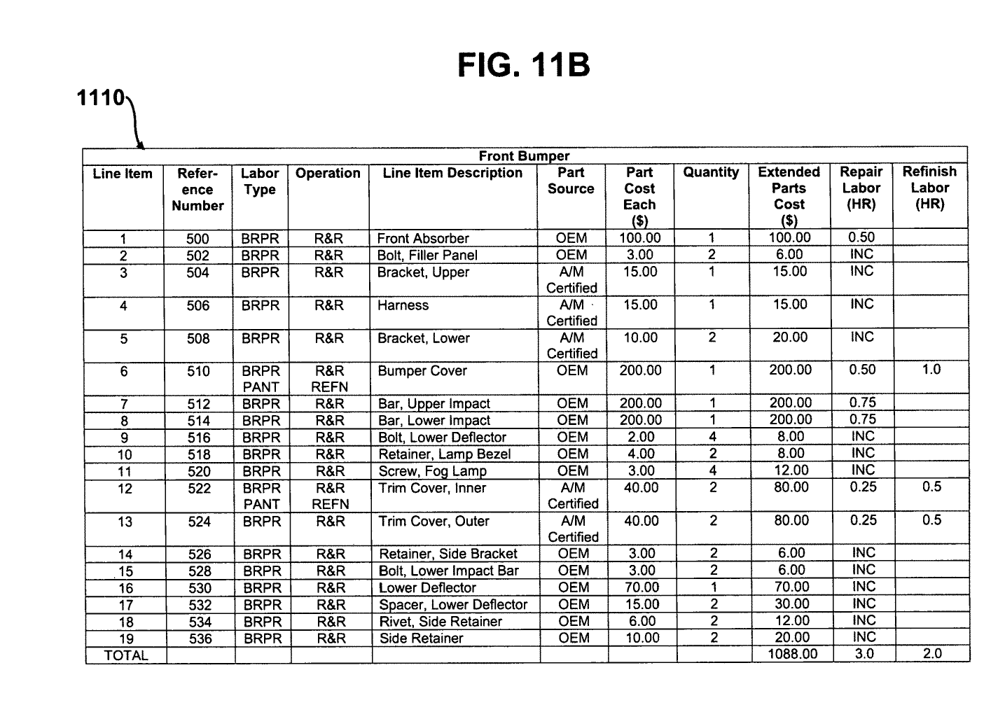

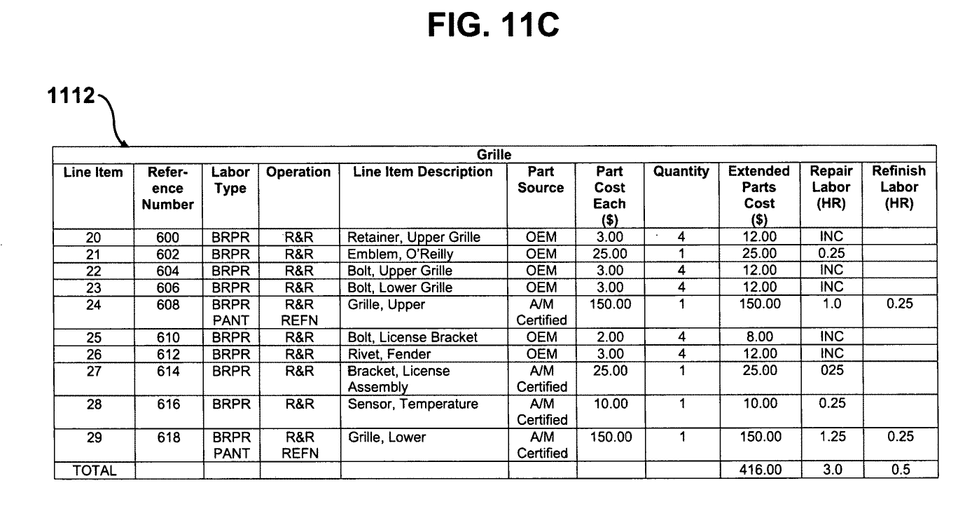

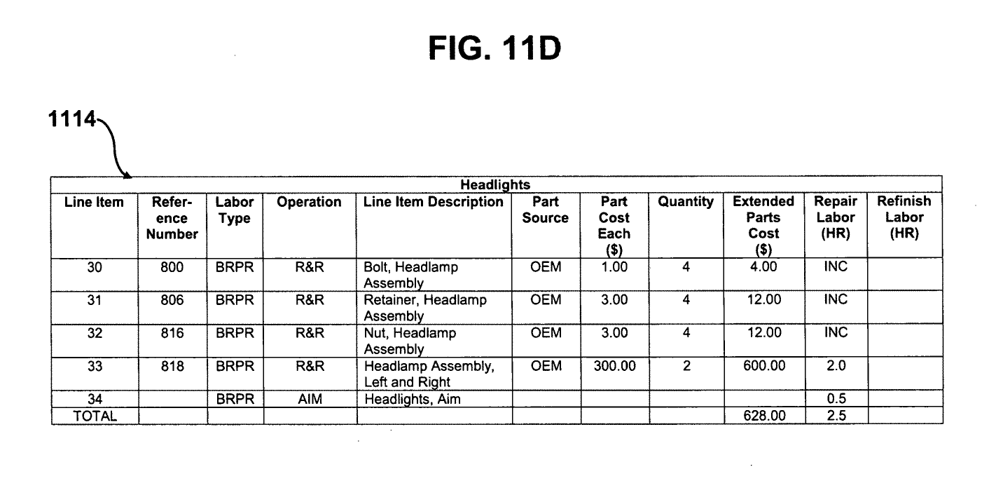

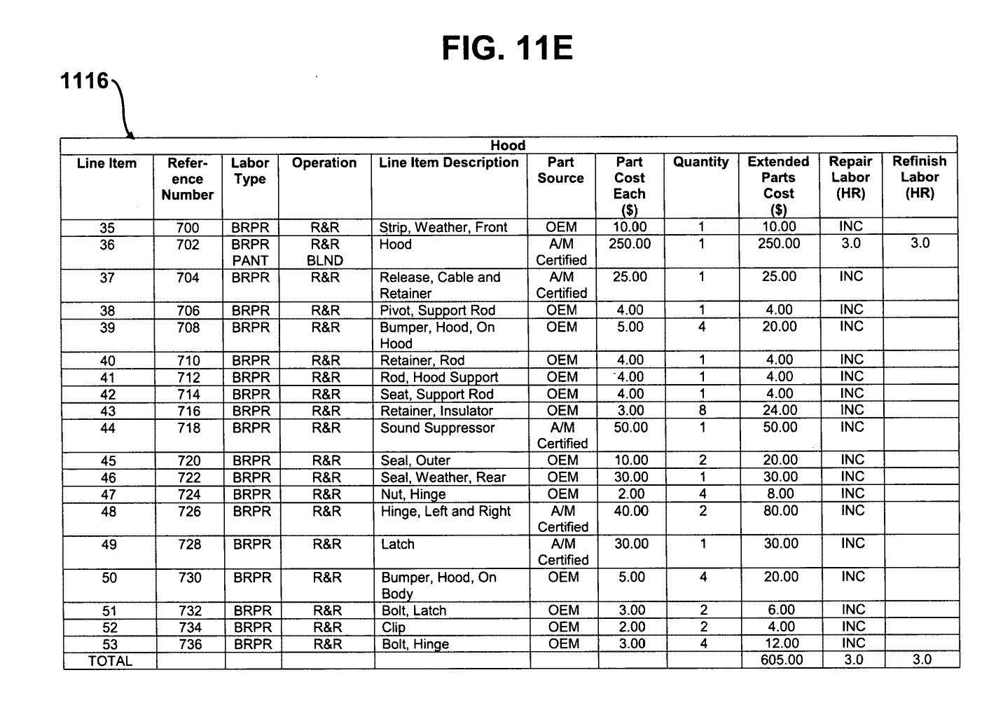

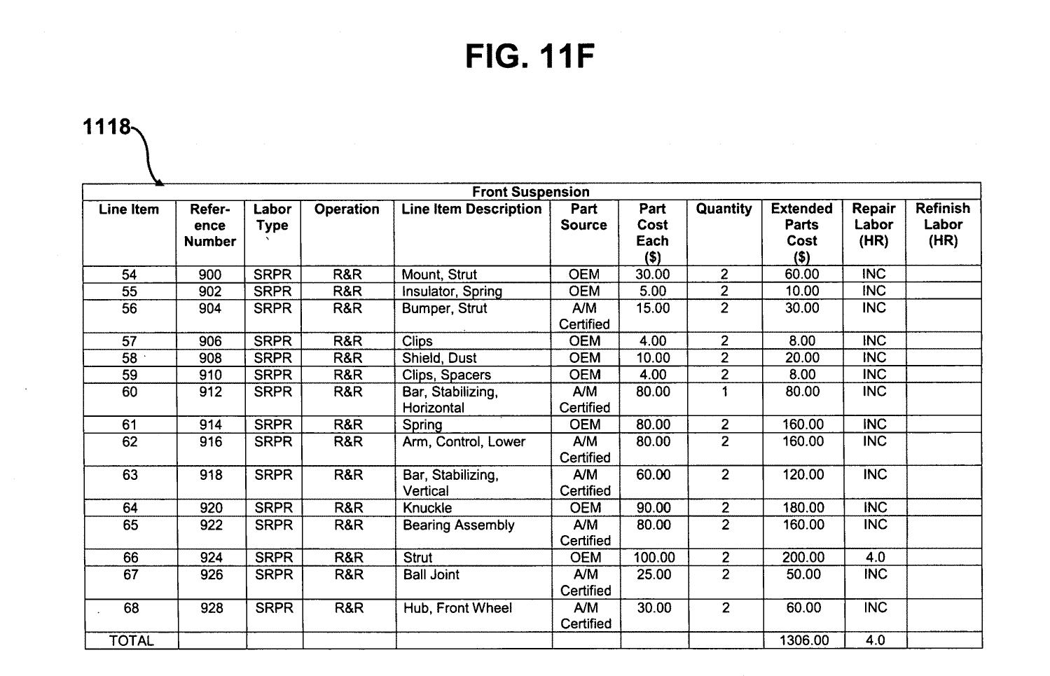

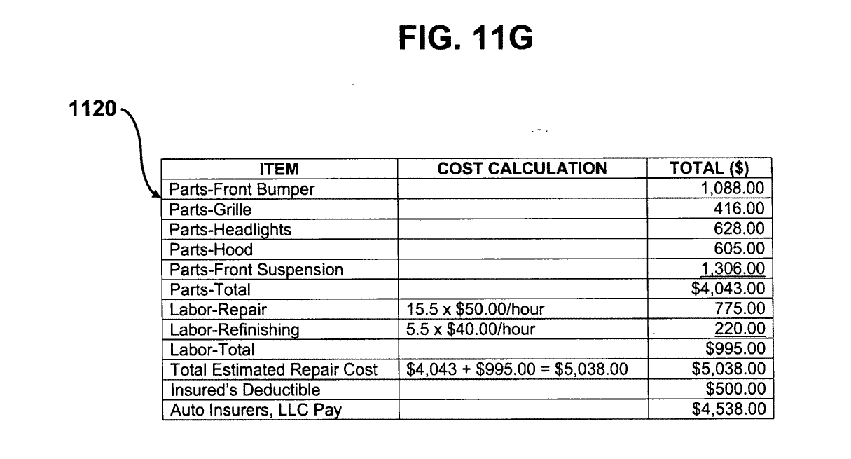

A sixteenth data set comprises tables containing the major damaged areas, the parts to repair each damaged area, the parts costs, the labor types, the operations, the labor hours and labor rates for repair, painting, and other repair services, and the total cost of the Final Estimate for the repair of a damaged vehicle. All tables with data related to a particular vehicle are linked via the vehicle's unique VIN. The data are entered by Outside Adjuster 102 with speech activated data entry using portable computing device 104 and saved to Vehicle Estimating Server 202. By way of example, for the 2017 O'Reilly, Table 1110 in FIG. 11B shows the final estimate to repair the front bumper, Table 1112 in FIG. 11C shows the final estimate to repair the grille, Table 1114 in FIG. 11D shows the final estimate to repair the headlights, Table 1116 in FIG. 11E shows the final estimate to repair the hood, and Table 1118 in FIG. 11F shows the final estimate to repair the front suspension. The summary of the Final Estimate is shown in Table 1120 in FIG. 11G.

4. Detailed Description of the Method of using the System Described Herein.

a. Data Entry and Written Reports.

In the preferred embodiment, the Microsoft Windows Server operating system and the Microsoft Access database management software permit the data populating the first data set, the second data set, the third data set, the fourth data set, the fifth data set, the sixth data set, the seventh data set, the eighth data set, the ninth data set, the tenth data set, the eleventh data set, the twelfth data set, and the thirteenth data set, to be entered by, deleted by, updated by, and displayed on Inside Adjuster Workstation 206, Parts Workstation 226, Labor Workstation 238, Shop Workstation 252, and Portable Computing Device 104. Portable Computing Device 104 is preloaded with Windows Speech Recognition software.

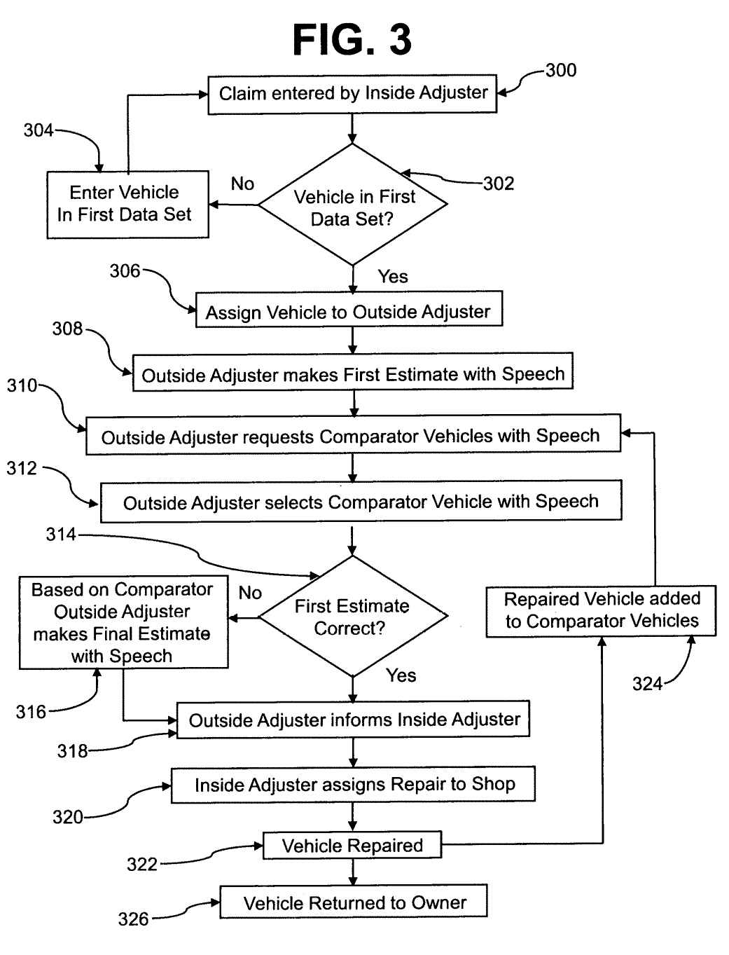

The flowchart in FIG. 3 gives the major steps in estimating the cost to repair a damaged vehicle according to the invention described herein. In Step 300, a claim is entered by Inside Adjuster 208. As shown in Step 302, Inside Adjuster 208 queries the first data set to determine if the make, model, and year of the damaged vehicle is already entered in the first data set. If not, Inside Adjuster 208 enters the data depicted in Table 400 of FIG. 4 for the damaged vehicle according to Step 304. In Step 306, Inside Adjuster 208 assigns the vehicle to Outside Adjuster 102. Using speech recognition technology, Outside Adjuster 102 makes the First Estimate to repair the damaged vehicle as noted in Step 308. Continuing to use speech recognition, Outside Adjuster 102 requests Comparator Vehicles to be listed according to Step 310. In Step 312, Outside Adjuster 102 selects a Comparator Vehicle. He or she then determines if the First Estimate is correct when compared against an actual repair of the Comparator Vehicle as shown in Step 314. In Step 316, if Outside Adjuster 102 determines the First Estimate must be updated, he or she makes a Final Estimate based on the repair of the selected Comparator Vehicle. If the First Estimate is acceptable, or the Final Estimate has been made, Outside Adjuster 102 informs Inside Adjuster 208 that the estimate is complete as shown in Step 318. In Step 320, Inside Adjuster 208 assigns the repair to a repair shop, represented by Shop 250. Shop 250 makes the repair as noted in Step 322. The repaired vehicle joins the ranks of potential Comparator Vehicles as shown in Step 324. In Step 326, the repaired vehicle is returned to the owner.

Referring to FIG. 2, as one or more vehicles are repaired by one or more collision repair shops, a shop represented by Shop 250, actual repair data are entered into the Shop Server 234 by Shop Technician 254 using Shop Workstation 252. The data populate the previously described ninth data set, the tenth data set, the eleventh data set, the twelfth data set, and the thirteenth data set. By way of example, the data described here for the 2016 Comparator 3 are depicted in Tables 1500, 1502, 1504 in FIG. 15, Tables 1506 and 1508 in FIG. 15A, Table 1510 in FIG. 15B, Table 1512 in FIG. 15C, Table 1514 in FIG. 15D, Table 1516 in FIG. 15E, Table 1518 in FIG. 15F, and Table 1520 in FIG. 15G. There may be more than one table containing the data for the 2016 Comparator 3. All tables with data related to a particular vehicle are linked via the vehicle's unique VIN.

The data stored in the Shop Server 234 provides the basis upon which a First Estimate for one or more damaged vehicles, one depicted here as Item 100, prepared by Outside Adjuster 102, is compared to actual repair cost data for the same or similar vehicles suffering the same or similar damage under the same or similar circumstances.

After a front-end collision, an insured vehicle owner informs his or her insurance company of the collision. By way of example for a front end collision involving the 2017 O'Reilly Limited 4-Door Sedan, Inside Adjuster 208, using Insider Adjuster Workstation 206, enters the claim by populating the fifth data set, the sixth data set, the seventh data set, and the eighth data set. Multiple tables referring to the same vehicle are linked by the vehicle's VIN. The data are stored in Vehicle Information Server 204. The fifth data set is populated with the data depicted in Tables 1000 and 1002 in FIG. 10, the sixth data set with the data shown in Table 1004 in FIG. 10, the seventh data set with the data depicted in Table 1006 in FIG. 10A, and the eighth data set with the data shown in Table 1008 in FIG. 10A.

Before assigning the claim to Outside Adjuster 102, Inside Adjuster 208 determines if the vehicle is among the vehicles saved to the first data set, images of its parts and parts costs are saved to the second data set, and local labor rates are saved to the fourth data set. In this instance, Inside Adjuster 208 finds data for the 2017 O'Reilly Limited 4-Door Sedan is already saved to the first data set as shown by the thirteenth row in Table 400 of FIG. 4. Further, Inside Adjuster 208 finds images of the major areas comprising the 2017 O'Reilly are saved to the second data set as depicted in FIGS. 5, 6, 7, 8, and 9. Inside Adjuster 208 also finds parts lists and parts costs for OEM, A/M Certified, and LKQ parts to the second data set and linked to appropriate images as shown in Table 538 in FIGS. 5A, Table 620 in FIG. 6A, Table 738 in FIG. 7A, Table 820 in FIG. 8A, and Table 930 in FIG. 9A. Inside Adjuster 208 further finds local labor rates saved to the fourth data set as shown in Table 2100 in FIG. 21 for all types of repair work under the column titled, “Repair Work Descriptions,” and corresponding local labor rates under the column titled, “Any Company Collision Estimating 2017 Labor Rate ($/Hour).”

Inside Adjuster 208 next informs Outside Adjuster 102 that Vehicle 100 has suffered a front end collision and requires an estimate to repair the damage. Outside Adjuster 102 either goes to the vehicle's location displayed on his portable computing device 104, or the vehicle is driven or trailered to a central claims adjustment location. Outside Adjuster 102 inspects Item 100 for damage and simultaneously speaks into Item 104 with his or her confirmation of the vehicle make, model, year, and VIN; assesses the vehicle's pre-collision condition, the collision severity, and the damaged areas. In this activity, Outside Adjuster 102 confirms the data previously entered by Inside Adjuster 208, and presented here in Tables 1002, 1004, 1006, and 1008, or makes updates as required for correctness.

Outside Adjuster 102 makes a First Estimate to repair Item 100. Outside Adjuster 102 speaks into Item 104, first identifying each major area that requires repair. Taking each major area one-by-one, he or she speaks into Item 104 the labor types and operations to make the repair, and the parts and parts sources to complete the repair. As Outside Adjuster 102 is speaking, the data previously entered in the second data set—images of parts and parts lists comprising major areas—and in the fourth data set—labor types, labor operations, abbreviations, and local labor rates—populate the estimate. The data populating the First Estimate is shown in Tables 1010 and 1012 in FIG. 10B for the front bumper and grille, respectively, and Tables 1014 and 1016 in FIG. 10C for the headlights and hood, respectively. Table 1018 in FIG. 10C shows the total cost of the First Estimate. The data comprising the First Estimate are saved to the Vehicle Estimating Server 202.

Once Outside Adjuster 102 confirms, corrects, and saves the data for the 2017 O'Reilly shown in Tables 1002, 1004, 1006, and 1008, a first algorithm in Vehicle Estimating Server 202 populates the fourteenth data set with a table containing the data shown in the Row 1314 of Table 1300 in FIG. 13.

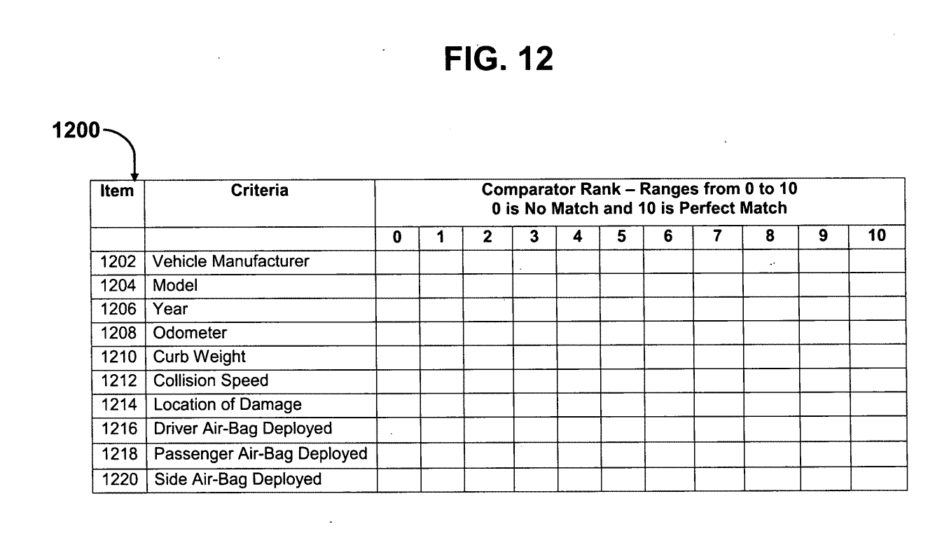

Using a spoken command, Outside Adjuster 102 triggers a second algorithm resident in Vehicle Estimating Server 202. The second algorithm calculates a number which ranks each vehicle against the 2017 O'Reilly for first estimate correction purposes based on same or similar vehicles suffering the same or similar damage under the same or similar circumstances. The comparison is based on the criteria depicted in Rows 1202, 1204, 1206, 1208, 1210, 1212, 1214, 1216, 1218, and 1220 in Table 1200 in FIG. 12. Each criterion is given a rank that ranges from 0 to 10. A perfect match occurs when criteria Items 1202 to 1212 are identical, each with a Rank of 10, for a Total Rank of 100. By way of example, the rules for ranking listed in FIG. 12 are:

Row 1202, “Vehicle Manufacturer”: If identical, A=10; all others, A=0.

Row 1204, “Model”: If identical, B=10; all others, B=0.

Row 1206, “Year”: If identical, C=10; for each one-year damaged vehicle's year of manufacture differs from the comparator vehicle's year of manufacture reduces C by 1, C is never less than 0.

Row 1208, “Odometer”: If identical, D=10; for each 1,000 Miles damaged vehicle's odometer reading differs from the comparator vehicle's odometer reading reduces D by 1, D is never less than 0.

Row 1210, “Curb Weight”: If identical, E=10; for each 100 LBS damage vehicle's curb weight differs from the comparator vehicle's curb weight reduces E by 1, E is never less than 0.

Row 1212, “Collision Speed”: If identical, F=10; for each 2 MPH damaged vehicle's collision speed differs from the comparator vehicle's collision speed reduces F by 1, F is never less than 0.

Row 1214, “Location of Damage”: If identical, G=10; any other difference between damage vehicle's damage location and comparator vehicle's damage location, G=0.

Row 1216, “Driver Air-Bag Deployed”: If both damaged vehicle's and comparator vehicle's driver air-bag and comparator vehicle's deployed or did not deploy, H=10, if any difference, H=0.

Row 1218, “Passenger Air-Bag Deployed”: If both damaged vehicle's and comparator vehicle's passenger air-bag deployed or did not deploy, I=10, if any difference, I=0.

Row 1220, “Side Air-Bags Deployed”: If both damaged vehicle's and comparator vehicle's side air-bags deployed or did not deploy, J=10, if any difference, J=0.

The second algorithm calculates the Total Rank as follows; Total Rank=A+B+C+D+E+F+G+H+I+J. By way of example and using the 10 criteria shown in Rows 1202 to 1220 in Table 1200 in FIG. 12, the Total Rank for each of the six vehicles represented by Rows 1302 to 1312 in FIG. 13 are shown under the column titled, “Total Rank.” The Total Rank ranges from 48 to 79; with the highest two, 73 and 79, for the 2017 Comparator 1 Sport 4-Door Sedan and the 2016 Comparator 3 Luxury 4-Door Sedan, respectively.

A portion of the data depicted in Table 1300 in FIG. 13 is displayed to Outside Adjuster 102 on Item 104. In the absence of an exact match, as represented by a Total Rank=100, using a speech command, 102 selects the vehicle with the highest Total Rank as the Comparator Vehicle; here it is the 2016 Comparator 3 Luxury 4-Door Sedan, represented by Row 1306 in Table 1300.

Once 102 selects the 2016 Comparator 3 as the Comparator Vehicle, the data depicted in Tables 1500, 1502, 1504 in FIG. 15, Tables 1506 and 1508 in FIG. 15A, Table 1510 in FIG. 15B, Table 1512 in FIG. 15C, Table 1514 in FIG. 15D, Table 1516 in FIG. 15E, Table 1518 in FIG. 15F, and Table 1520 in FIG. 15G, are displayed on Item 104.

Using the actual parts and labor costs required to repair the 2016 Comparator 3, 102 is able to overcome the deficiencies in the prior art of automobile collision repair estimating based on “[i]f you can't see it, don't write it.” Outside Adjuster 102 is, in real-time, shown the actual repair parts and labor used to repair a Comparator Vehicle suffering a similar front-end collision under similar circumstances to the vehicle whose damage is being estimated to repair; the 2017 O'Reilly. Outside Adjuster 102 is immediately provided the information needed to add parts and labor costs for repair that could not be seen thereby reducing or eliminating the need for one or more supplemental estimates.

In the collision repair estimate for the 2017 O'Reilly, Outside Adjuster 102 notes that the Comparator Vehicle's front-end collision required substantially more parts and labor to repair, as shown in Tables 1510, 1512, 1514, 1516, and 1518, than what he or she estimated as a First Estimate. Outside Adjuster 102 then makes an immediate decision whether or not to amend the First Estimate.

Here, Outside Adjuster 102 amends the First Estimate to account for the increased number of actual parts and labor hours to repair the similarly sized and damaged 2016 Comparator 3; thereby creating a Final Estimate. The tables comprising the Final Estimate populate the sixteenth data set. They are depicted by Table 1110 in FIG. 11B, Table 1112 in FIG. 11C, Table 1114 in FIG. 11D, Table 1116 in FIG. 11E, Table 1118 in FIG. 11F, and summary in Table 1120 in FIG. 11G.

The summarized First Estimate and Final Estimate, shown in Tables 1018 and 1120, respectively, are compared are shown below:

Comparison of Collision Repair Estimates for the hypothetical
2017 O'Reilly Limited 4-Door Sedan based on the Prior Art
and the Invention described herein

| | | | Table 1120 in FIG. 11G | | |
|---|---|---|---|---|---|
| | | | (Based on Invention | | |
| Table 1018 in FIG. 10C | | | described herein) | | |
| (Based on Prior Art) | | | | | Estimate |
| Item | Calculation | Estimate ($) | Item | Calculation | ($) |
| Parts | | 1,680.00 | Parts | | 4,043.00 |
| Repair | 9.2 Hours × | 460.00 | Repair | 15.5 Hours × | 775.00 |
| Labor | $50.00/hour | | Labor | $50.00/hour | |
| Refinish | 3.25 Hours × | 130.00 | Refinish | 5.5 Hours × | 220.00 |
| Labor | $40.00/hour | | Labor | $40.00/hour | |
| Total | | $2,270.00 | Total | | $5,038.00 |

The revised estimate is given the title, “Final Estimate,” to distinguish it from the estimate made under the prior art; the “First Estimate.” Once it is saved to the Vehicle Estimating Server 202, Inside Adjuster 208 assigns it to one of a plurality of vehicle collision repair shops, such as Shop 250, according to instructions from the insured or the insurance company.

Shop Technician 254 of Shop 250 downloads the Final Estimate uploaded by Outside Adjuster 102 for the 2017 O'Reilly associated with the claim entered by Inside Adjuster 208. Shop Technician 254 is confident that the Final Estimate will accurately estimate the parts and labor necessary to make the repair.

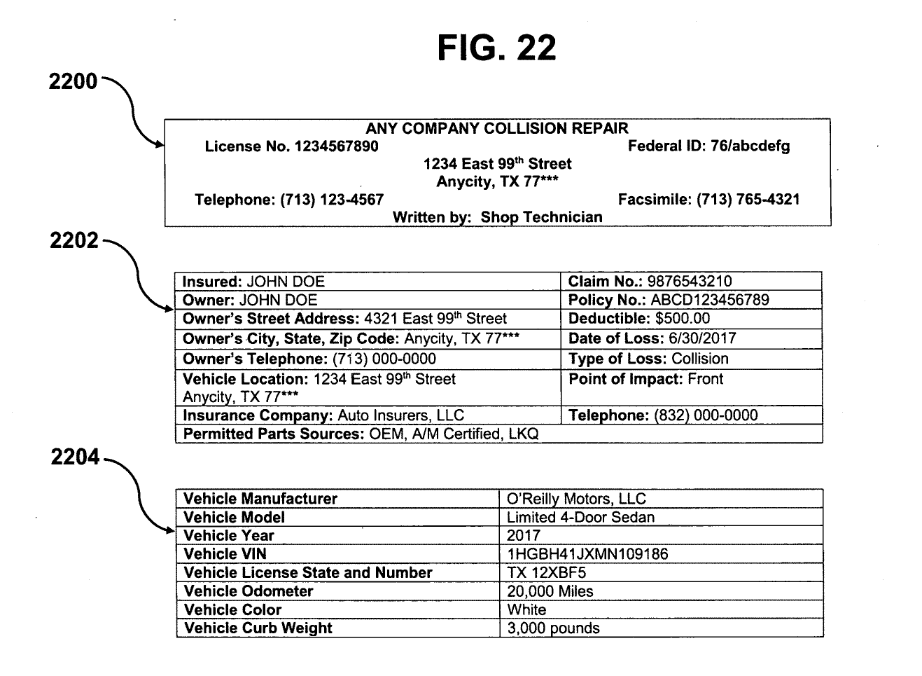

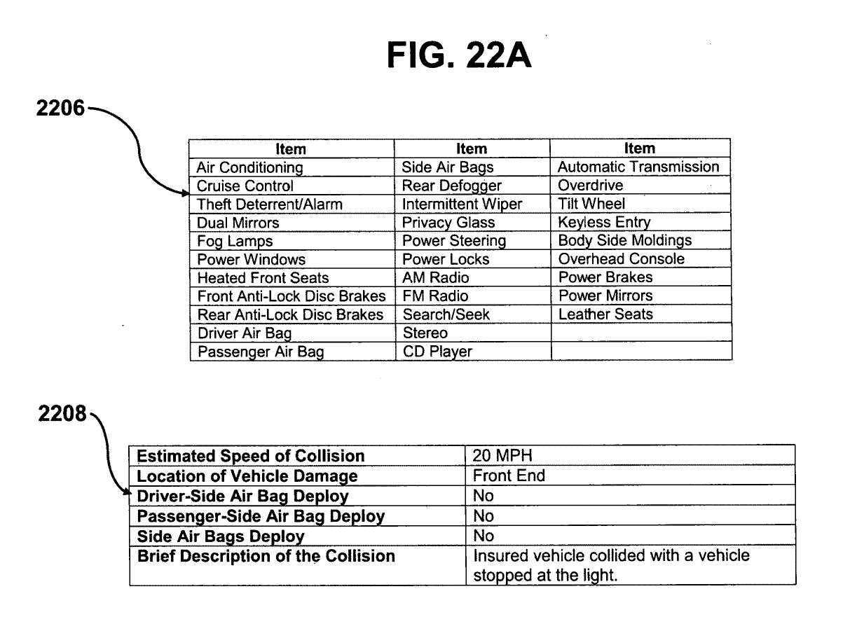

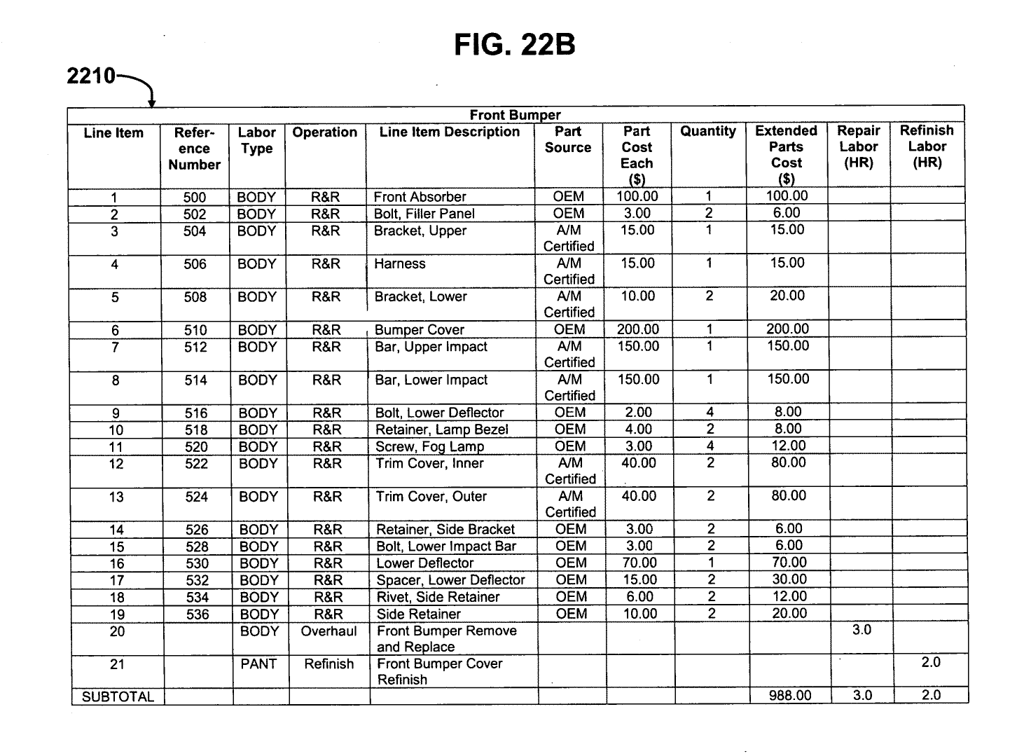

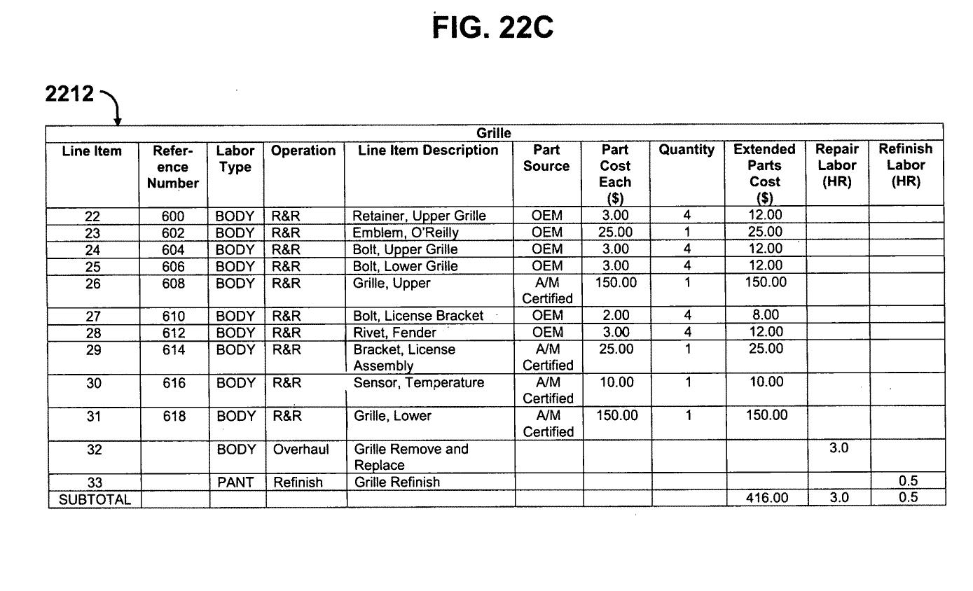

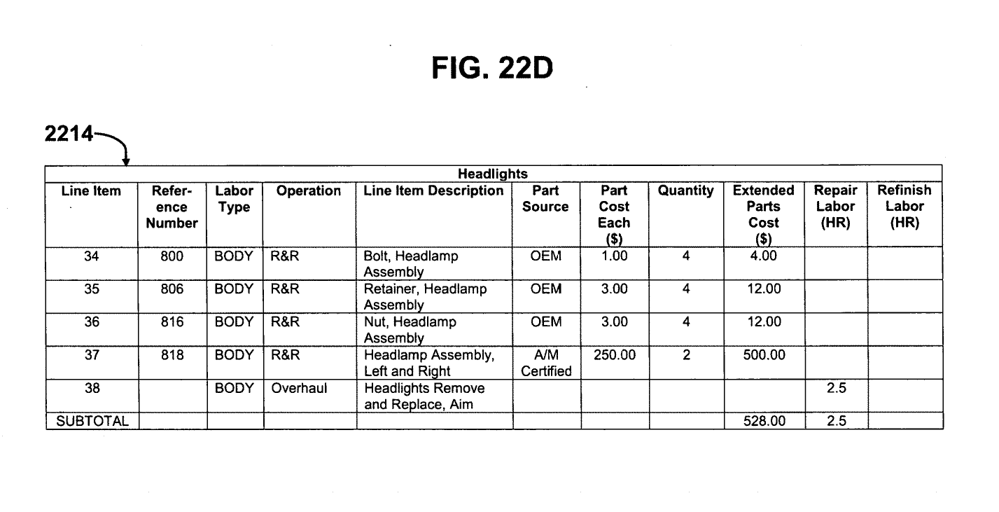

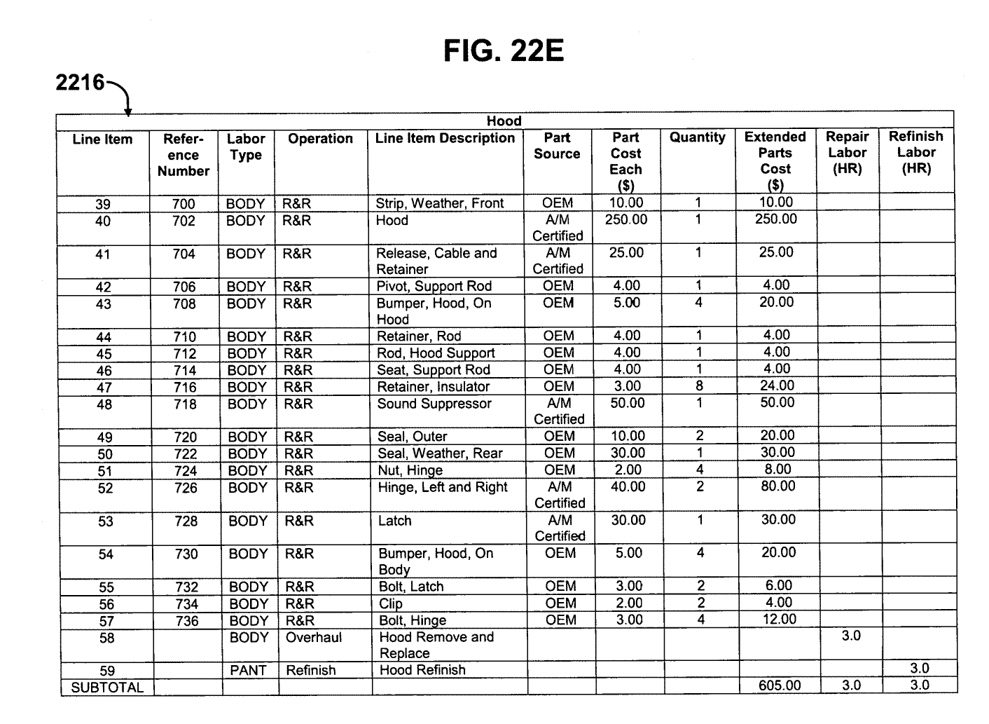

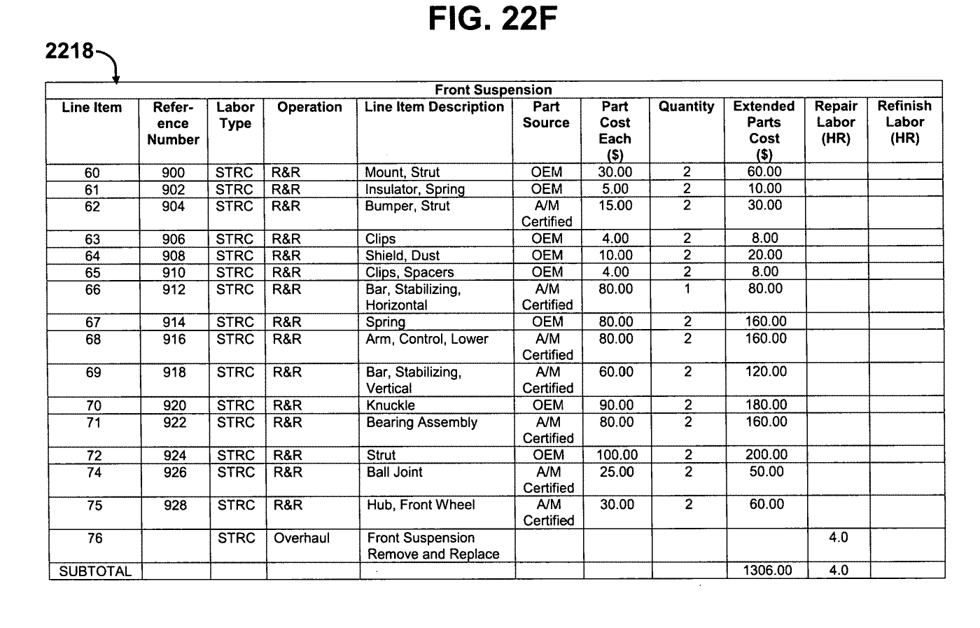

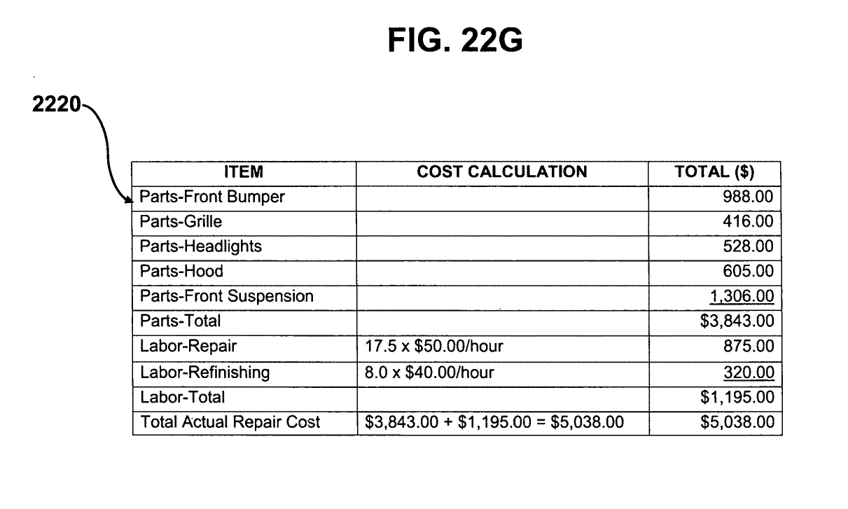

Noting the parts and labor shown on the Final Estimate, Shop Technician 254 disassembles the front-end of the vehicle. The vehicle is repaired resulting in an actual list of parts and the labor required for the repair. After the repair is complete, Shop Technician 254 prepares a Collision Repair Report for the 2017 O'Reilly. The Collision Repair Report is shown in Tables 2200, 2202, and 2204 in FIG. 22, Tables 2206 and 2208 in FIG. 22A, Table 2210 in FIG. 22B, Table 2212 in FIG. 22C, Table 2214 in FIG. 22D, Table 2216 in FIG. 22E, Table 2218 in FIG. 22F, and the summary in Table 2220 in FIG. 22G.

The total estimated parts and labor costs for the repair of the 2017 O'Reilly are $4,043.00 for parts, $775.00 for repair labor, and $220.00 for refinishing labor as shown in Table 1120 in FIG. 11G. This compares to the total actual parts and labor costs for the repair of the 2017 O'Reilly of $3,843.00 for parts, $875.00 for repair labor, and $320.00 for refinishing labor as shown in Table 2220 in FIG. 22G.

Although the actual estimated parts and labor costs differed from the actuals, the total estimated and actual repair costs were equal. Shop Technician 254 was authorized to use OEM, A/M Certified, or LKQ parts as he or she determined. Under that authority, Shop Technician 254 substituted A/M Certified parts for OEM parts thereby reducing the total parts costs which equally offset the slightly higher costs for repair and refinishing. This is not uncommon to those persons of skill in the art of automobile collision repair; thereby showing the benefits of the invention described herein. The before and after views of the repaired 2017 O'Reilly are shown, respectively, in Items 1400 and 1402 in FIG. 14.

Using Item 252, Shop Technician 254 uploads the collision repair data for the 2017 O'Reilly to Shop Server 234. The database management system saves the data in Tables 2200 and 2202 to the ninth data set, the data in Table 2204 to the tenth data set, the data in Table 2206 to the eleventh data set, the data in Table 2208 to the twelfth data set, and the data in Tables 2212, 2214, 2216, 2218, and 2220 to the thirteenth data set. The data may be displayed to Outside Adjuster 102, Inside Adjuster 208, Parts Clerk 228, and Labor Clerk 240 and also printed as a Collision Repair Report as depicted in FIGS. 22, 22A, 22B, 22C, 22D, 22E, 22F, and 22G on Network Printer 256.

The collision repair data for the 2017 O'Reilly now permits that vehicle to be used as a Comparator Vehicle for updating future repair estimates of identical or similar vehicles suffering same or similar damage under same or similar circumstances. This demonstrates the incremental and iterative features of the invention to achieve vehicle collision repair estimates of ever increasing accuracy.

b. Speech Activated Data Entry and on-line Viewable Reports

In the preferred embodiment, one or more of a plurality of outside adjusters, here represented by Outside Adjuster 102, make their collision repair estimates using a series of words or phrases to command Item 104 to move from screen-to-screen and to control data entry during the estimating process.

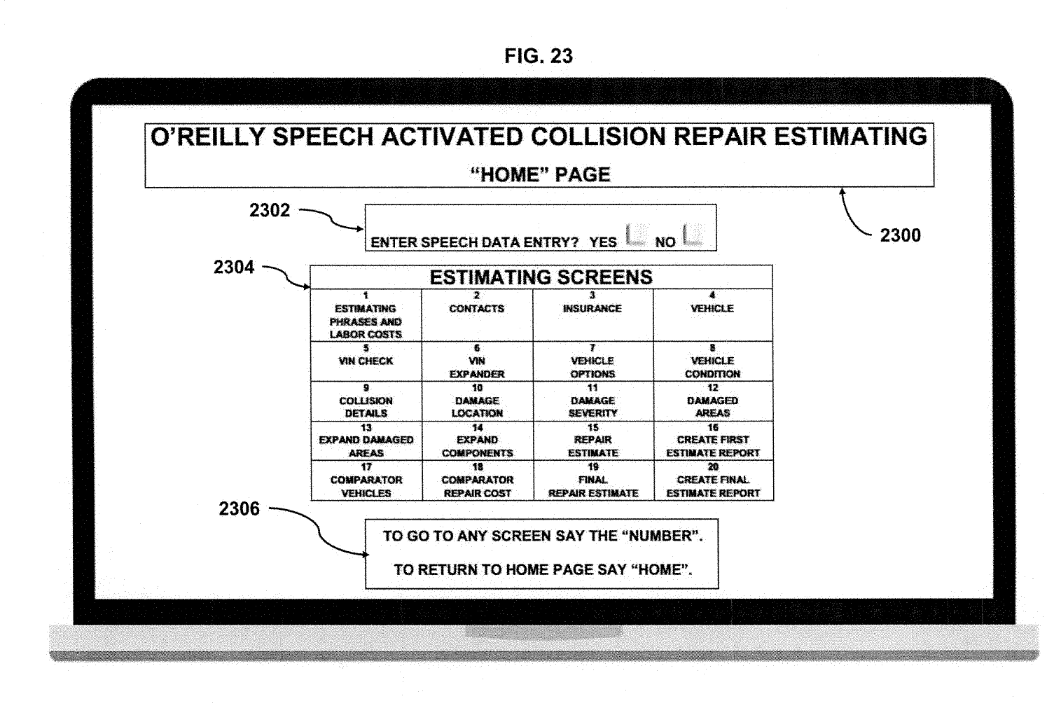

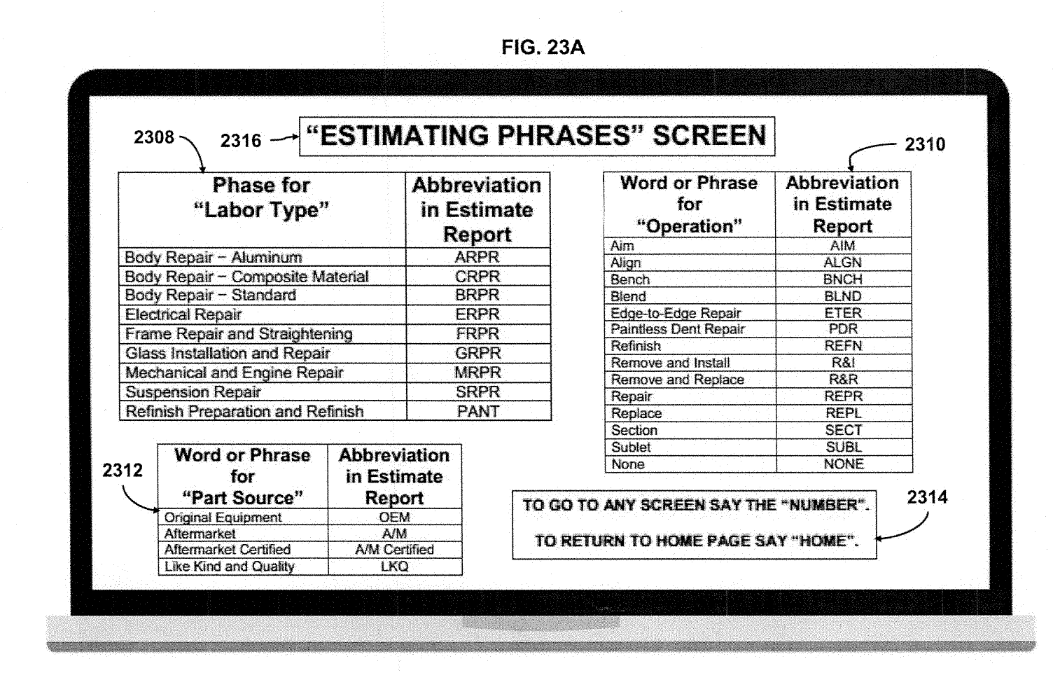

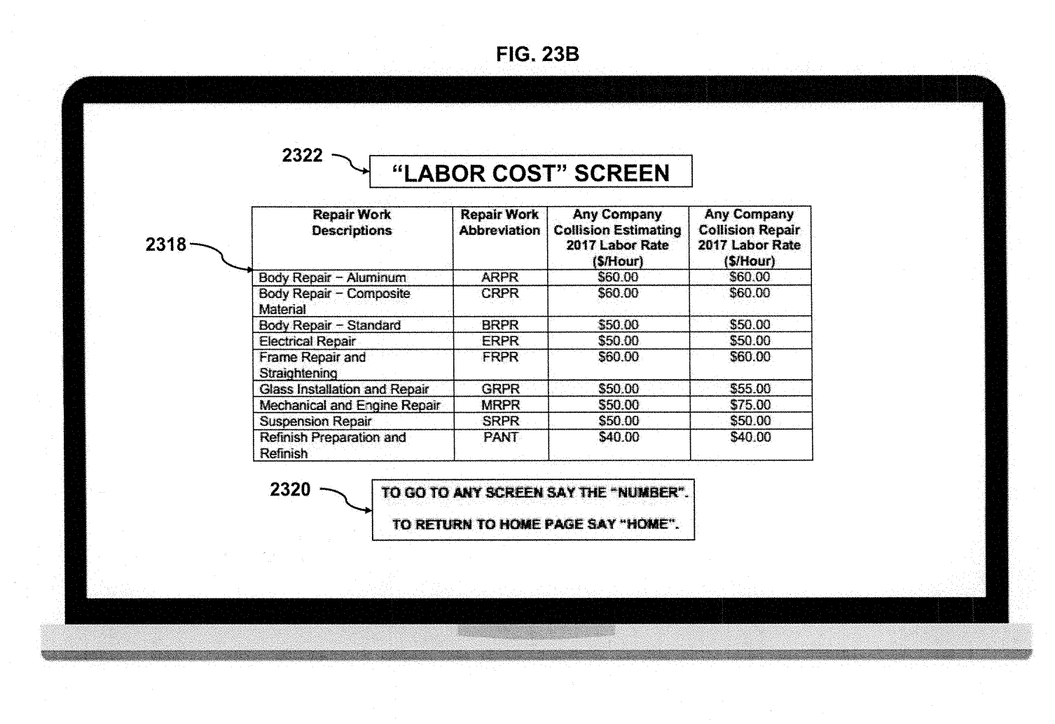

FIG. 23 shows the “Home Page” Screen displayed on Outside Adjuster 102's device 104. The title of the screen is shown in Box 2300. As shown in Box 2302, Outside Adjuster 102 enters speech activated data entry by depressing the “Yes” button by touchscreen or by clicking on a “Yes” button on Portable Computing Device 104. Instructions for navigating screens are shown in Box 2306.

Once the “Yes” button is activated, the estimating software initiates automatic speech recognition mode. From this point forward, Outside Adjuster 102 must use care in speaking to the computer device to properly and efficiently complete an estimate.

Referring to Table 2304 in FIG. 23, from the “Home Page”, Outside Adjuster 102 navigates to other screens by saying the number above each of the 20 boxes that contain numbers displayed on the screen. For example, to access the “Estimating Phrases” Screen, Outside Adjuster 102 says “One”.

While on the “Home Page”, Outside Adjuster 102, says “One”, which accesses the “Estimating Phrases” Screen depicted in FIG. 23A. Box 2316 in FIG. 23A shows the title of the screen. Table 2308 shows the proper spoken phrase for each “Labor Type” that may be needed to complete a repair. Table 2308 also shows the abbreviation for each “Labor Type” that will be entered in an estimating report. For “Labor Type”, Outside Adjuster 102 has the following phrases available for estimating collision repairs: “Body Repair—Aluminum”; “Body Repair—Composite Material”; “Body Repair—Standard”; “Electrical Repair”; “Frame Repair and Straightening”; “Glass Installation and Repair”; “Mechanical and Engine Repair”; “Suspension Repair”; “Preparation and Refinish”, and when selected, with their respective abbreviations entered into the estimate report; ARPR, CRPR, BRPR, ERPR, FRPR, GRPR, MRPR, SRPR, and PANT. The “dash” does not have to be spoken. It is written to clarify that body repairs are further subdivided depending on the material of construction.

Table 2310 in FIG. 23A shows the “Operations” that may be performed under a “Labor Type” as the estimate is made. During the estimate, Outside Adjuster 102 states the particular word or phrase that describes the operation to be performed. The “Operations” words or phrases available for estimating collision repairs are: “Aim”; “Align”; “Bench”; “Blend”; “Edge-to-Edge Repair”; “Paintless Dent Repair”; “Refinish”; “Remove and Install”; “Remove and Replace”; “Repair”; “Replace”; “Section”; “Sublet”; “None”, and when selected, with their respective abbreviations entered into the estimate report; AIM, ALGN, BNCH, BLND, ETER, PDR, REFN, R&I, R&R, REPR, REPL, SECT, SUBL, and NONE.

Table 2312 in FIG. 23A further shows the spoken words or phrases to select a “Parts Source” as the estimate is made. During the estimate, Outside Adjuster 102 states the particular word or phrase that describes the parts source. The “Parts Source” words or phrases available for estimating collision repairs are: “Original Equipment”; “Aftermarket”; “Aftermarket Certified”; “Like Kind and Quality”, and when selected their respective abbreviations are entered into the estimate report; OEM, A/M, A/M Certified, or LKQ. Table 2314 instructs Outside Adjuster 102 to say “Home” to return to the “Home Page”.

The “Estimating Phrases” Screen has a second page titled, “Labor Cost” Screen, as shown in Box 2322 in FIG. 23B. Table 2318 displays to Outside Adjuster 102 the “Any Company Collision Estimating 2017 Labor Rate ($/Hour)” and the “Any Company Collision Repair 2017 Labor Rate ($/Hour)”. Table 2320 instructs Outside Adjuster 102 to say “Home” to return to the “Home Page”.

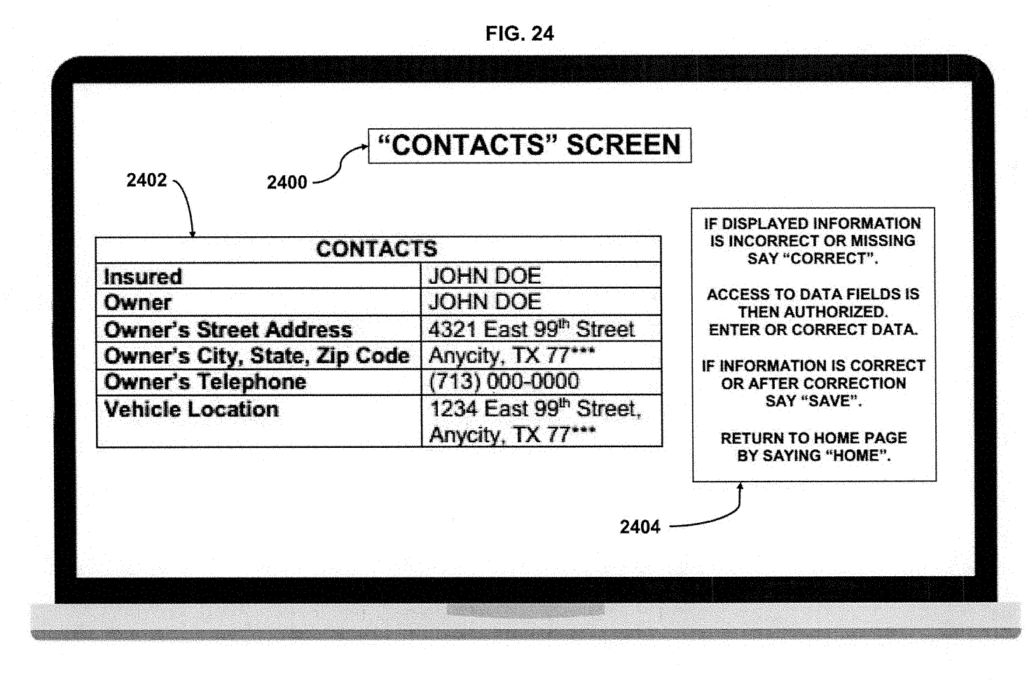

Referring to Table 2304, from the “Home Page” and by saying “Two”, Outside Adjuster 102 accesses the screen titled “Contacts” Screen depicted in Box 2400 in FIG. 24. Table 2402 displays the Insured's name, Owner's Name, Owner's Street Address, Owner's City, State, Zip Code, Owner's Telephone Number, and Vehicle Location. This is the same information entered by Inside Adjuster 208. If the displayed information is correct, Outside Adjuster 102, following the instructions in Table 2404, says “Save” and returns to the “Home Page” by saying “Home”. The data is saved to Vehicle Information Server 204.

If information in the “Contacts” Screen is missing or incorrect, Outside Adjuster 102 has the ability to make entries or corrections. In this instance, Outside Adjuster 102, again following the instructions in Table 2402, says, “Correct”. Access to the data fields is then authorized. Outside Adjuster 102 then enters or corrects the data. Once the information is correct, Outside Adjuster 102 says “Save” and returns to the “Home Page” by saying “Home”. The corrected information is saved to Vehicle Information Server 204.

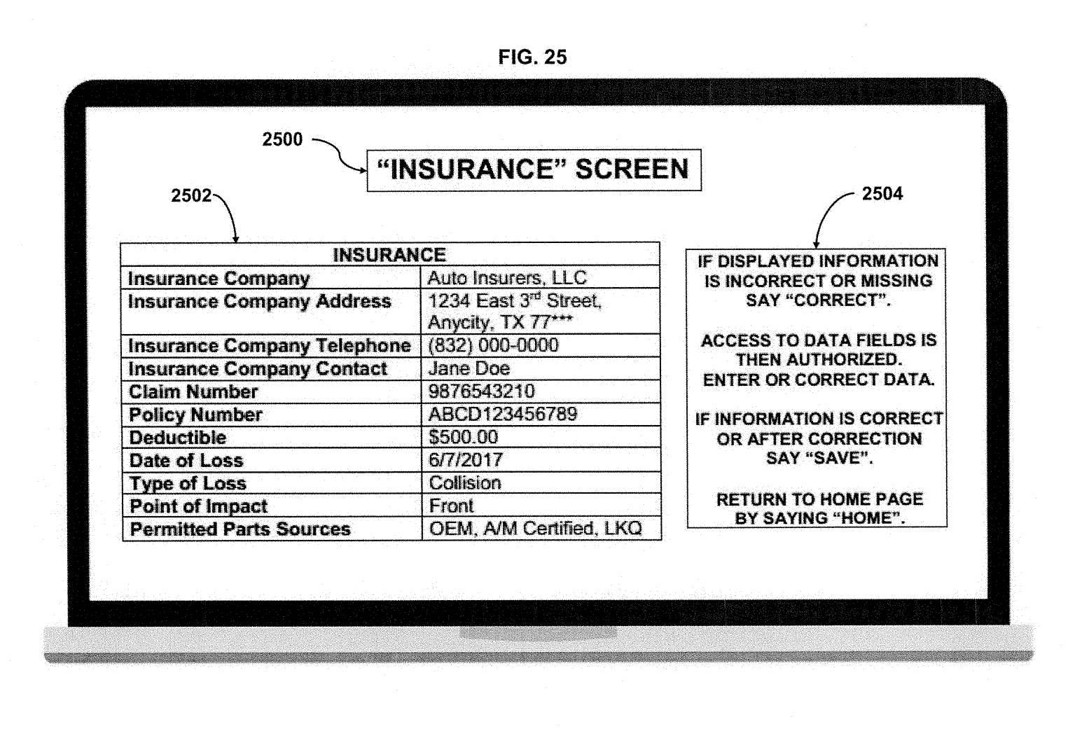

From the “Home Page” and by saying “Three”, Outside Adjuster 102 accesses the screen titled “Insurance” Screen depicted in Box 2500 in FIG. 25. As shown in Table 2502, the “Insurance” Screen displays the Insurance Company, Insurance Company Address, Insurance Company Telephone, Insurance Company Contact, Claim Number, Policy Number, Deductible amount, Date of Loss, Type of Loss, Point of Impact, and Permitted Parts Sources. This is the same information entered by Inside Adjuster 208. If the displayed information is correct, Outside Adjuster 102, following the instructions in Table 2504, says “Save” and returns to the “Home Page” by saying “Home”. The data is saved to Vehicle Information Server 204.

If information in the “Insurance” Screen is missing or incorrect, Outside Adjuster 102 has the ability to make entries or corrections. In this instance and as shown in Box 2504, Outside Adjuster 102 says “Correct”. Access to the data fields is then authorized. Outside Adjuster 102 then enters or corrects the data. Once the information is correct, Outside Adjuster 102 says “Save” and returns to the “Home Page” by saying “Home”. The corrected information is then saved to Vehicle Information Server 204.

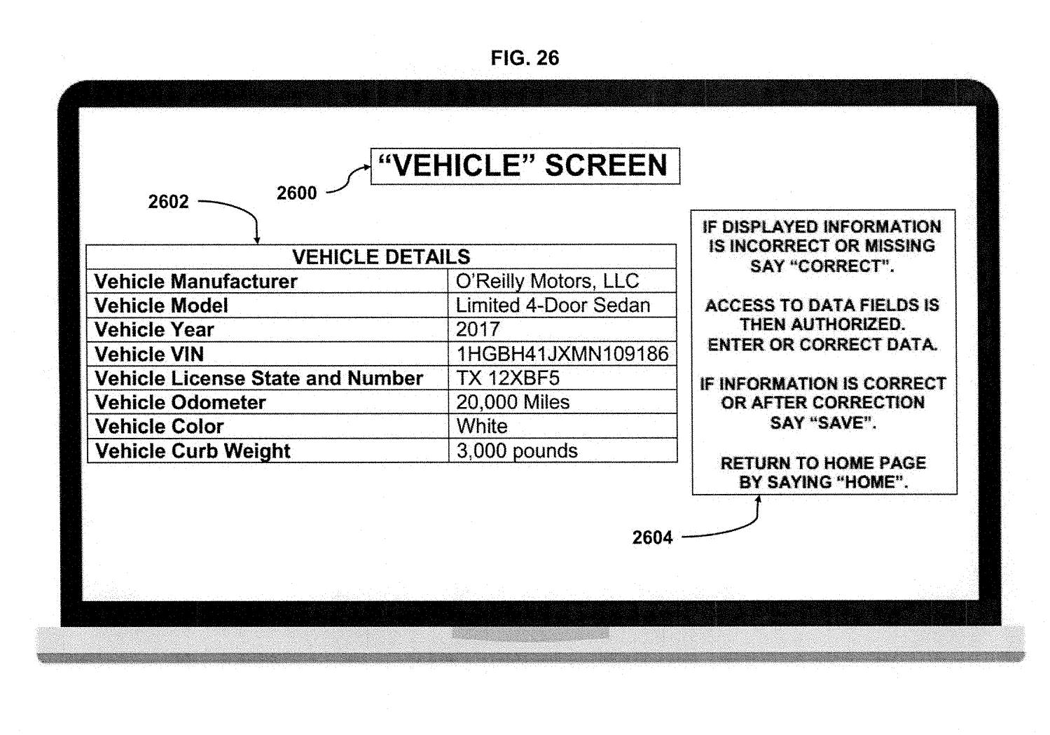

From the “Home Page” and by saying “Four”, Outside Adjuster 102 accesses the screen titled “Vehicle” Screen depicted in Box 2600 in FIG. 26. As shown in Table 2602, the “Vehicle” Screen displays the damaged Vehicle Manufacturer, Vehicle Model, Vehicle Year, Vehicle VIN, Vehicle License State and Number, Vehicle Odometer reading, Vehicle Color, and Vehicle Curb Weight. This is the same information entered by Inside Adjuster 208. If the displayed information is correct, Outside Adjuster 102, following the instructions in Table 2604, says “Save” and returns to the “Home Page” by saying “Home”. The data is saved to Vehicle Information Server 204.

If information in the “Vehicle” Screen is missing or incorrect, Outside Adjuster 102 has the ability to make entries or corrections. In this instance and as shown in Box 2604 Outside Adjuster 102 says, “Correct”. Access to the data fields is then authorized. Outside Adjuster 102 then enters or corrects the data. Once the information is correct, Outside Adjuster 102 says “Save” and returns to the “Home Page” by saying “Home”. The corrected information is then saved to Vehicle Information Server 204.

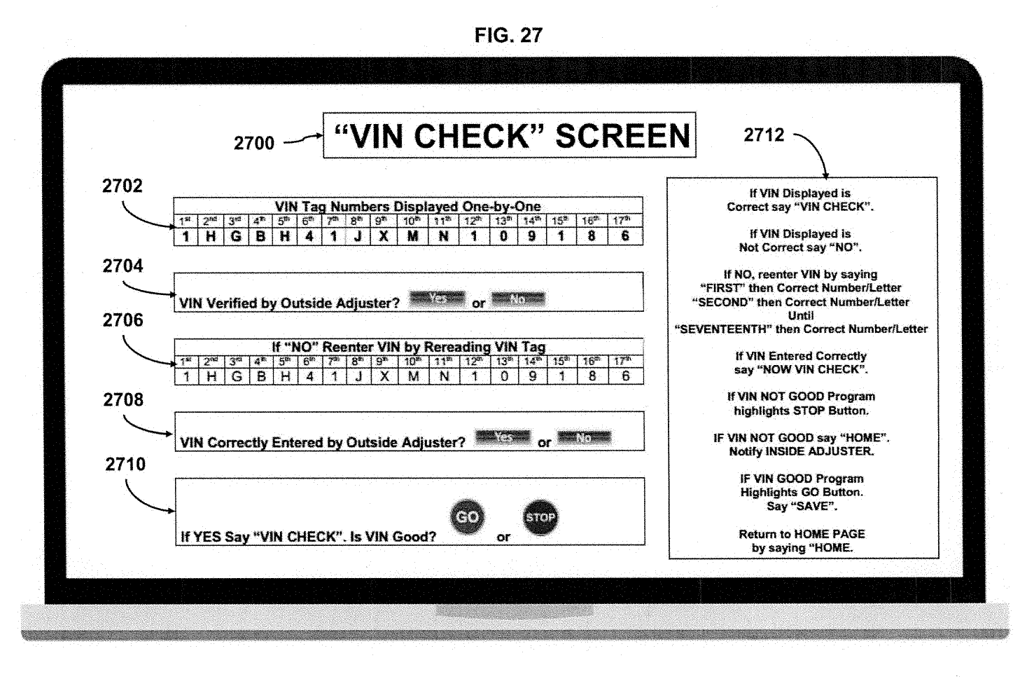

From the “Home Page” and by saying “Five”, Outside Adjuster 102 accesses the screen titled the “VIN Check” Screen depicted in Box 2700 in FIG. 27. The “VIN Check” Screen displays the damaged vehicle VIN in Table 2702 as entered by Inside Adjuster 208. Referring to Table 2702, Outside Adjuster 102 checks each of the 17 letters and numbers displayed on the screen against those on the vehicle's VIN tag. As shown in Box 2704, if the displayed VIN matches the VIN tag, Outside Adjuster 102 answers the question, “VIN Verified by Outside Adjuster?” by saying “Yes”. As shown in Box 2710, if “Yes”, Outside Adjuster 102 says “VIN Check”. Using software known to those skilled in the art of detecting fraudulent VINs, the software checks the VIN to ensure it is valid. If the VIN is not fraudulent, the software highlights the green “GO” button. Following the instructions in Box 2712, Outside Adjuster 102 returns to the “Home Page” by saying “Home”.

As shown in Box 2710, if the VIN is fraudulent, the software highlights the red “STOP” button. Outside Adjuster 102 returns to the “Home Page” by saying “Home” and notifies Inside Adjuster 208. The software tags the VIN as fraudulent and same is saved to Vehicle Information Server 204.

Referring to Box 2704 and Table 2706 in FIG. 27, if the displayed VIN does not match the VIN tag, Outside Adjuster 102 answers the question, “VIN Verified by Outside Adjuster?” by saying “No”. As shown in Table 2706, if “No”, the software opens a row of 17 boxes under the heading, “If “NO” Reenter VIN by Rereading VIN Tag”. Outside Adjuster 102, then reenters the VIN letters and numbers one-by-one from the VIN Tag by saying “First” then the correct number or letter, “Second” then the correct number or letter, and so on until the “Seventeenth” correct number or letter is stated. Referring to Box 2708, Outside Adjuster 102 answers the question “VIN Correctly Entered by Outside Adjuster?” by saying “Yes”. If the VIN is entered correctly and following the instructions in Box 2712, Outside Adjuster 102 says “Now VIN Check”. Using software known to those skilled in the art of detecting fraudulent VINs, the software checks the VIN to ensure it is valid.

As depicted in Box 2710, if the VIN is not fraudulent, the software highlights the green “GO” button. Outside Adjuster 102 returns to the “Home Page” by saying “Home”. The verified VIN is saved to Vehicle Information Server 204.

Again referring to Box 2710, if the VIN is fraudulent, the software highlights the red “STOP” button. Outside Adjuster 102 returns to the “Home Page” by saying “Home” and notifies Inside Adjuster 208. The software tags the VIN as fraudulent and same is saved to Vehicle Information Server 204.

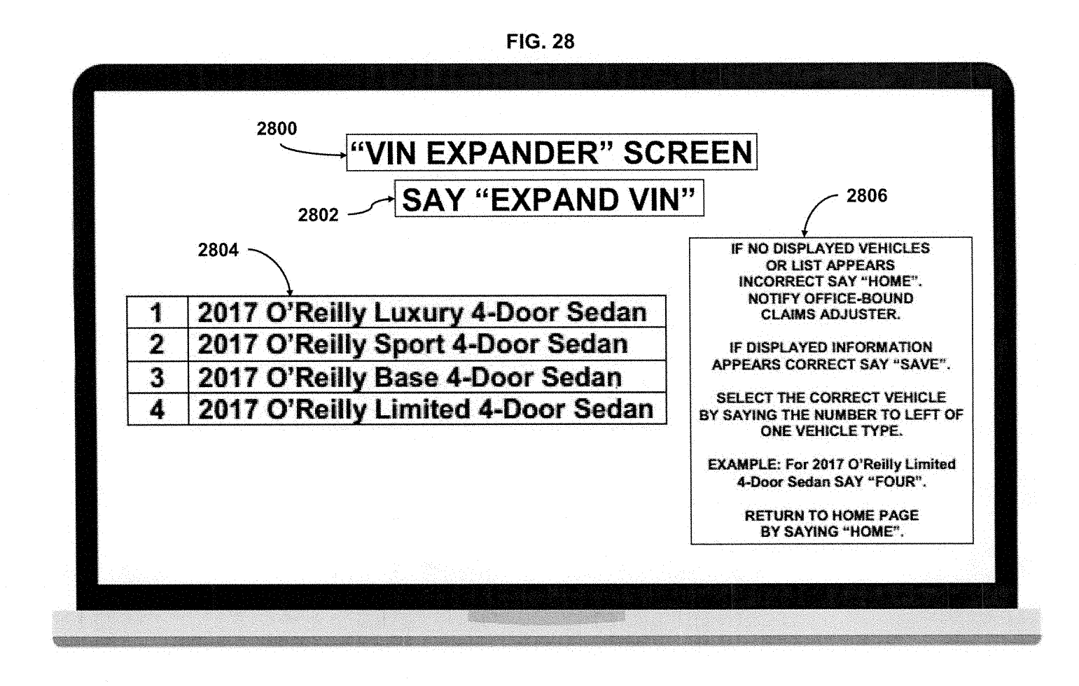

From the “Home Page” and by saying “Six”, Outside Adjuster 102 accesses the screen titled “VIN Expander” Screen as depicted in Box 2800 in FIG. 28. As shown in Box 2802, Outside Adjuster 102 says “Expand VIN”. The software then displays the vehicle types and models with this VIN. By way of example and as shown in Table 2804 in FIG. 28, four vehicle makes and models may have this VIN. They are: (1), 2017 O'Reilly Luxury 4-Door Sedan; (2), 2017 O'Reilly Sport 4-Door Sedan; (3), 2017 O'Reilly Base 4-Door Sedan; and (4), 2017 O'Reilly Limited 4-Door Sedan. Referring to Table 2804 and following the instruction in Box 2806, Outside Adjuster 102 inspects the damaged vehicle and selects the correct vehicle by saying the number next to the correct displayed vehicle. Here, the correct vehicle is the 2017 O'Reilly Limited 4-Door Sedan. Accordingly, Outside Adjuster 102 says “Four”, then says “Save” and returns to the “Home Page” by saying “Home”.

Continuing to follow the instructions in Box 2806, if no vehicles are displayed or none of the displayed vehicles match the make and model of the damaged vehicle, Outside Adjuster 102, returns to the “Home Page” by saying “Home” and notifies Inside Adjuster 208. The software tags the VIN as not matching the damaged vehicle and same is saved in Vehicle Information Server 204.

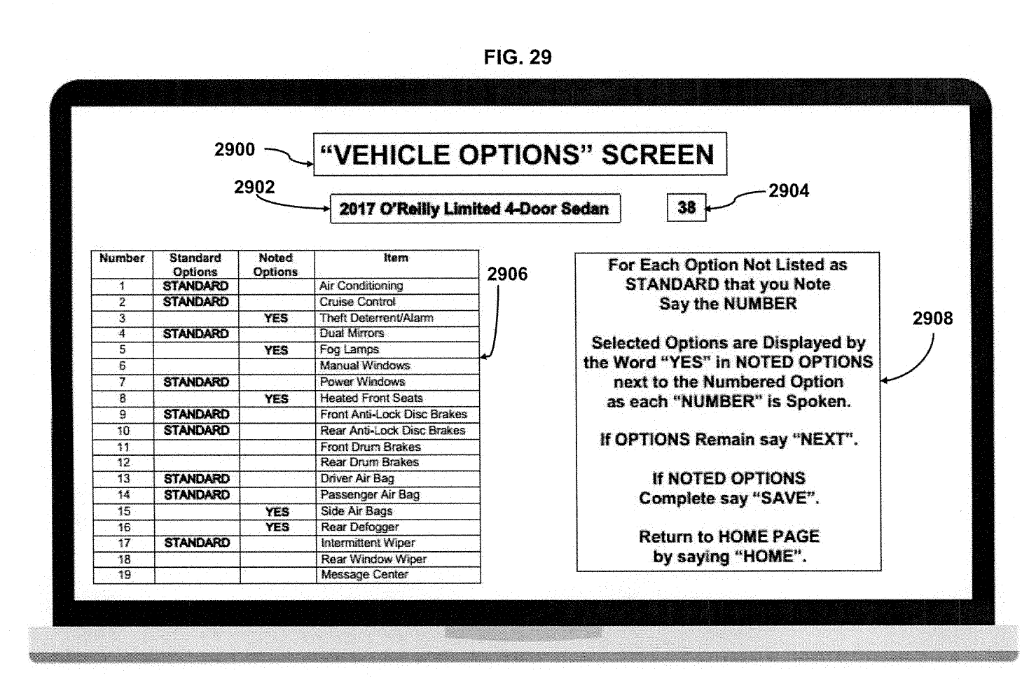

From the “Home Page” and by saying “Seven”, Outside Adjuster 102 accesses the screens titled “Vehicle Options” Screen as depicted in Box 2900 in FIG. 29 and Box 2910 in FIG. 29A. Referring to Box 2902 in FIG. 29 and Box 2912 in FIG. 29A, the screens display the make and model of the vehicle selected in the “VIN Expander” Screen and the total number of available options. Specifically, the make and model is the “2017 O'Reilly Limited 4-Door Sedan” in Boxes 2902 and 2912 and the total number of available options is “38” in the respective Boxes 2904 and 2914. In Table 2906 in FIG. 29 and continuing on to Table 2916 in FIG. 29A, each of the 38 available options is given a number from “1” to “38”. Instructions are given in Boxes 2908 and 2918.

Continuing to refer to Table 2906 in FIG. 29 and Table 2916 in FIG. 29A, the software identifies which of the 38 available options are standard in the 2017 O'Reilly by displaying the word “Standard” next to them in the column titled “Standard Options”. Outside Adjuster 102 inspects the damaged vehicle to identify options unique to the vehicle. As a non-standard option is noted, Outside Adjuster 102 says the “Number” next to that option and then the word “Yes”. The software enters the word “Yes” in the column titled “Noted Options” for the identified option. According to instructions in Boxes 2908 and 2918, if there is only one Noted Option, Outside Adjuster 102 says “Save” then returns to “Home Page” by saying “Home”. The data are saved to Vehicle Information Server 204.

If additional non-standard options remain, Outside Adjuster 102 says “Next”, then the “Number” adjacent to that non-standard option, and then “Yes”. The word “Yes” is entered in the column titled “Noted Options” for that identified option. If all Noted Options are complete, Outside Adjuster 102 says “Save” then returns to “Home Page” by saying “Home”. The data are saved to Vehicle Information Server 204.

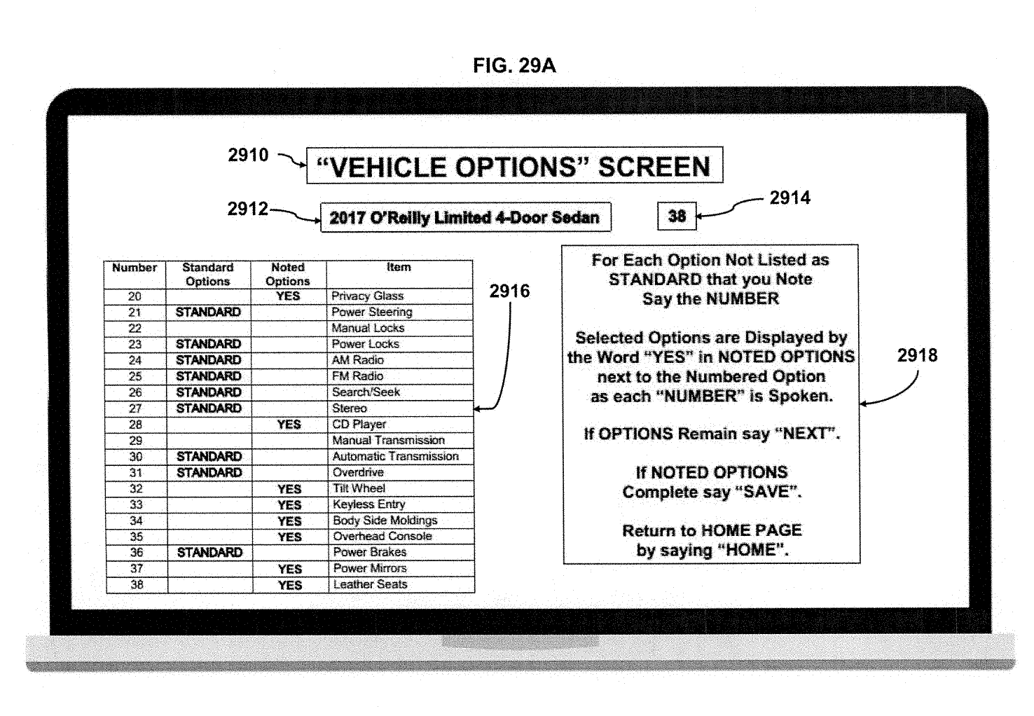

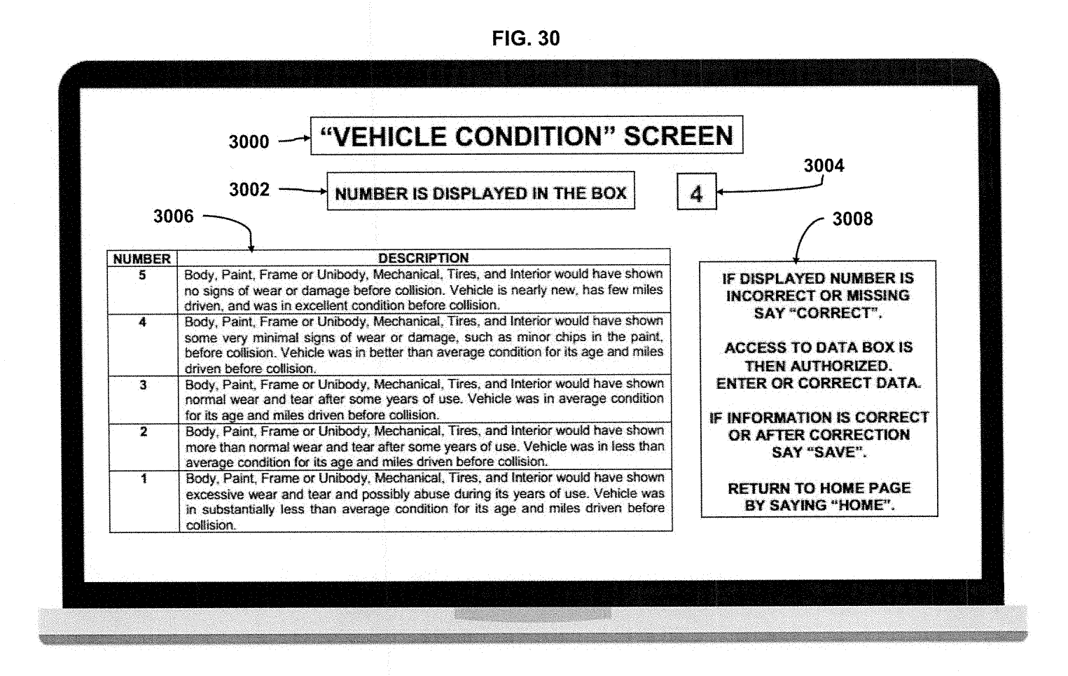

From the “Home Page” and by saying “Eight”, Outside Adjuster 102 accesses the screen titled “Vehicle Condition” Screen as depicted in Box 3000 in FIG. 30. Referring to Table 3006 in FIG. 30, vehicle condition is specified as a number between “1” and “5”. “5” represents a vehicle whose, “Body, Paint, Frame or Unibody, Mechanical, Tires, and Interior would have shown no signs of wear or damage before collision. Vehicle is nearly new, has few miles driven, and was in excellent condition before collision.” “4” represents a vehicle with, “Body, Paint, Frame or Unibody, Mechanical, Tires, and Interior would have shown some very minimal signs of wear or damage, such as minor chips in the paint, before collision. Vehicle was in better than average condition for its age and miles driven before collision.” “3” is a vehicle with “Body, Paint, Frame or Unibody, Mechanical, Tires, and Interior would have shown normal wear and tear after some years of use. Vehicle was in average condition for its age and miles driven before collision.” “2” is a vehicle whose, “Body, Paint, Frame or Unibody, Mechanical, Tires, and Interior would have shown more than normal wear and tear after some years of use. Vehicle was in less than average condition for its age and miles driven before collision.” “1” represents a vehicle with, “Body, Paint, Frame or Unibody, Mechanical, Tires, and Interior would have shown excessive wear and tear and possibly abuse during its years of use. Vehicle was in substantially less than average condition for its age and miles driven before collision.”

When taking the claim, Inside Adjuster 208 asks the insured to describe the vehicle's condition before the collision. Based on the insured's assessment and referring to Box 3002 in FIG. 30, the vehicle condition entered by Inside Adjuster 208 is noted as “Number is Displayed in the Box”. Here, as noted in Box 3004, Inside Adjuster 208 has entered “4” into Vehicle Information Server 204. Outside Adjuster 102 inspects the damaged vehicle to confirm the vehicle's condition before collision as entered by Inside Adjuster 208. Following instructions in Box 3008, if the displayed number is correct, Outside Adjuster 102 says “Save” and returns to “Home Page” by saying “Home”. The data are saved to Vehicle Information Server 204.

Referring to instructions in Box 3008, if the number describing the vehicle condition is not displayed or the number is incorrect, Outside Adjuster 102 says “Correct”. This authorizes access to the field for entry of the vehicle condition. According to his or her assessment, Outside Adjuster 102 enters the correct number. He or she then says “Save” and returns to “Home Page” by saying “Home”. The data are saved to Vehicle Information Server 204.

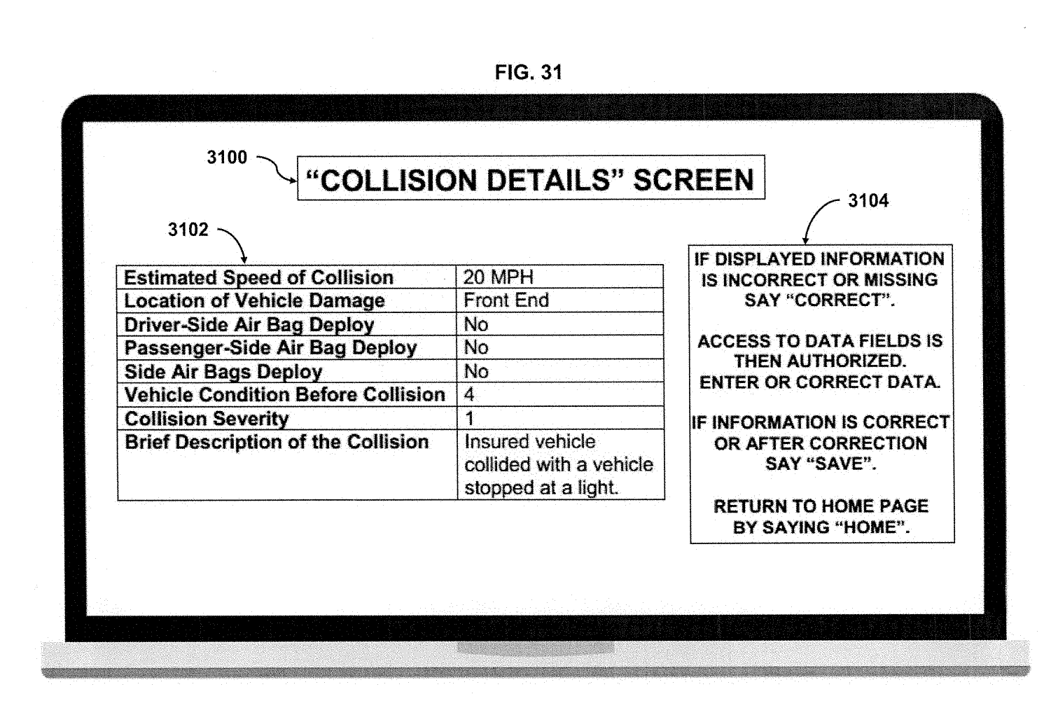

From the “Home Page” and by saying “Nine”, Outside Adjuster 102 accesses the screen titled “Collision Details” Screen as depicted in Box 3100 in FIG. 31. Referring to Table 3102, the “Collision Details” Screen displays the Estimated Speed of Collision, Location of Vehicle Damage, Driver-Side Air Bag Deploy, Passenger-Side Air Bag Deploy, Side Air Bags Deploy, Vehicle Condition Before Collision, Collision Severity, and a Brief Description of the Collision. This is the same information entered by Inside Adjuster 208. Following instructions in Box 3104, if the displayed information is correct, Outside Adjuster 102 says “Save” and returns to the “Home Page” by saying “Home”. The information is saved Vehicle Information Server 204.

If information in Table 3102 is missing or incorrect, Outside Adjuster 102 has the ability to make entries or corrections. In this instance and as shown in Box 3104, Outside Adjuster 102 says “Correct”. Access to the data fields is then authorized. Outside Adjuster 102 then enters or corrects the data. Once the information is correct, Outside Adjuster 102 says “Save” and returns to the “Home Page” by saying “Home”. The corrected information is then saved to Vehicle Information Server 204.

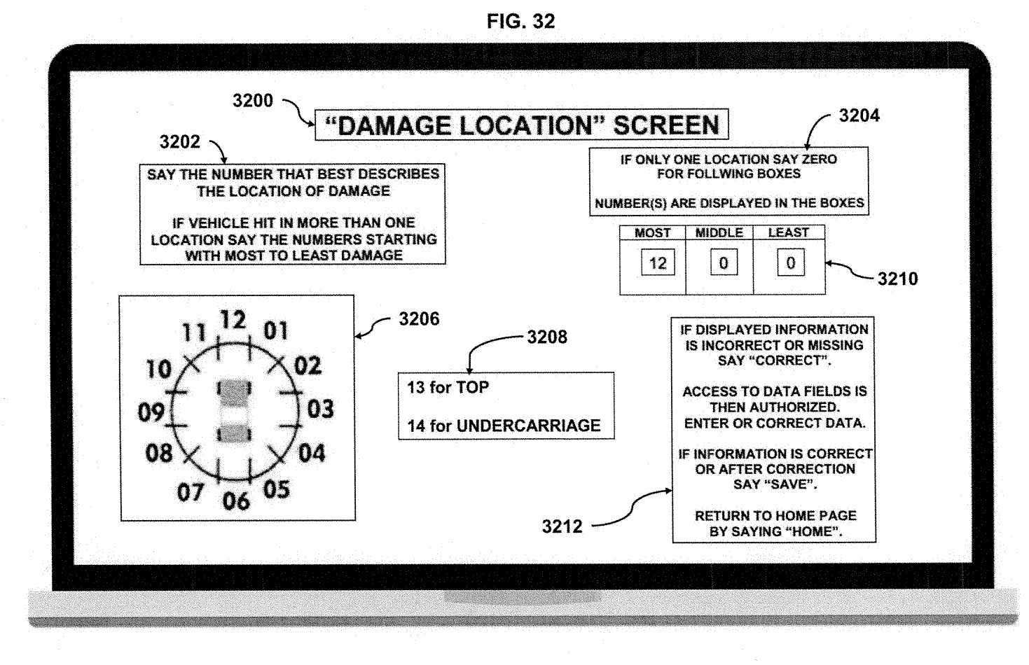

From the “Home Page” and by saying “Ten”, Outside Adjuster 102, accesses the screen titled “Damage Location” Screen as depicted in Box 3200 in FIG. 32. Instructions are shown in Boxes 3202 and 3204. As shown in Box 3206, the “Damage Location” Screen displays the location of collision damage based on a number from “1” to “12” consistent with the face of a 12-hour clock. Referring to Box 3208, the number “13” is reserved for damage to the roof of the vehicle and “14” for damage to the undercarriage. Box 3210 shows space is provided for the entry of three numbers to describe collision damage occurring in more than one location on the vehicle. Referring to Box 3210, the first number on the left gives the location of the worst damage, the second in the middle for the location of lesser damage, and the third number on the right for the location of the least damage. If only one location is damaged, “0” is entered in the second and third boxes. The displayed numbers are the same information entered by Inside Adjuster 208. According to instructions in Box 3212, if the displayed information is correct, Outside Adjuster 102 says “Save” and returns to the “Home Page” by saying “Home”. The information is saved to Vehicle Information Server 204.

If information in the “Damage Location” Screen is missing or incorrect, Outside Adjuster 102 has the ability to make entries or corrections. In this instance and as shown in Box 3212, Outside Adjuster 102 says, “Correct”. Access to the three location boxes in Box 3210 is then authorized. Outside Adjuster 102 then enters or corrects the collision location data. Once the information is correct, Outside Adjuster 102, says “Save” and returns to the “Home Page” by saying “Home”. The corrected information is saved to Vehicle Information Server 204.

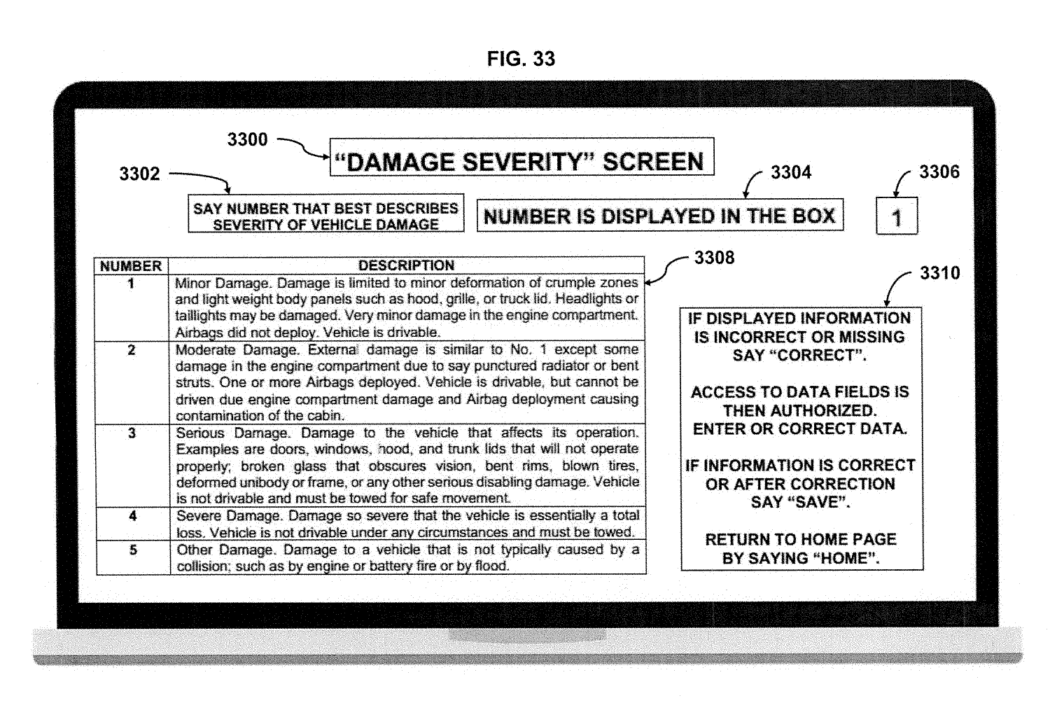

From the “Home Page” and by saying “Eleven”, Outside Adjuster 102 accesses the screen titled “Damage Severity” Screen as depicted in Box 3300 in FIG. 33. Referring to Table 3308, damage severity is a number between “1” and “5”. “1” represents, “Minor Damage. Damage is limited to minor deformation of crumple zones and light weight body panels such as hood, grille, or truck lid. Headlights or taillights may be damaged. Very minor damage in the engine compartment. Airbags did not deploy. Vehicle is drivable.” “2” is for, “Moderate Damage. External damage is similar to No. 1 except some damage in the engine compartment due to say punctured radiator or bent struts. One or more Airbags deployed. Vehicle is drivable, but cannot be driven due engine compartment damage and Airbag deployment causing contamination of the cabin.” “3” represents, “Serious Damage. Damage to the vehicle that affects its operation. Examples are doors, windows, hood, and trunk lids that will not operate properly; broken glass that obscures vision, bent rims, blown tires, deformed unibody or frame, or any other serious disabling damage. Vehicle is not drivable and must be towed for safe movement.” “4” is, “Severe Damage. Damage so severe that the vehicle is essentially a total loss. Vehicle is not drivable under any circumstances and must be towed.” “5” represents, “Other Damage. Damage to a vehicle that is not typically caused by a collision; such as by engine or battery fire or by flood.” The displayed number is that entered by Inside Adjuster 208 in Box 3306 to the right of the statement in Box 3304. Following instructions in Boxes 3302 and 3310, if the displayed number is correct, Outside Adjuster 102 says “Save” and returns to the “Home Page” by saying “Home”. The information is saved to Vehicle Information Server 204.

If Outside Adjuster 102 finds the number displayed in Box 3306 is missing or incorrect, he or she has the ability to make an entry or correction. Following the instruction in Box 3310, Outside Adjuster 102 says, “Correct”. Access to the box displaying the damage severity is then authorized. In this instance, damage to the 2017 O'Reilly is minor. Outside Adjuster 102 enters or corrects the damage severity by entering the number “1” in Box 3306. Once the number is correct, Outside Adjuster 102 says “Save” and returns to the “Home Page” by saying “Home”. The corrected information is saved to Vehicle Information Server 204.

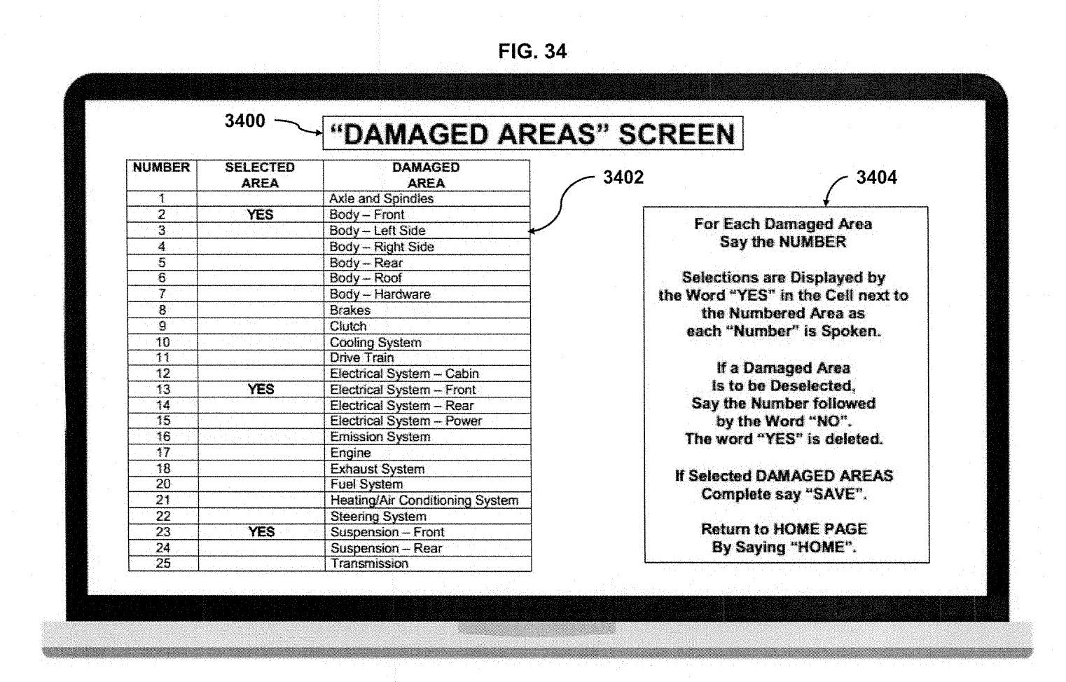

From the “Home Page” and by saying “Twelve”, Outside Adjuster 102 accesses the screen titled “Damaged Areas” Screen as depicted in Box 3400 in FIG. 34. Table 3402 lists 25 major areas of a 2017 O'Reilly with a corresponding number, shown as the first column in Table 3402. The 25 major areas were previously entered by Parts Clerk 228. They are: 1 Axles and Spindles; 2 Body—Front; 3 Body—Left Side; 4 Body—Right Side; 5 Body—Rear; 6 Body—Roof; 7 Body—Hardware; 8 Brakes; 9 Clutch; 10 Cooling System; 11 Drive Train; 12 Electrical System —Cabin; 13 Electrical System—Front; 14 Electrical System—Rear; 15 Electrical System—Power; 16 Emission System; 17 Engine; 18 Exhaust System; 20 Fuel System; 21 Heating/Air Conditioning System; 22 Steering System; 23 Suspension—Front; 24 Suspension—Rear; and 25 Transmission. Following the instructions in Box 3404, as Outside Adjuster 102 inspects the damaged vehicle, he or she says the number corresponding to the areas damaged in the collision. As each number is spoken, the software enters the word “Yes” in the column titled, “Selected Area” in Table 3402.

Continuing to refer to Table 3402 in FIG. 34, here Outside Adjuster 102 says the number “Two”. The word “Yes” is displayed next to “Body—Front”. He or she then says the number “Thirteen” and the word “Yes” is displayed next to “Electrical System—Front”, and then says the number “Twenty-three” and the word “Yes” is displayed next to “Suspension—Front”. As instructed in Box 3404, Outside Adjuster 102 can deselect a damaged area by saying the number corresponding to that damaged area followed by saying the word “No”. The word “Yes” is deleted. When the selected damaged areas are correct, Outside Adjuster 102 says “Save” and returns to the “Home Page” by saying “Home”. The selected damaged areas are saved to Vehicle Information Server 204.

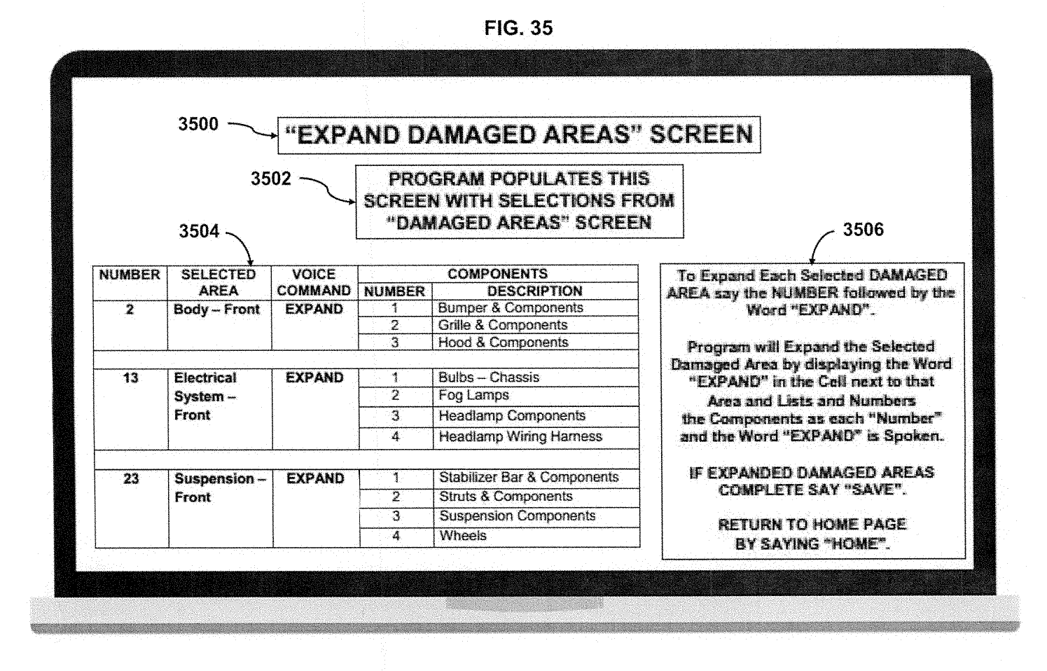

From the “Home Page” and by saying “Thirteen”, Outside Adjuster 102 accesses the screen titled the “Expand Damaged Areas” Screen as depicted in Box 3500 in FIG. 35. As noted in Box 3502, software populates this screen with Table 3504 showing the damaged areas of the 2017 O'Reilly selected in Table 3402 of the “Damaged Areas” Screen depicted in FIG. 34.

Referring to Table 3504, here Outside Adjuster 102, expands each selected damaged area by saying the numbcr next to the column titled “Selected Area” followed by the word “Expand”. The software expands each damaged area into the components for the 2017 O'Reilly previously entered by the Parts Clerk 228. By way of example and referring to instructions in Box 3506 and Table 3504, damaged area “2 Body—Front” is expanded to its components, “1 Bumper & Components”; “2 Grille & Components”; and “3 Hood & Components”. Damaged area “13 Electrical System—Front” is expanded to its components, “1 Bulbs—Chassis”; “2 Fog Lamps”; “3 Headlamp Components”; and “4 Headlamp Wiring Harness”. Continuing to refer Table 3504, damaged area “23 Suspension—Front” is expanded to its components, “1 Stabilizer Bar & Components”; “2 Struts & Components”; “3 Suspension Components”; and “4 Wheels”. Outside Adjuster 102 can deselect an expansion of a damaged area by saying the number corresponding to that damaged area followed by saying the word “No”. The word “Expand” is deleted. When the selected damaged areas to expand are correct, Outside Adjuster 102 says “Save” and returns to the “Home Page” by saying “Home”. The expanded damaged areas are uploaded to Vehicle Information Server 204.

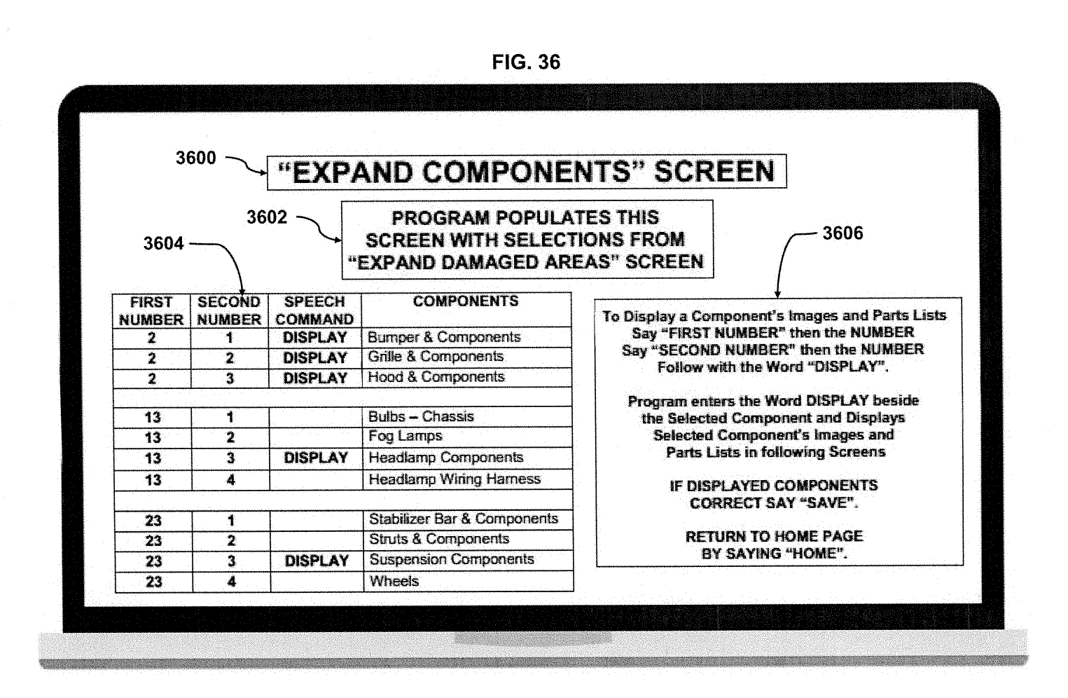

From the “Home Page” and by saying “Fourteen”, Outside Adjuster 102, accesses the screen titled “Expand Components” Screen as depicted in Box 3600 in FIG. 36. As noted in Box 3602, software populates Table 3604 with the damaged areas of the 2017 O'Reilly selected to be expanded on the “Expand Damaged Areas” Screen as depicted in FIG. 35.

According to instructions in Box 3606, Outside Adjuster 102, is able to display in Table 3604 the selected component's images and parts lists by saying “First Number” and then the “Number” in the cell in the column titled, “First Number”, followed by saying “Second Number” and then the “Number” in the cell on the same row in the column titled “Second Number”. The software responds by entering the word “Display” in Table 3604 in the cell on the same row in the column titled, “Speech Command”. This sequence of spoken commands is done one-by-one for each component of the damaged 2017 O'Reilly that Outside Adjuster 102 expects to use its image and parts list in his or her estimate.

Continuing to refer to Table 3604 and FIG. 36, here Outside Adjuster 102 selects the following images and parts lists to be displayed in later screens: (1) by saying “First Number” and then “Two” and then “Second Number” and then “One”, the software enters the word, “Display” in the same row in the column titled “Speech Command” for the component, “Bumper & Components”; (2) by saying “First Number” and then “Two” and then “Second Number” and then “Two”, the software enters the word, “Display” in the same row in the column titled “Speech Command” for the component, “Grille & Components”; (3) by saying “First Number” and then “Two” and then “Second Number” and then “Three”, the software enters the word, “Display” in the same row in the column titled “Speech Command” for the component, “Hood & Components”; (4) by saying “First Number” and then “Thirteen” and then “Second Number” and then “Three”, the software enters the word, “Display” in the same row in the column titled “Speech Command” for the component, “Headlamp Components”; and (5) by saying “First Number” and then “Twenty-three” and then “Second Number” and then “Three”, the software enters the word, “Display” in the same row in the column titled “Speech Command” for the component, “Suspension Components”. Following instructions in Box 3606, when the selected components are correct, Outside Adjuster 102 says “Save”. The images and parts lists selected by Outside Adjuster 102 are saved to Parts Server 224 for display to Outside Adjuster 102's Item 104.

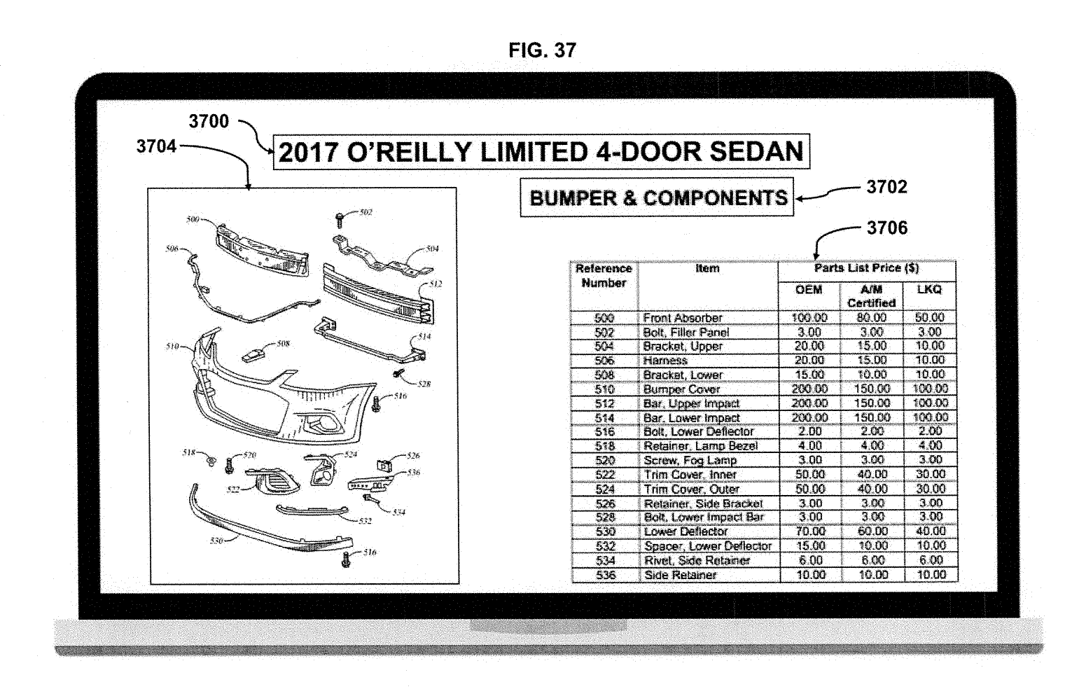

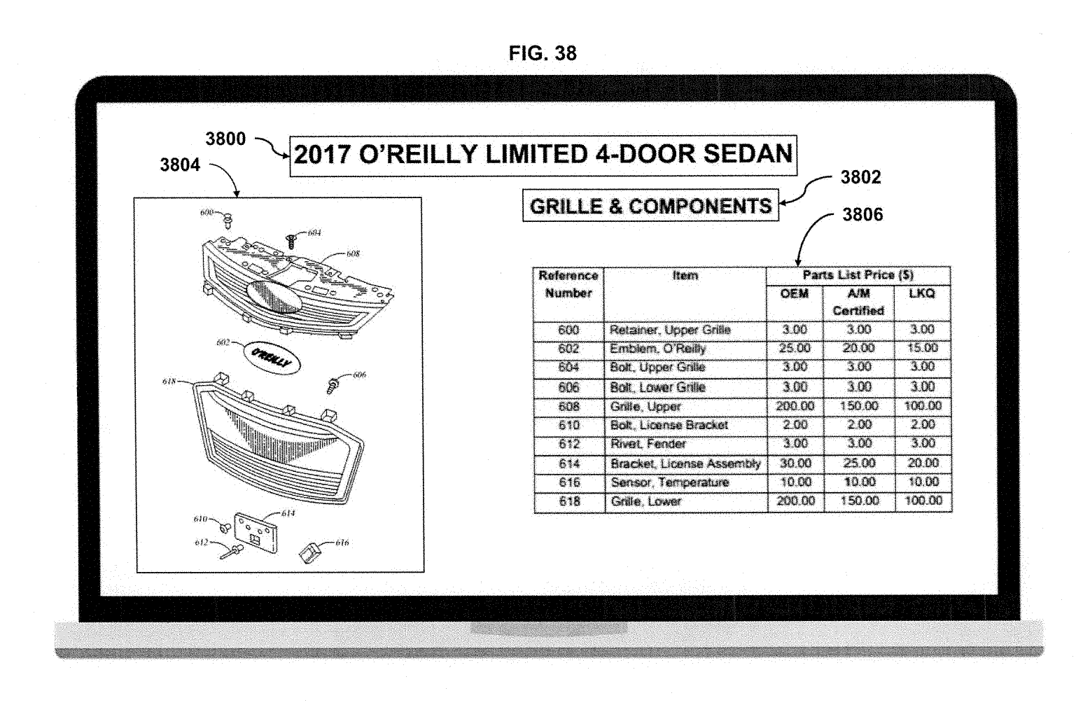

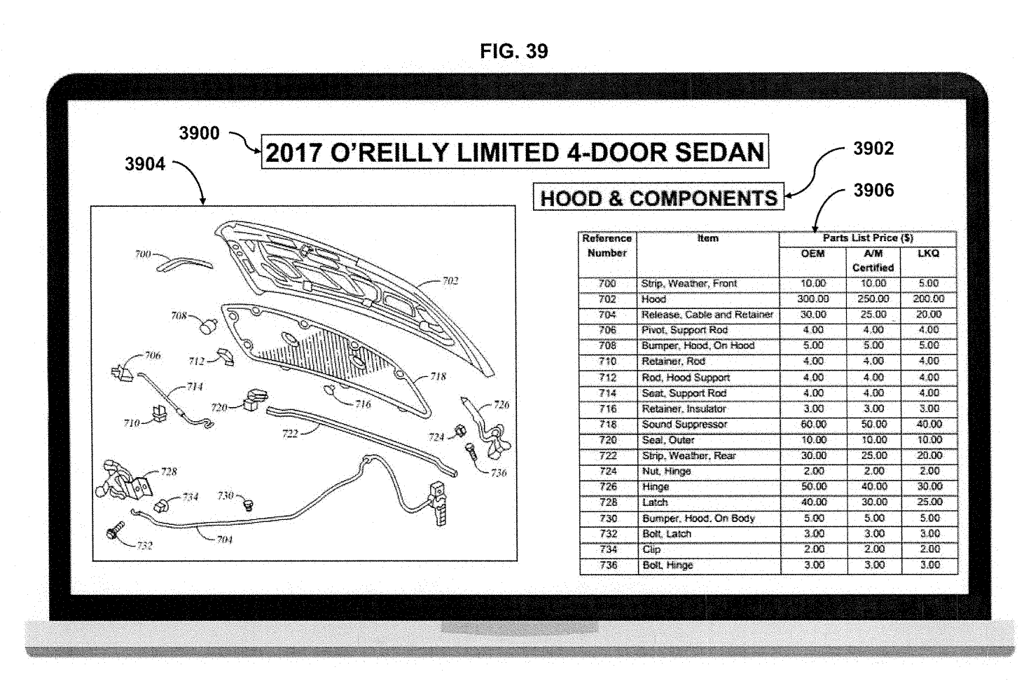

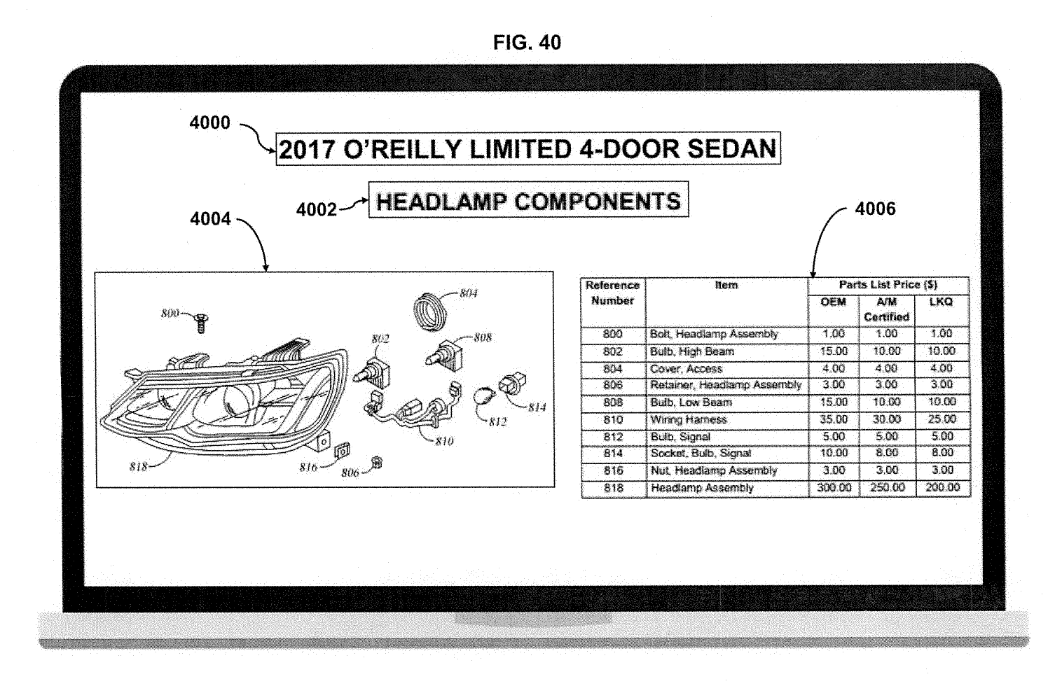

Here, the screens depicted in FIGS. 37, 38, 39, 40, and 41 are made available to Outside Adjuster 102 for preparing the First Estimate. Outside Adjuster 102 scrolls through each of the screens depicted as FIGS. 37, 38, 39, 40, and 41, with each referring to the 2017 O'Reilly as shown respectively in Boxes 3700, 3800, 3900, 4000, and 4100. Referring to FIG. 37, Box 3702 notes the screen applies to the Bumper & Components. Box 3704 and Table 3706 depict, respectively, the image of the bumper parts, and the parts list, and OEM, A/M Certified, and LKQ parts costs. Referring to FIG. 38, Box 3802 notes the screen is for the Grille & Components. Box 3804 and Table 3806 show, respectively, the image of the grille parts and parts list and costs. Referring to FIG. 39, Box 3902 notes the screen applies to the Hood & Components. Box 3904 and Table 3906 show, respectively, the image of the hood parts and parts list and costs. Referring to FIG. 40, Box 4002 notes the screen applies to the Headlamp Components. Box 4004 and Table 4006 depict, respectively, the image of the headlamp components and parts list and costs. Referring to FIG. 41, Box 4102 states the screen applies to the Suspension Components. Box 4104 and Table 4106 show, respectively, the image of the suspension components and parts list and costs. When the images and parts lists selected to display are confirmed to be correct, Outside Adjuster 102 returns to the “Home Page” by saying “Home”.

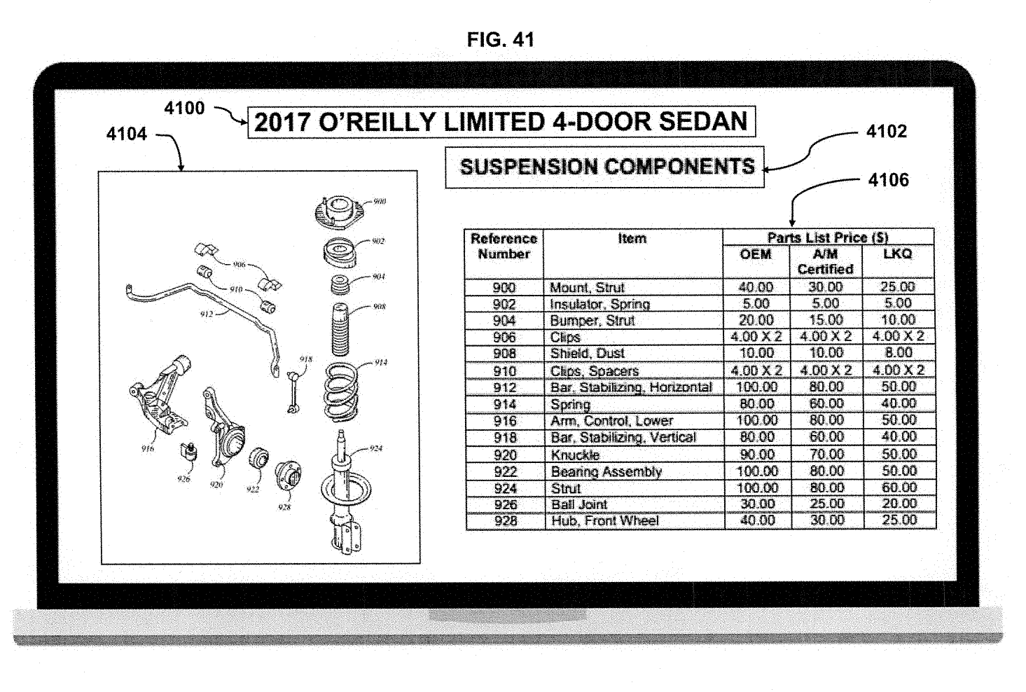

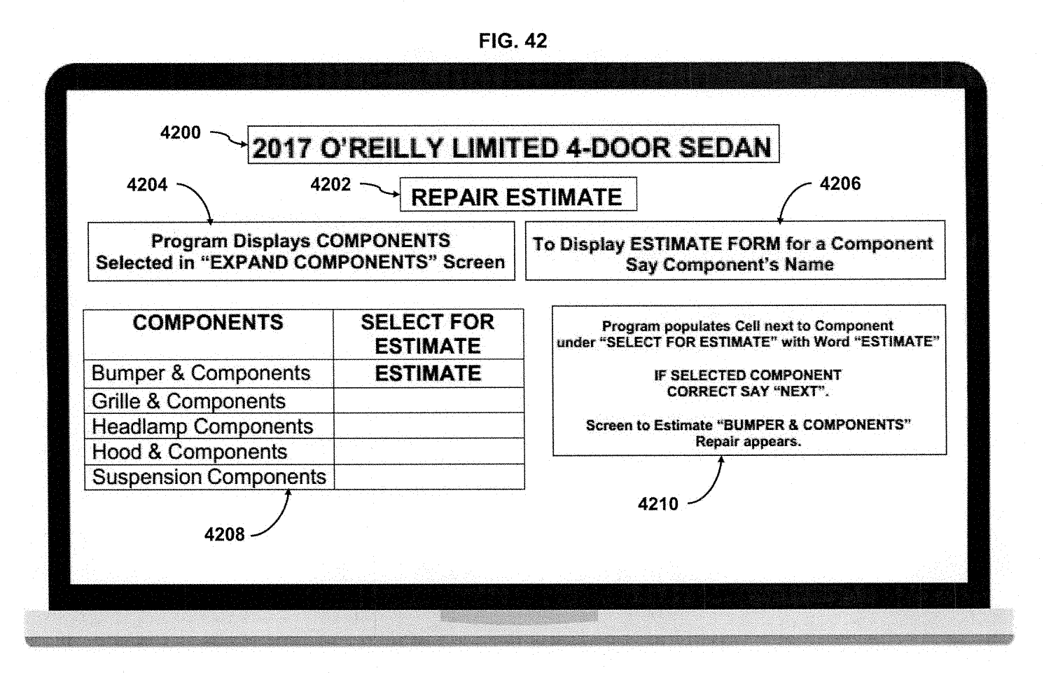

From the “Home Page” and by saying “Fifteen”, Outside Adjuster 102 accesses the screen titled “Repair Estimate” Screen for the 2017 O'Reilly as depicted in Boxes 4200 and 4202, respectively, in FIG. 42. As noted in Box 4204 and shown in Table 4208, software populates this screen with the components of the 2017 O'Reilly selected to be expanded on the “Expand Components” Screen as previously depicted in Table 3604 in FIG. 36. As noted in Box 4206 and instructed in Box 4210, Outside Adjuster 102 accesses the estimate form for a component by saying the “Component's Name”. By way example and referring to the second row in Table 4208, when Outside Adjuster 102 says “Bumper and Components”, the software populates the cell in Table 4208 on the same row with the word, “Estimate”. If the selected component is correct, Outside Adjuster 102 says “Next”.

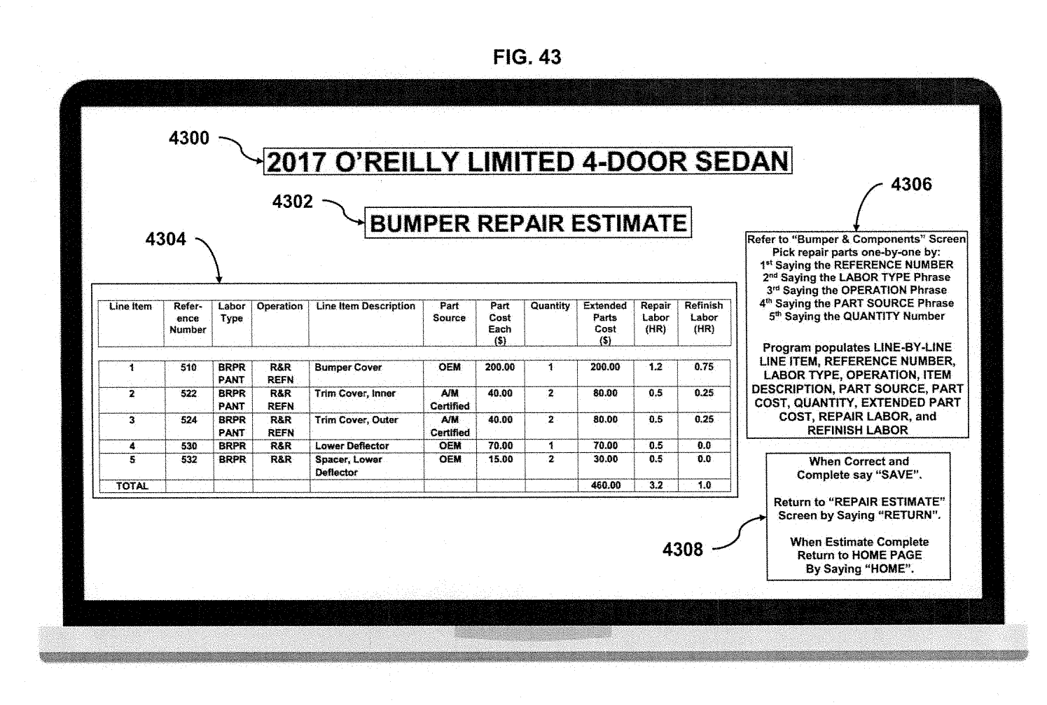

As noted in Boxes 4300 and 4302 in FIG. 43, the screen for the Bumper Repair Estimate of the 2017 O'Reilly is displayed. To prepare an estimate, Outside Adjuster 102 picks the needed repair parts one-by-one from the Bumper & Components image, parts list, and parts cost, depicted in Image 3704 and Table 3706 in FIG. 37. As noted in instructions in Box 4306, while on the Bumper Repair Estimate Screen and simultaneously referring to FIG. 37, for each part required for repair, Outside Adjuster 102 first says the “Reference Number” for the part, second says the “Labor Type”, third says the “Operation”, fourth says the “Part Source”, and fifth says the “Quantity” of that part. Referring to Table 4304, the software populates line-by-line, the “Line Item”, the “Reference Number”, the “Labor Type”, the “Operation”, the “Item Description”, the “Part Source”, the “Part Cost”, the “Quantity”, the “Extended Part Cost”, the “Repair Labor”, and “Refinish Labor”. As parts are selected, the parts, repair labor time and cost, and refinish labor time and cost, are displayed on Item 104. As noted in Box 4308, when the estimate to repair the Bumper is complete, Outside Adjuster 102 says “Save”. The data are saved to Vehicle Estimating Server 202. If additional components are to be estimated Outside Adjuster 102 says “Return” to return to the “Repair Estimate” Screen depicted in FIG. 42.

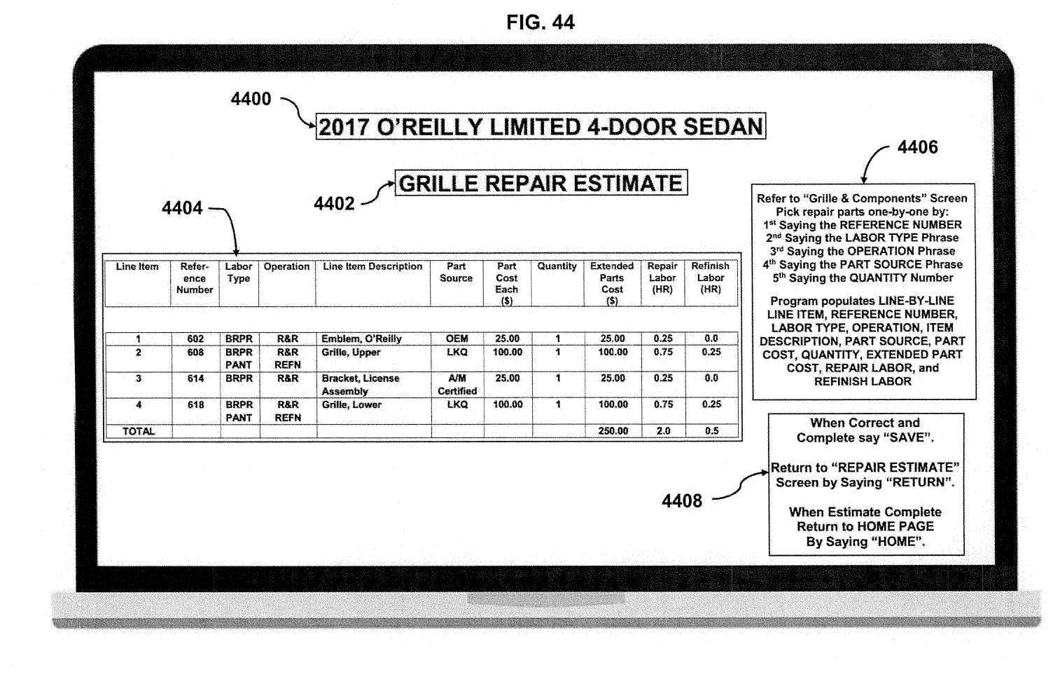

Referring to Table 4208 in FIG. 42, to continue the estimate Outside Adjuster 102 selects the Grille & Components by saying “Grille and Components”, then saying “Next”. As noted in Boxes 4400 and 4402 in FIG. 44, the screen for the Grille Repair Estimate of the 2017 O'Reilly is displayed on Item 104. To make an estimate to repair the grille, Outside Adjuster 102 picks the needed repair parts one-by-one from the Grille & Components image, parts list, and parts source depicted in Image 3804 and Table 3806 in FIG. 38. Following notes and instructions in Box 4406, software populates Table 4404 with the data for the estimated repair of the grille. As noted in Box 4408, when the estimate to repair the Grille is complete, Outside Adjuster 102 says “Save”. The data are saved to Vehicle Estimating Server 202. If additional components are to be estimated Outside Adjuster 102 says “Return” to return to the “Repair Estimate” Screen depicted in FIG. 42.

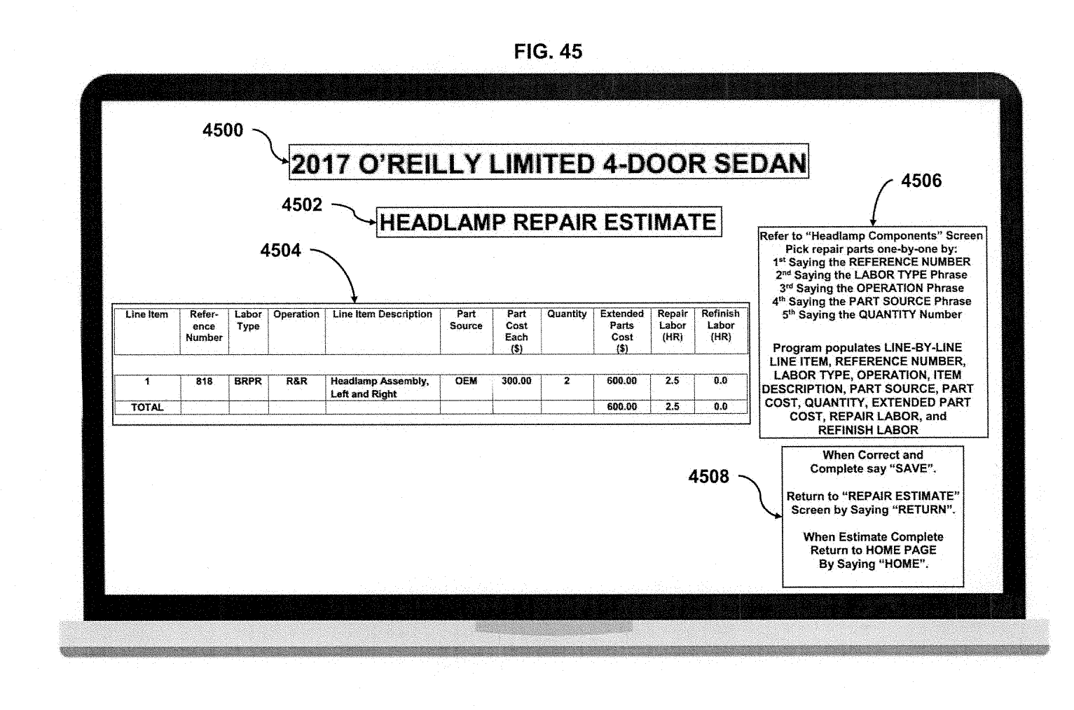

Referring to Table 4208 in FIG. 42, to continue the estimate Outside Adjuster 102 selects the Repair Estimate form for the Headlamp Components by saying “Headlamp Components”, then saying “Next”. As noted in Boxes 4500 and 4502 in FIG. 45, the screen for the Headlamp Repair Estimate of the 2017 O'Reilly is displayed on Item 104. To make an estimate to repair the headlamps, Outside Adjuster 102 picks the needed repair parts one-by-one from the Headlamp Components image, parts list, and parts costs depicted in Image 4004 and Table 4006 in FIG. 40. Following notes and instructions in Box 4506, the software populates Table 4504 with the data for the estimated repair of the headlamps. As noted in Box 4508, when the estimate to repair the Headlamps is complete, Outside Adjuster 102 says “Save”. The data are saved to Vehicle Estimating Server 202. If additional components are to be estimated Outside Adjuster 102 says “Return” to return to the “Repair Estimate” Screen depicted in FIG. 42.

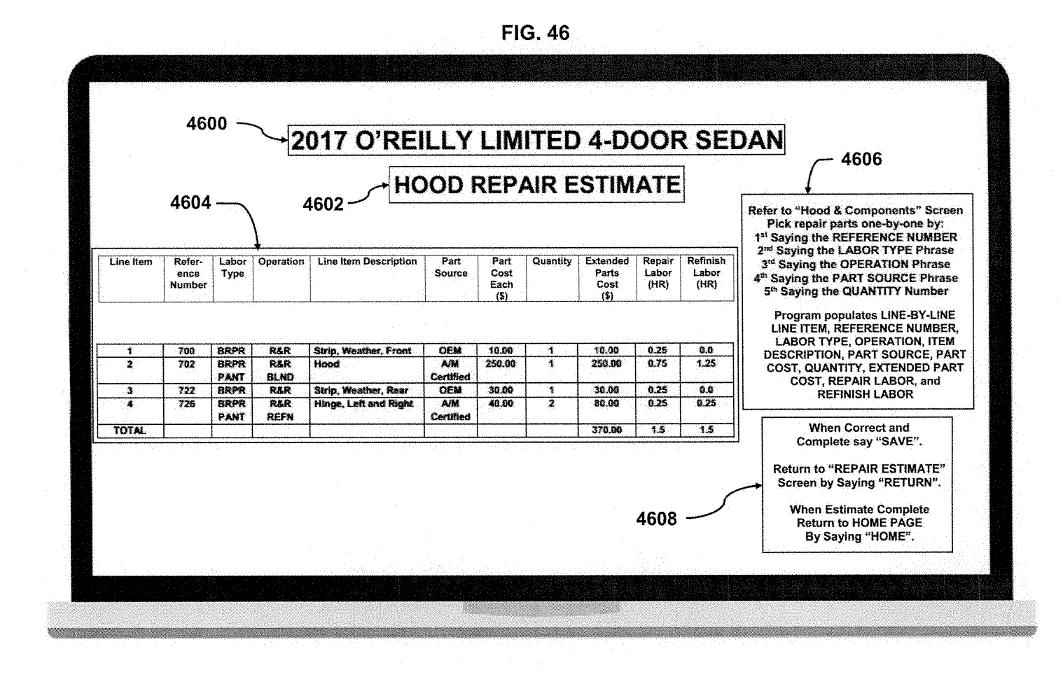

Referring to Table 4208 in FIG. 42, to continue the estimate Outside Adjuster 102 selects to the Repair Estimate form for the Hood & Components by saying “Hood and Components”, then saying “Next”. As noted in Boxes 4600 and 4602 in FIG. 46, the screen for the Hood Repair Estimate of the O'Reilly is displayed on Item 104. To make an estimate to repair the hood, Outside Adjuster 102 picks the needed repair parts one-by-one from the Hood & Components image, parts lists, and parts costs depicted in Image 3904 and Table 3906 in FIG. 39. Following notes and instructions in Box 4606, software populates Table 4604 with the data for the estimated repair of the hood. As noted in Box 4608, when the estimate to repair the hood is complete, Outside Adjuster 102 says “Save”. The data are saved to Vehicle Estimating Server 202. If additional components are to be estimated Outside Adjuster 102 says “Return” to return to the “Repair Estimate” Screen depicted in FIG. 42. When the repair estimate for all damaged components are complete, Outside Adjuster 102 returns to the “Home Page” by saying “Home”.

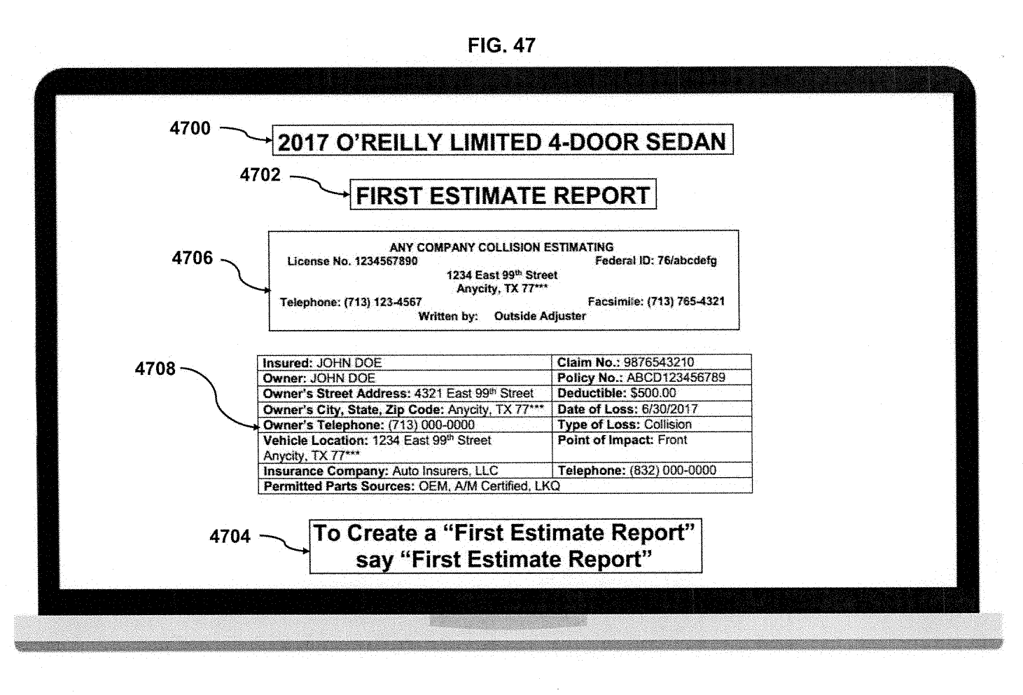

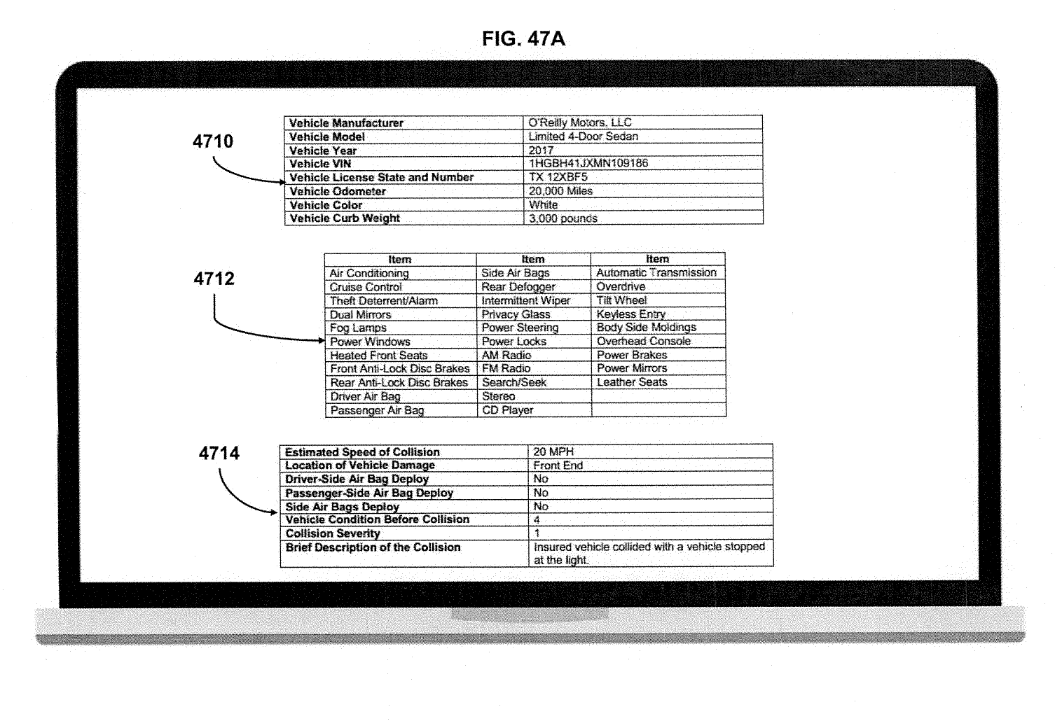

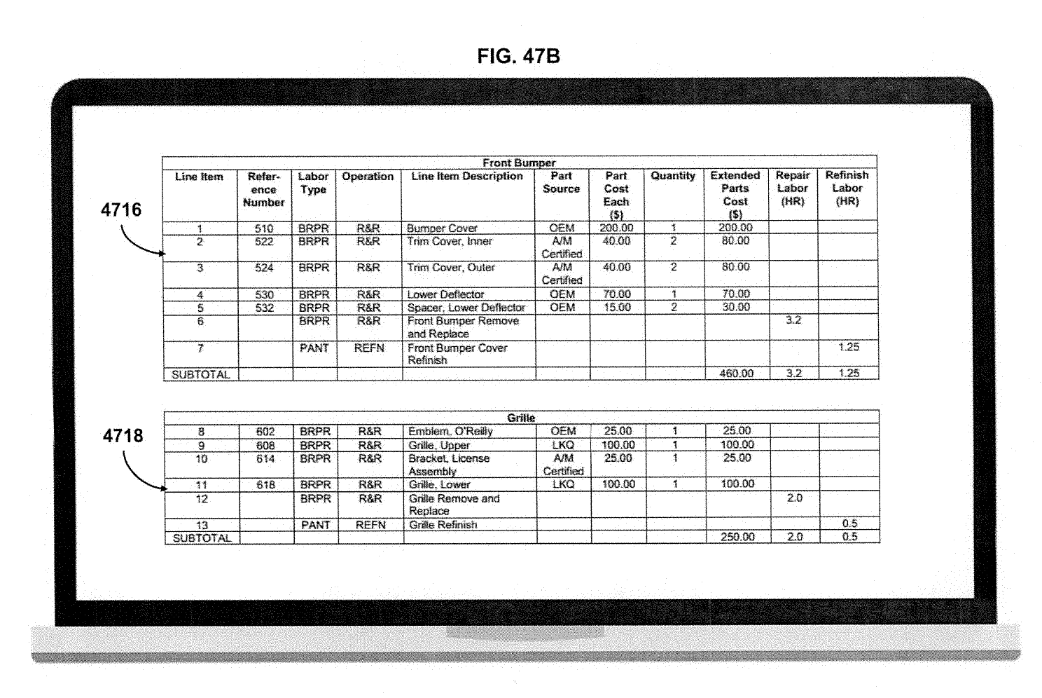

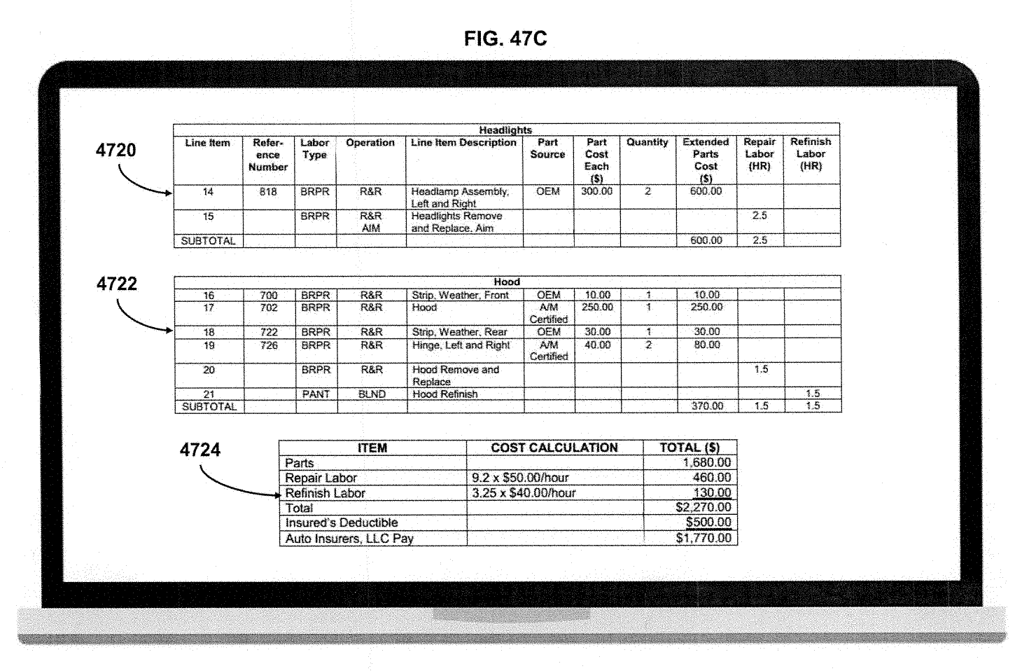

From the “Home Page” and by saying “Sixteen”, Outside Adjuster 102 opens a blank screen with the instruction shown in Box 4704 in FIG. 47, To Create a “First Estimate Report” say “First Estimate Report”. When Outside Adjuster 102 says “First Estimate Report”, data previously uploaded to the Vehicle Information Server 204, Parts Server 216, Labor Rate Server 232, and Vehicle Estimating Server 238 are assembled in real-time and displayed on Item 104 as depicted in Boxes 4700, 4702, and 4706, and Table 4708 in FIG. 47, Tables 4710, 4712, and 4714 in FIG. 47A, Tables 4716 and 4718 in FIG. 47B, and Tables 4720, 4722, and 4724 in FIG. 47C. In this instance, Outside Adjuster 102 did not observe any damage to the suspension and no parts were selected for that repair. The total parts and labor cost for the repair are summarized in Table 4724 in FIG. 47C. The First Estimate Report may also be displayed to Inside Adjuster 208, Parts Clerk 228, and Labor Clerk 240 or printed as a First Estimate Report as depicted in FIGS. 47, 47A, 47B and 47C on Network Printer 256. Outside Adjuster 102 returns to the “Home Page” by saying “Home”.

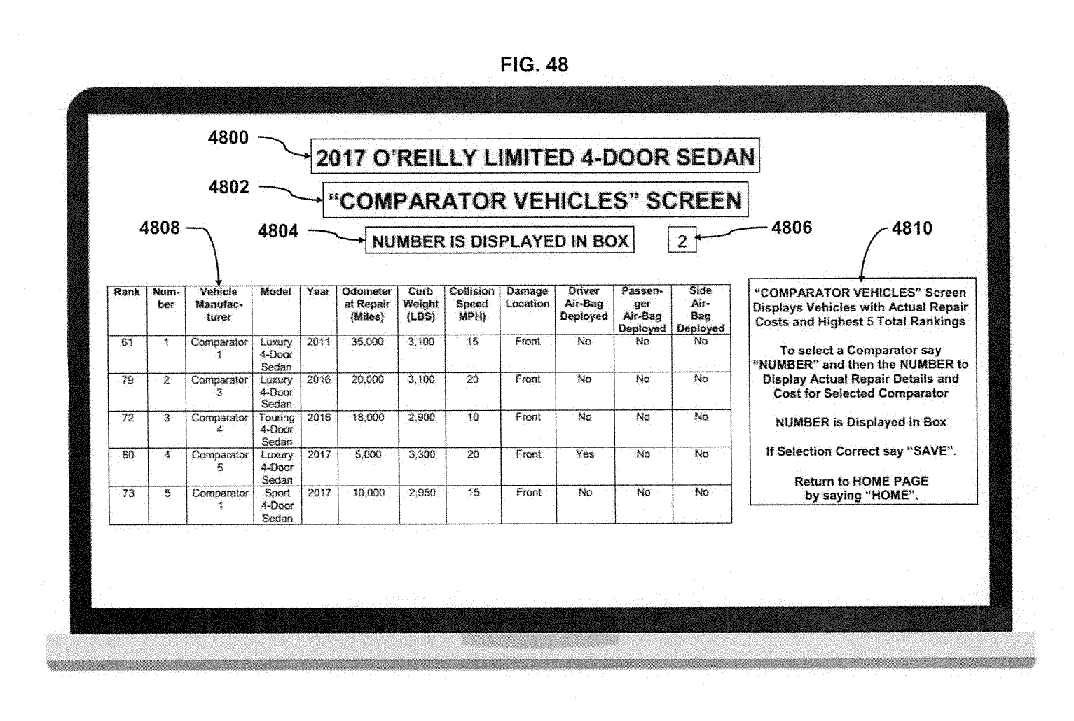

From the “Home Page” and by saying “Seventeen”, Outside Adjuster 102 displays the screen titled 2017 O'Reilly Limited 4-Door Sedan and “Comparator Vehicles” Screen as depicted in Boxes 4800 and 4802 in FIG. 48. According to instructions in Box 4810, the “Comparator Vehicles” Screen displays in Table 4808 vehicles with actual repair costs previously saved in Shop Server 234 with the 5 highest “Rank” as compared to the 2017 O'Reilly. Continuing to refer to Table 4808 in FIG. 48 and in this instance, the “Comparator Vehicles” Screen displays: (1) 2011 Comparator 1 Luxury 4-Door Sedan with “Rank” equal 61; (2) 2016 Comparator 3 Luxury 4-Door Sedan with “Rank” equal 79; (3) 2016 Comparator 4 Touring 4-Door Sedan with “Rank” equal 62; (4) 2017 Comparator 5 Luxury 4-Door Sedan with “Rank” equal 60; and (5) 2017 Comparator 1 Sport 4-Door Sedan with “Rank” equal 73.

Continuing to refer to instructions in Box 4810, Outside Adjuster 102 selects the “Comparator Vehicle” with the highest “Rank”; i.e., 79, the 2016 Comparator 3 Luxury 4-Door Sedan by saying “Two”, the number next to the rank. The software displays the number “Two” in Box 4806 adjacent to the phrase “Number is Displayed in Box” as depicted in Box 4804. If the number displayed in Box 4806 is correct, Outside Adjuster 102 says “Save” and returns to the “Home Page” by saying “Home”.

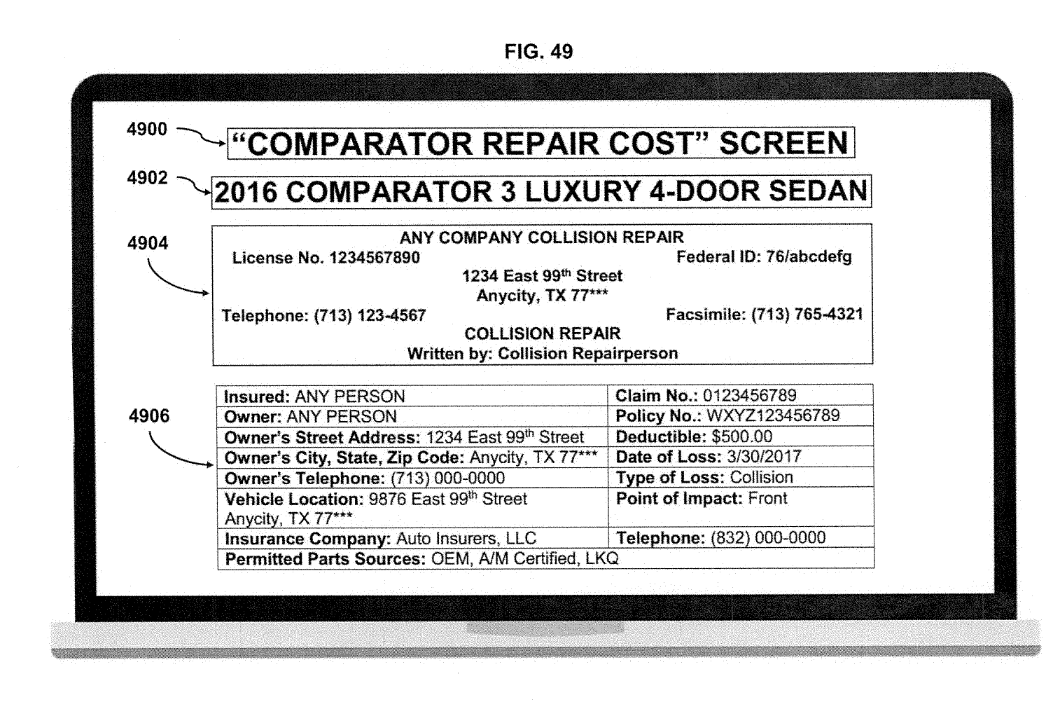

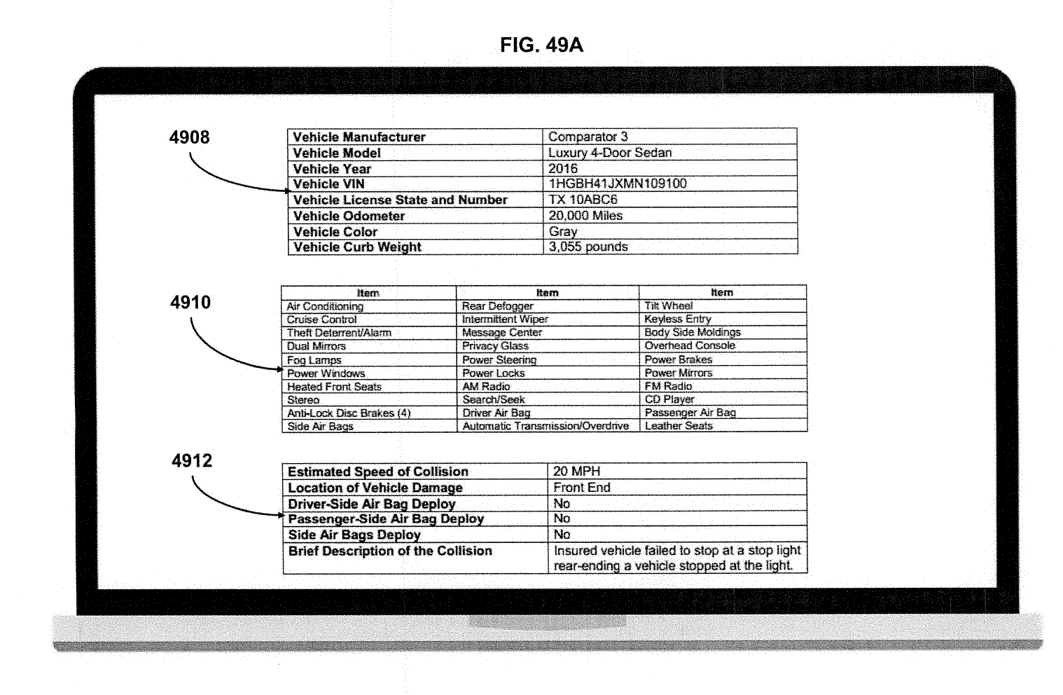

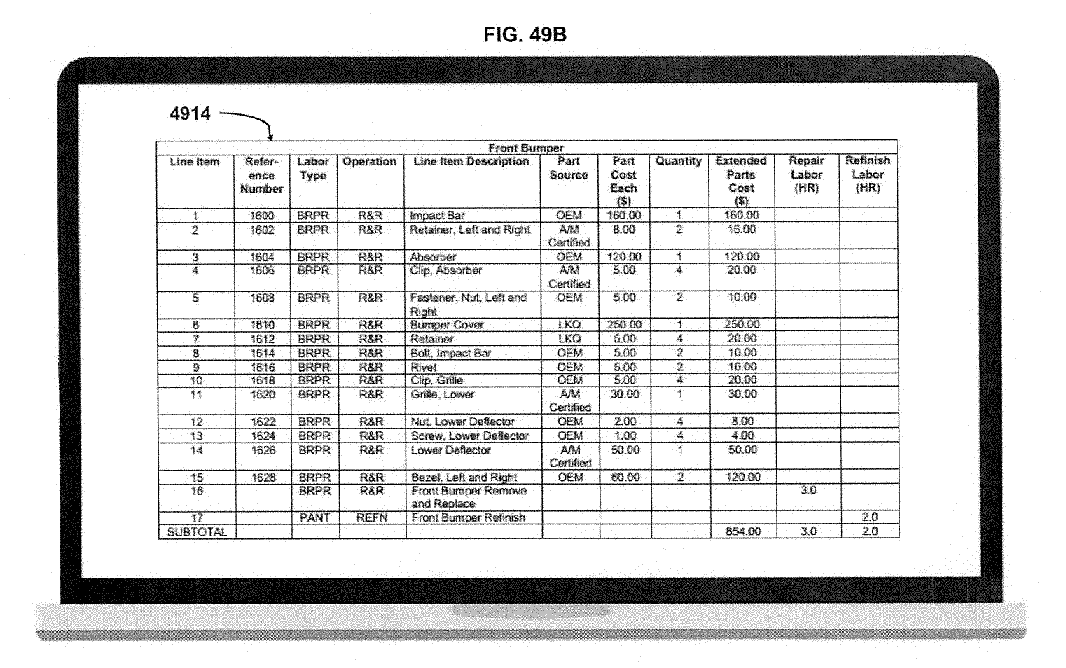

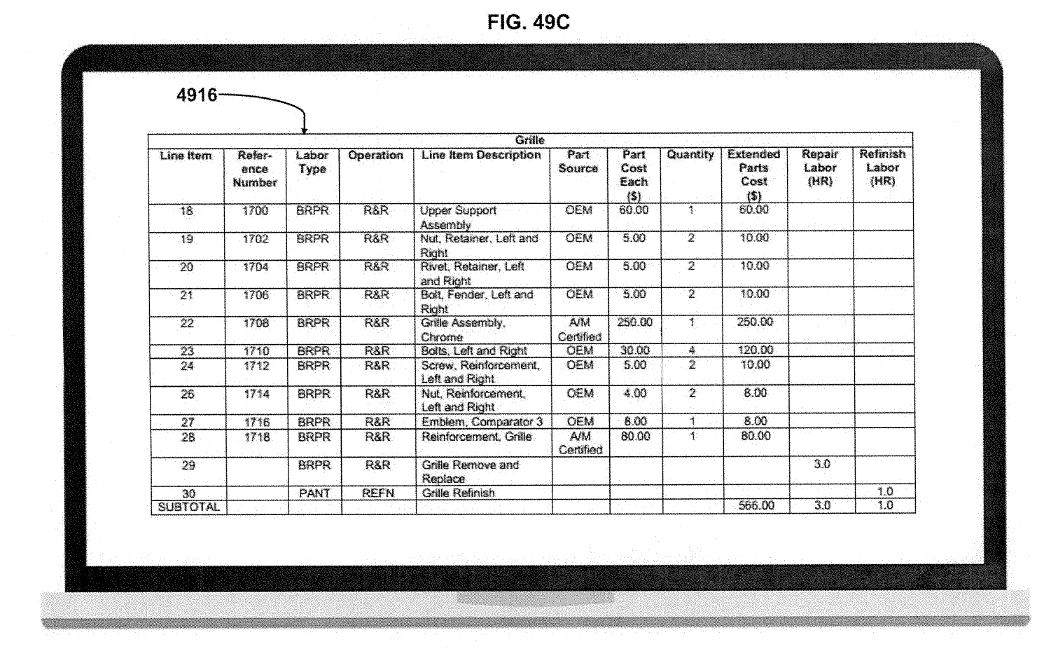

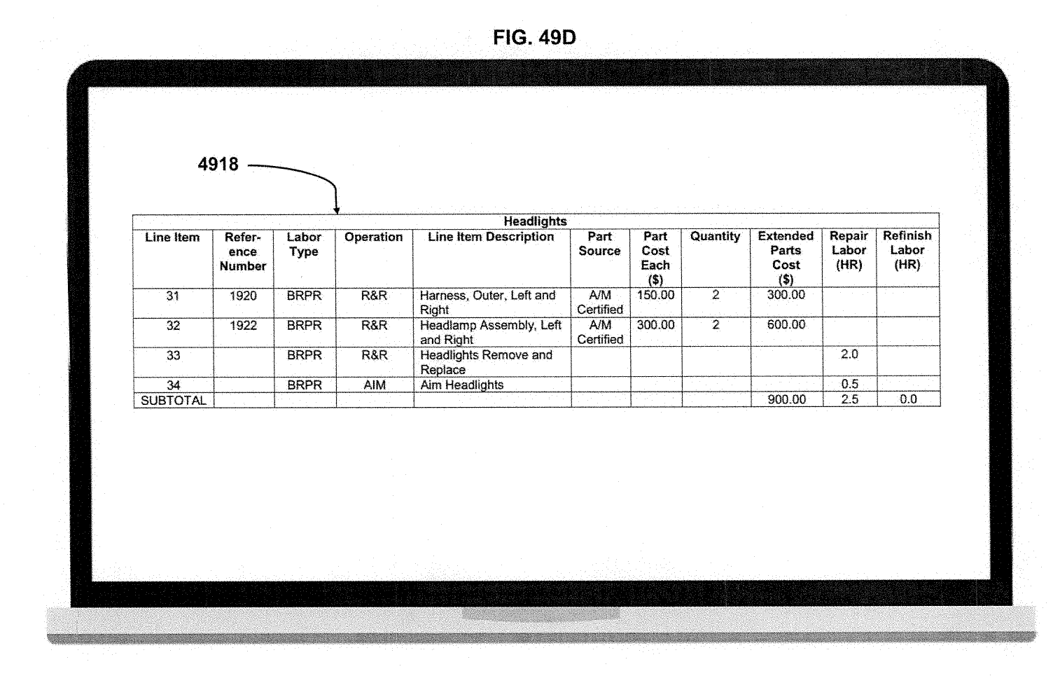

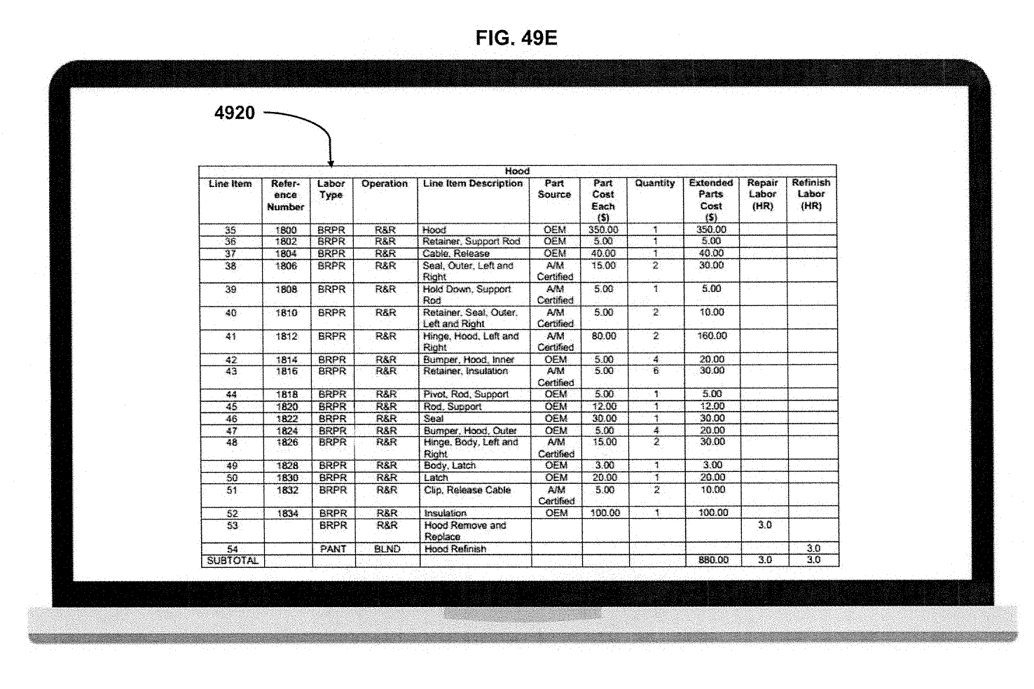

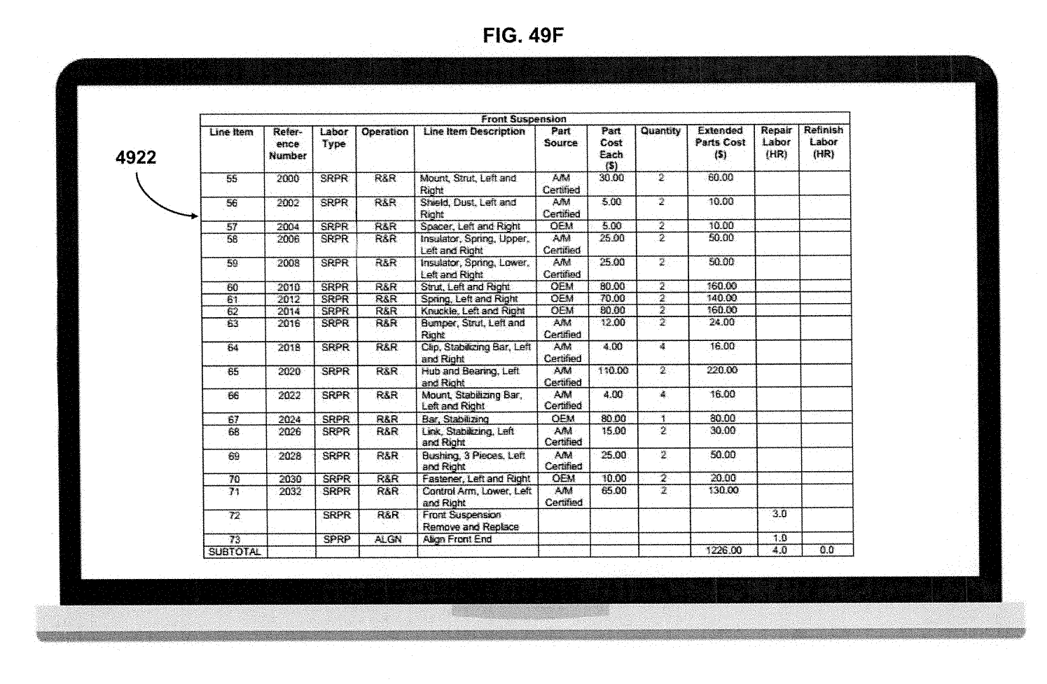

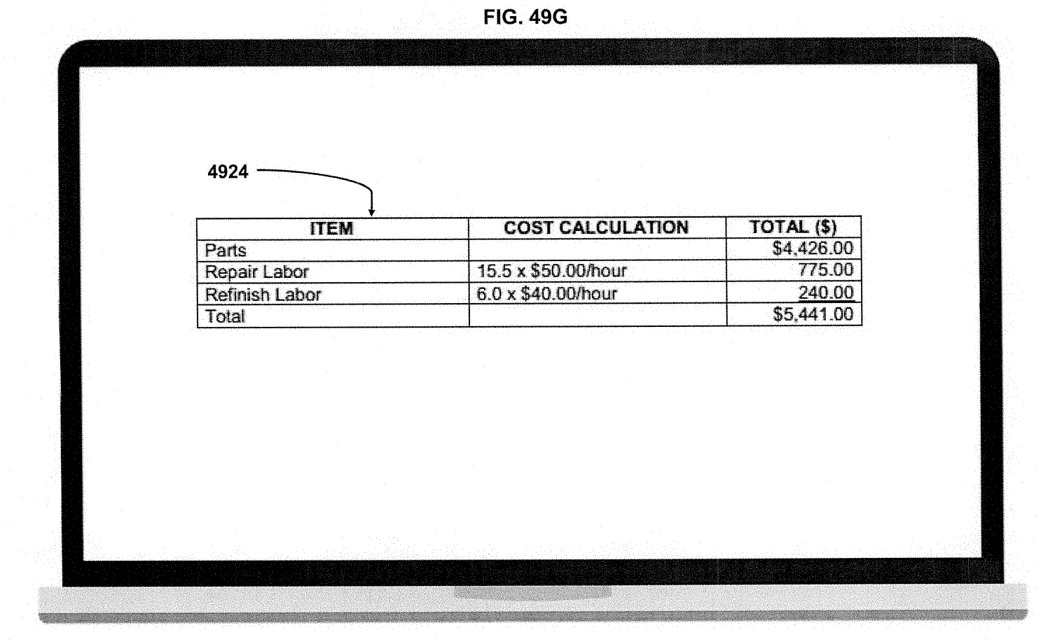

From the “Home Page” and by saying “Eighteen”, Outside Adjuster 102 displays on Item 104 the screen titled “Comparator Repair Cost” for the 2016 Comparator 3 Luxury 4-Door Sedan as depicted in Boxes 4900 and 4902 in FIG. 49. The information displayed are depicted in Box 4904 and Table 4906 in FIG. 49, Tables 4908, 4910, and 4912 in FIG. 49A, Table 4914 in FIG. 49B, Table 4916 in FIG. 49C, Table 4918 in FIG. 49D, Table 4920 on FIG. 49E, Table 4922 in FIG. 49F, and Table 4924 in FIG. 49G. By way of example showing how the invention described herein may be practiced and referring to Table 4922 in FIG. 49F, the front suspension of the 2016 Comparator 3 was damaged in a collision similar in circumstances to that of the 2017 O'Reilly and required repair. Referring to Tables 4914, 4916, and 4920, the parts and labor to repair the damaged the 2016 Comparator 3 Luxury 4-Door Sedan were more substantial than those previously estimated as needed to repair the 2017 O'Reilly. Based on this real-time comparison between the First Estimate made by Outside Adjuster 102 as depicted in FIGS. 47, 47A, 47B, and 47C, Outside Adjuster 102, amends his estimate. Outside Adjuster 102 returns to the “Home Page” by saying “Home”.

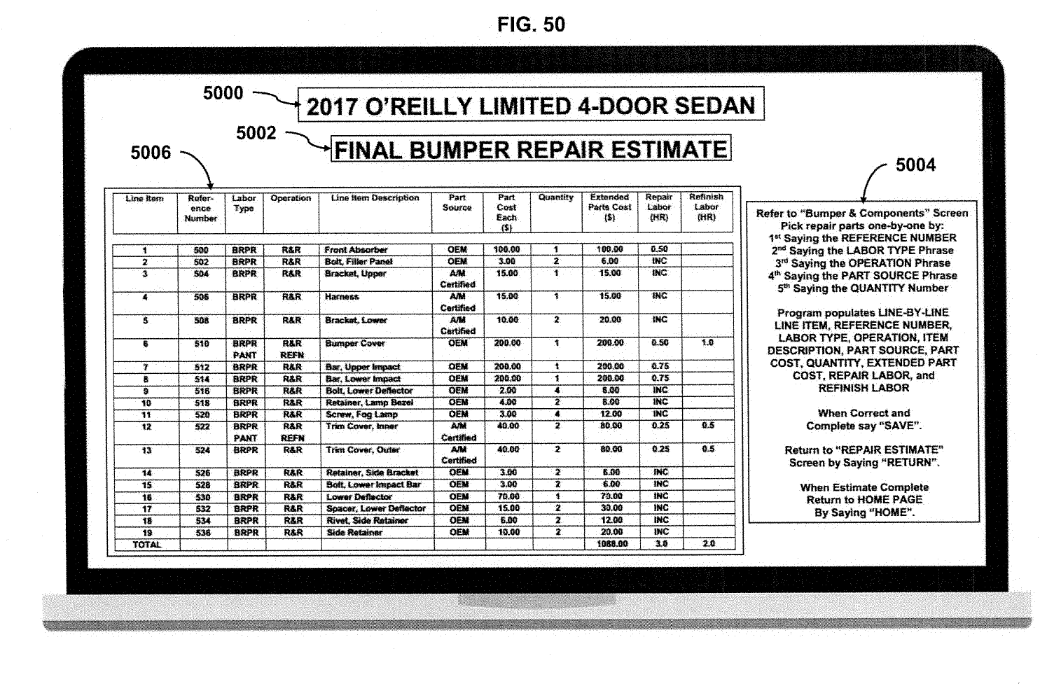

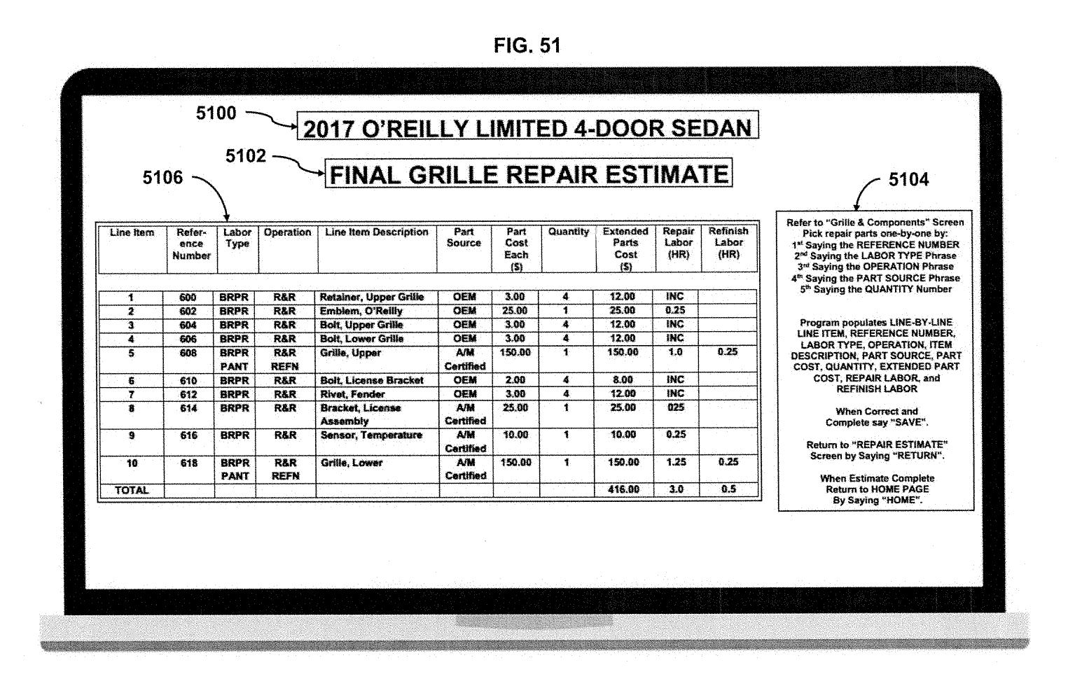

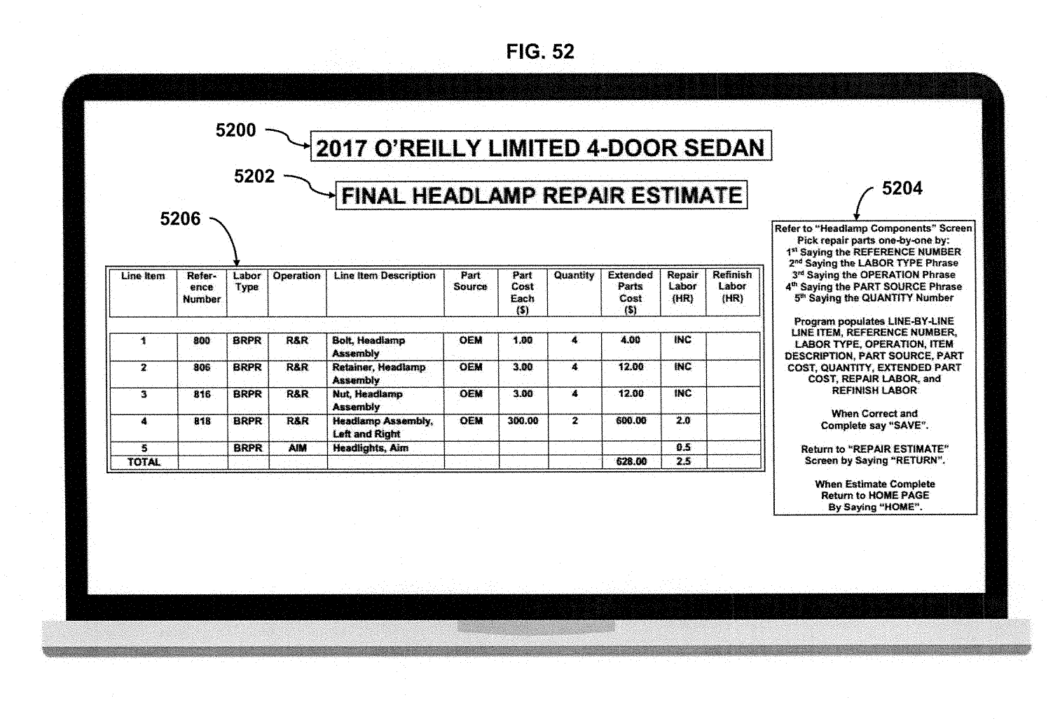

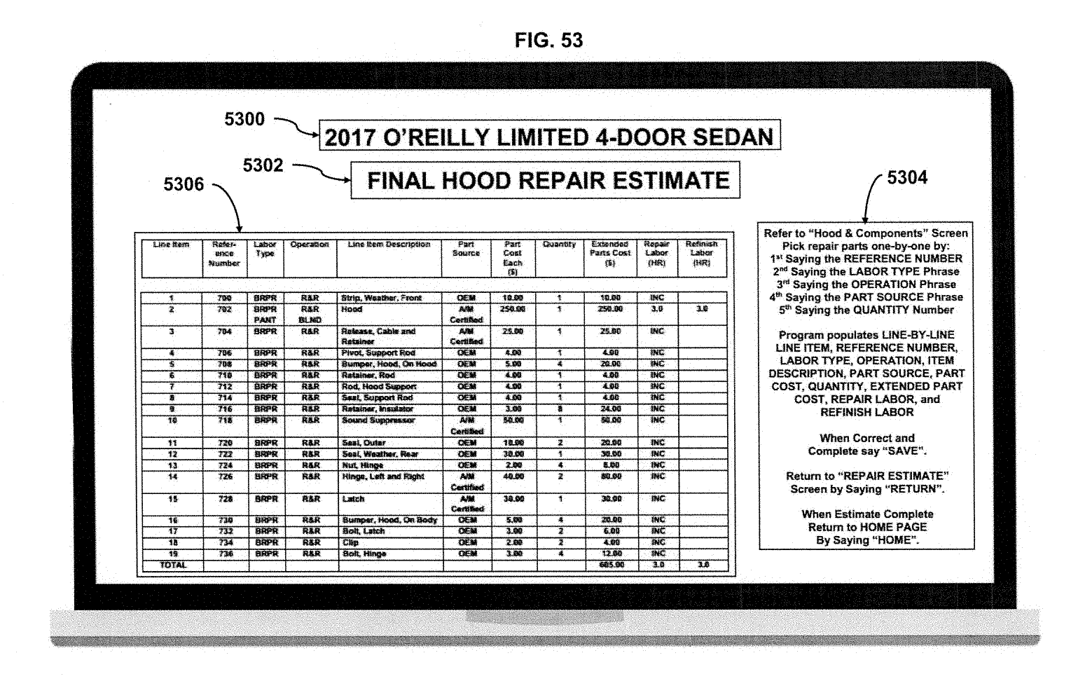

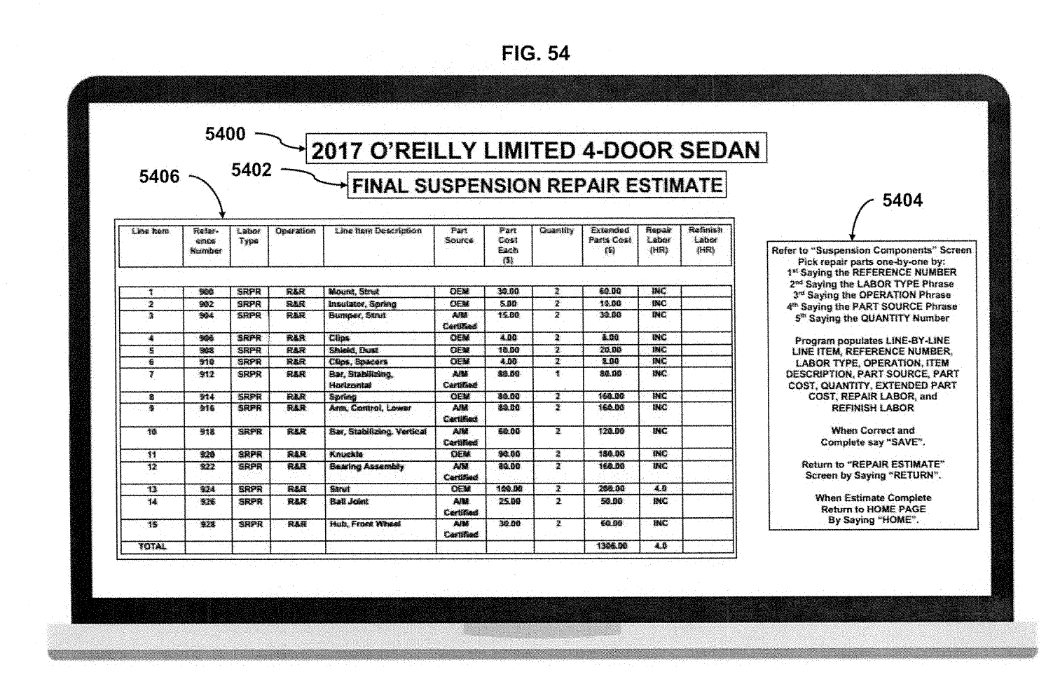

From the “Home Page” and by saying “Nineteen”, Outside Adjuster 102 displays on Item 104 one-by-one the screen titled “Final Bumper Repair Estimate” for the 2017 O'Reilly Limited 4-Door Sedan as depicted in Boxes 5000 and 5002 in FIG. 50. Following the instructions in Box 5004, Outside Adjuster 102 makes a Final Estimate for the bumper as depicted in Table 5006. Outside Adjuster 102 then displays on Item 104 the screen titled “Final Grille Repair Estimate” for the 2017 O'Reilly as shown in Boxes 5100 and 5102 in FIG. 51. Following the instructions in Box 5104, Outside Adjuster 102 makes a Final Estimate for the grille as depicted in Table 5106. Outside Adjuster 102 then displays on Item 104 the screen titled “Final Headlamp Repair Estimate” for the 2017 O'Reilly as depicted in Boxes 5200 and 5202 in FIG. 52. Following the instructions in Box 5204, Outside Adjuster 102 makes a Final Estimate for the headlamps as depicted in Table 5206. Outside Adjuster 102 next displays on Item 104 the screen titled “Final Hood Repair Estimate” for the 2017 O'Reilly as shown in Boxes 5300 and 5302 in FIG. 53. Following the instructions in Box 5304, Outside Adjuster 102 makes a Final Estimate for the hood as depicted in Table 5306. Outside Adjuster 102 then displays on Item 104 the screen titled “Final Suspension Repair Estimate” for the 2017 O'Reilly as shown in Boxes 5400 and 5402 in FIG. 54. Using the estimating methods previously described, Outside Adjuster 102 re-estimates the damage. When complete, Outside Adjuster 102 returns to the “Home Page” by saying “Home”. The new estimate is uploaded to Vehicle Estimating Server 238.

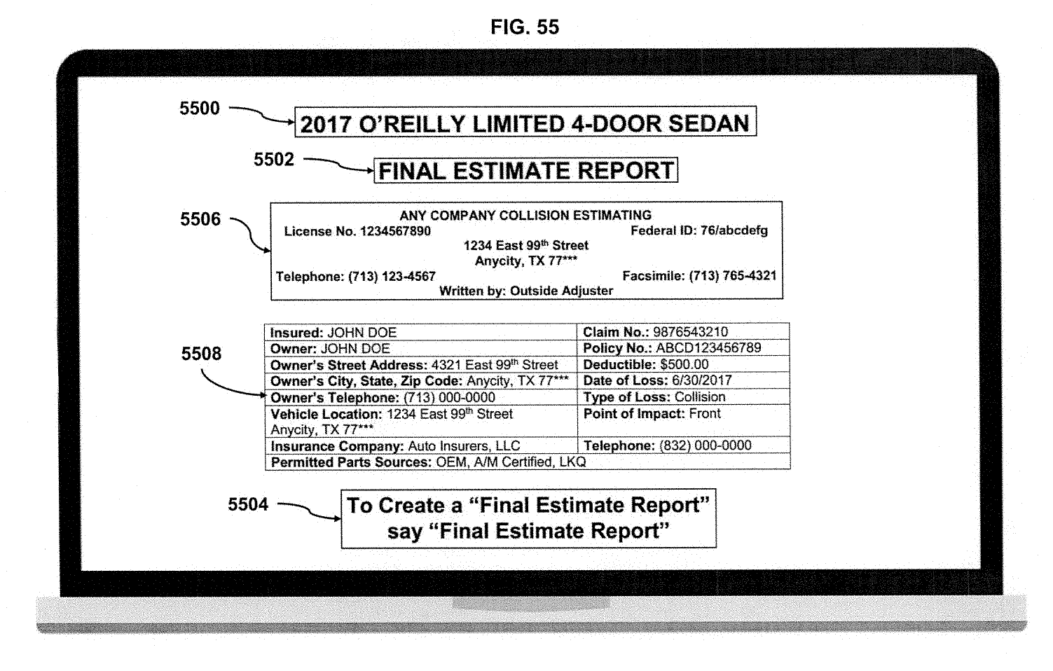

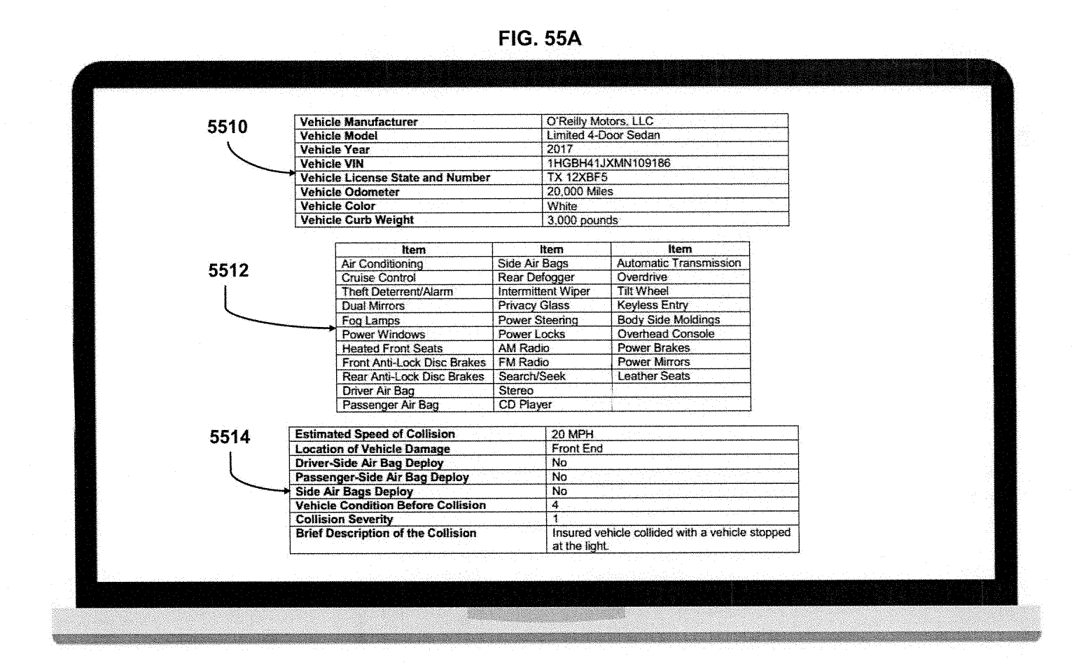

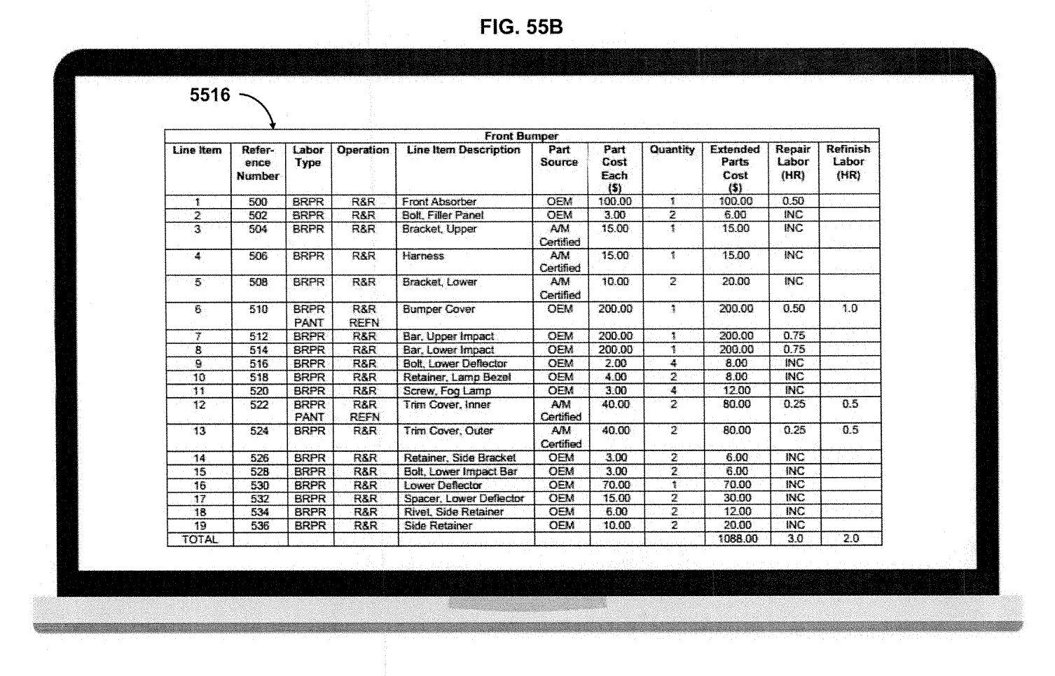

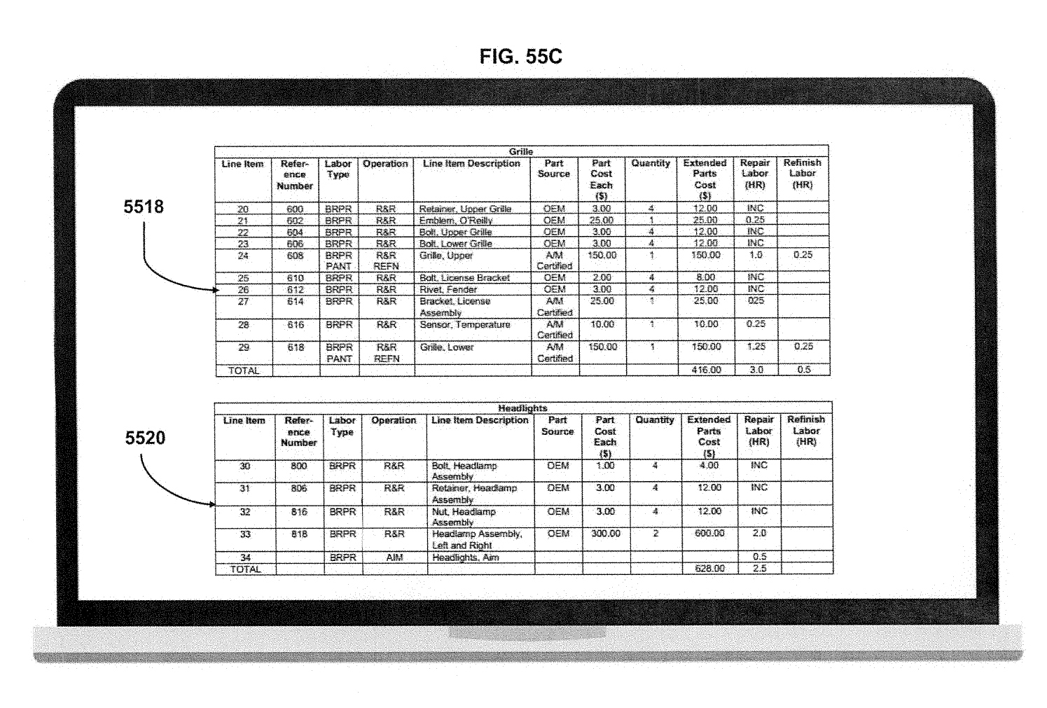

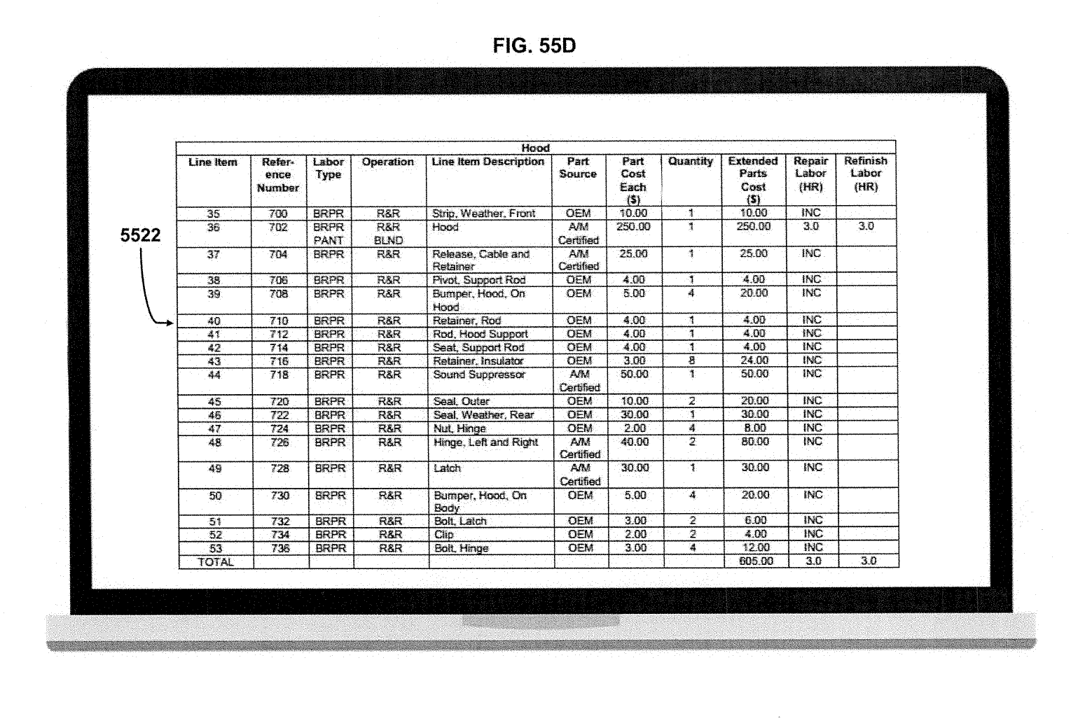

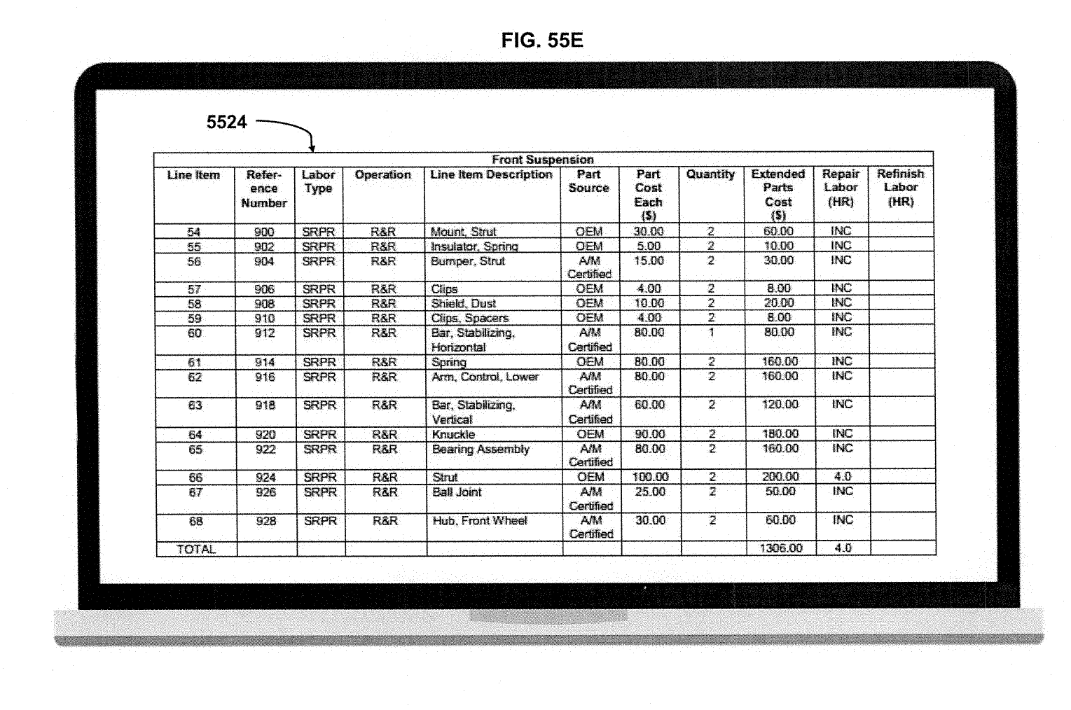

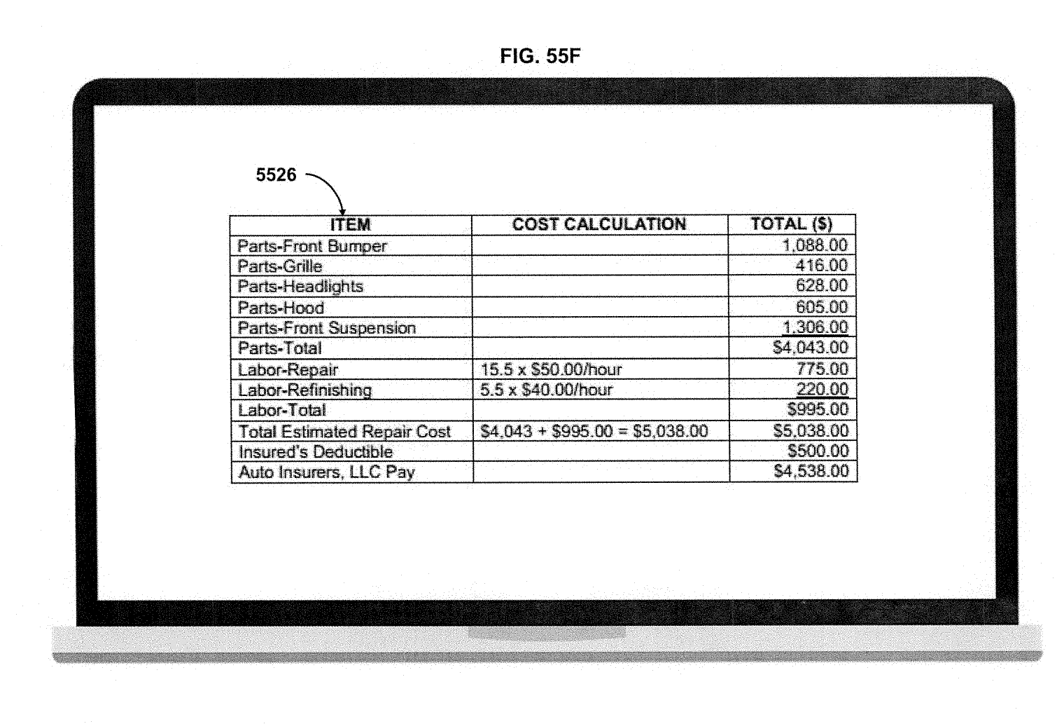

From the “Home Page” and by saying “Twenty”, Outside Adjuster 102 opens a blank screen titled, 2017 O'Reilly Limited 4-Door Sedan and Final Estimate Report as shown in Boxes 5500 and 5502 in FIG. 55 with the instruction, to create “Final Estimate Report” say “Final Estimate Report” in Box 5504. When Outside Adjuster 102 says “Final Estimate Report” data previously saved to the Vehicle Information Server 204, Parts Server 224, Labor Server 236, and Vehicle Estimating Server 202 are assembled in real-time and displayed on Item 104. The report is depicted in Box 5506 and Table 5508 in FIG. 55, Tables 5510, 5512, and 5514 in FIG. 55A, Table 5516 in FIG. 55B, Tables 5518 and 5520 in FIG. 55C, Table 5522 in FIG. 55D, Table 5524 in FIG. 55E, and Table 5526 in FIG. 55F. The “Final Estimate Report” is saved to Vehicle Estimating Server 202. The Final Estimate Report may also be displayed to Inside Adjuster 208, Parts Clerk 228, and Labor Clerk 240 or printed as a Final Estimate Report as depicted in FIGS. 55, 55A, 55B, 55C, 55D, 55E, and 55F on Network Printer 256. Outside Adjuster 102 returns to the “Home Page” by saying “Home”.

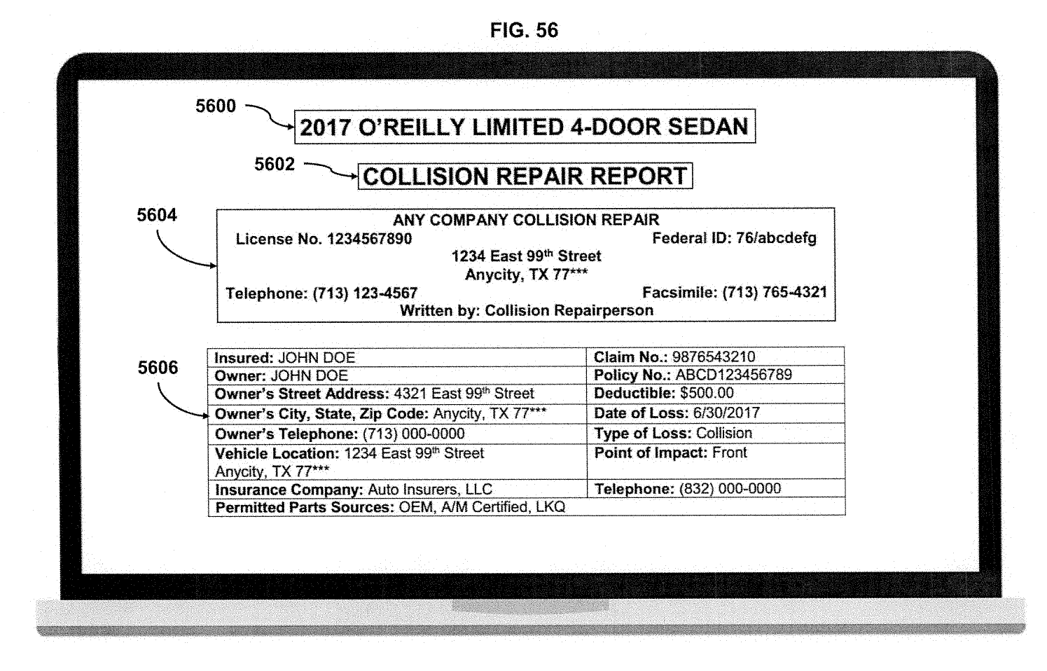

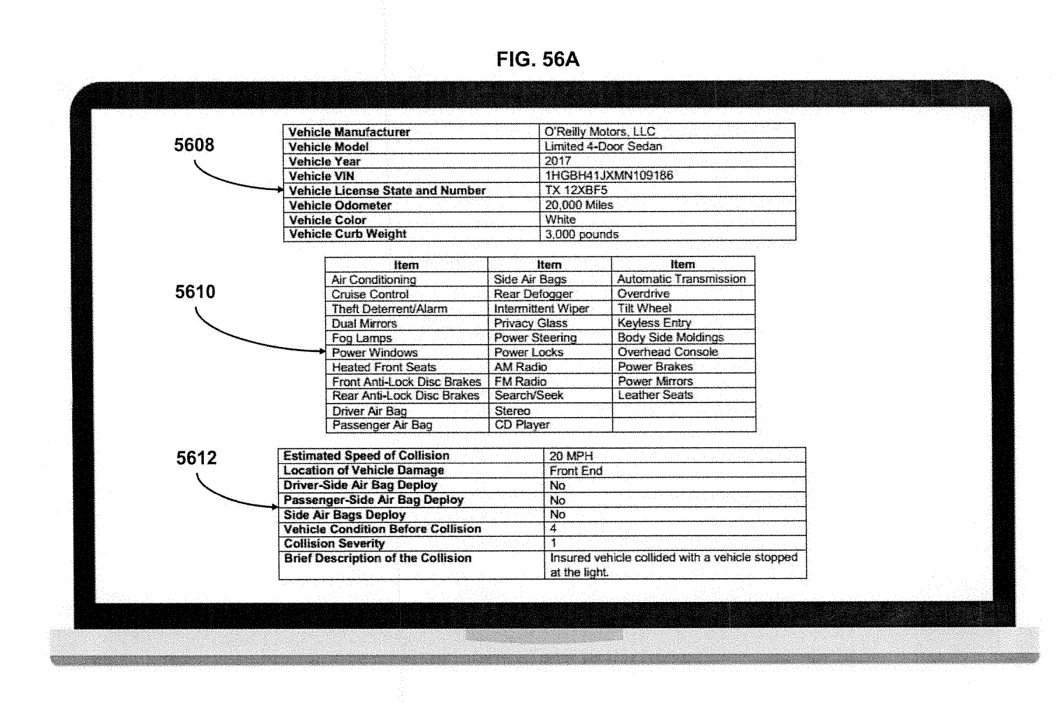

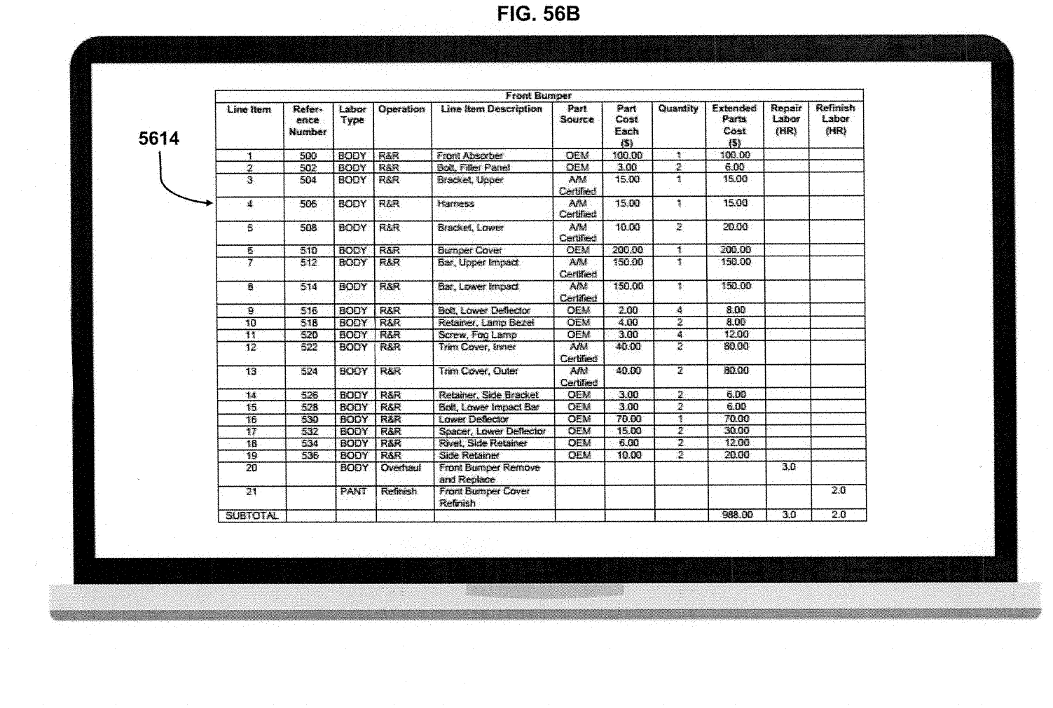

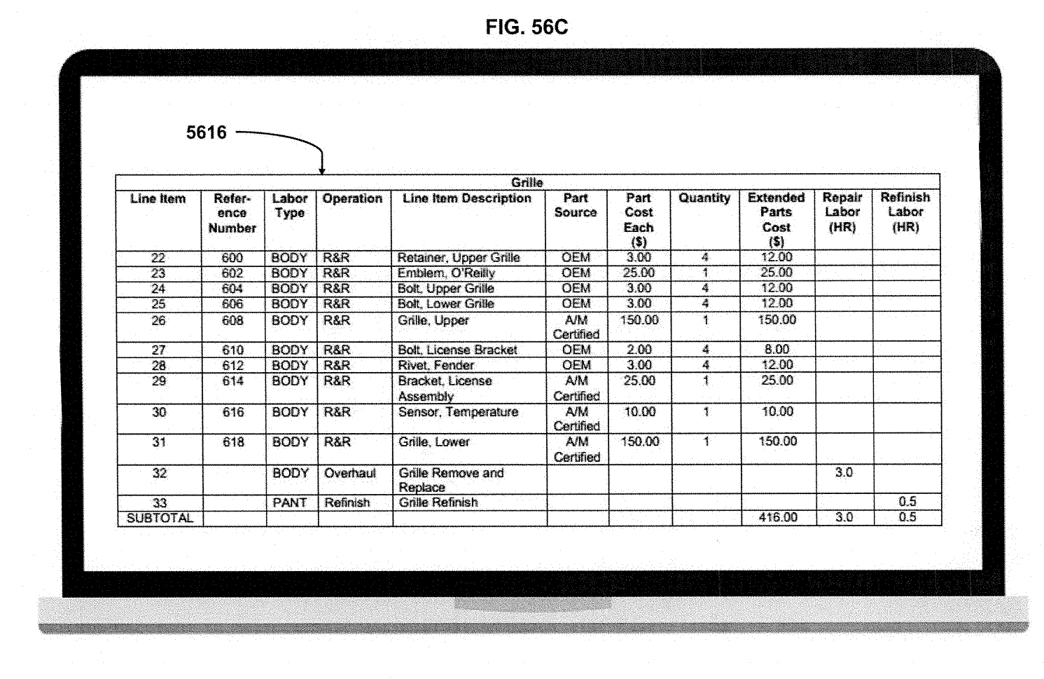

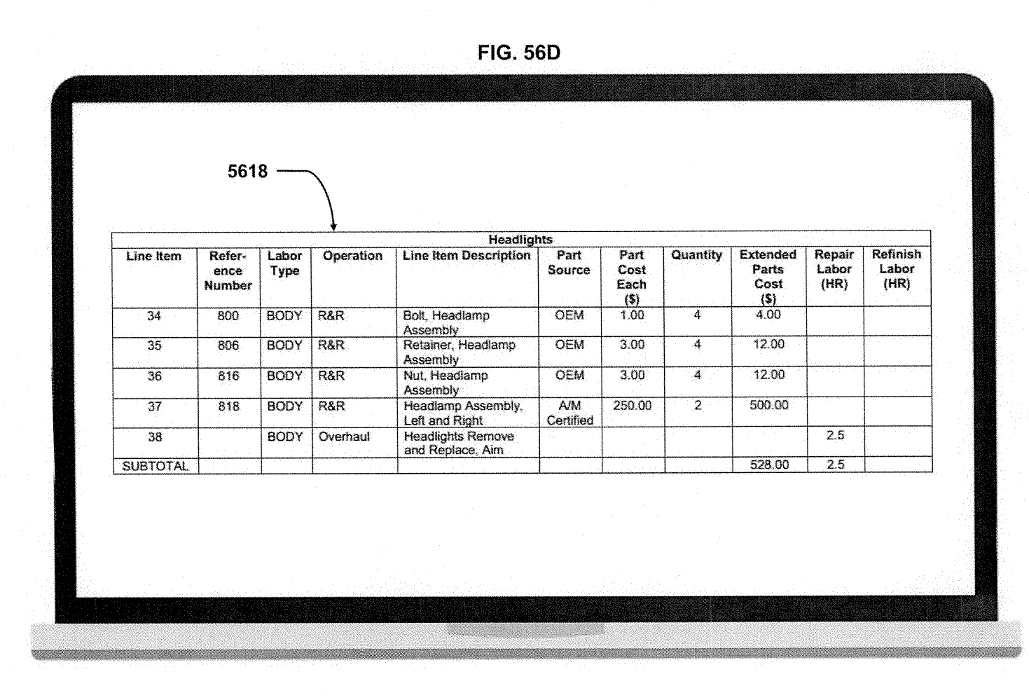

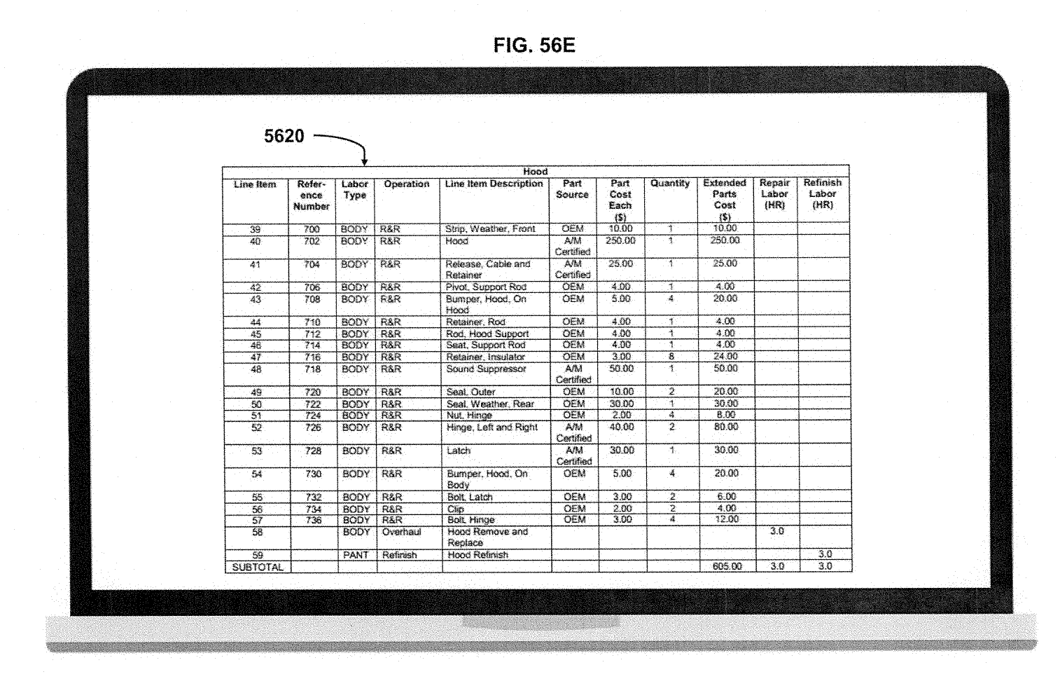

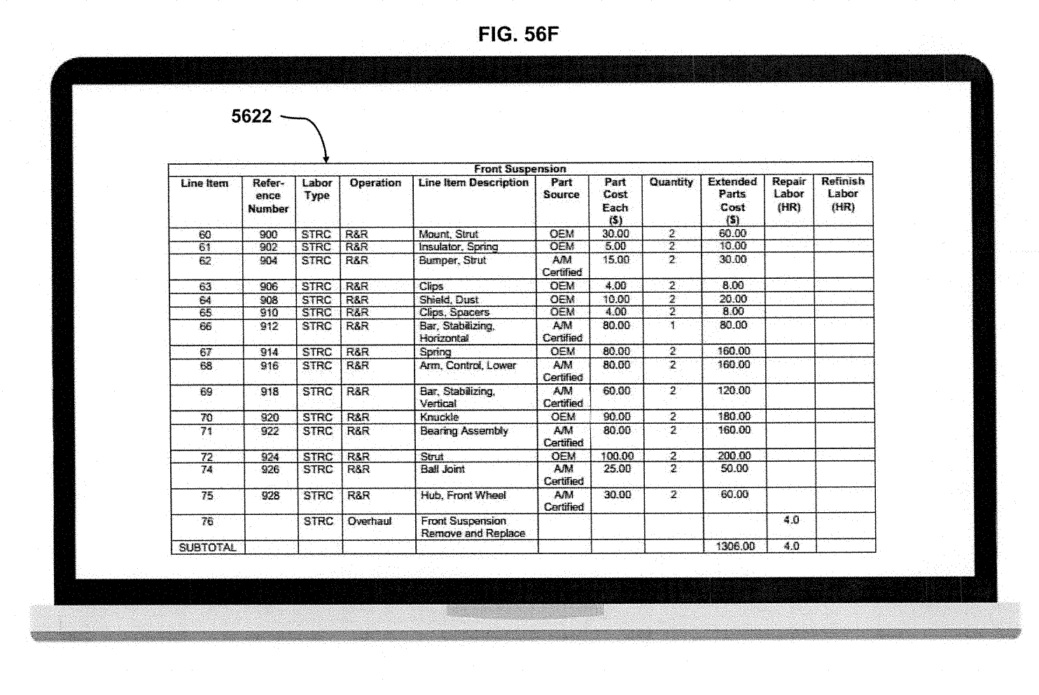

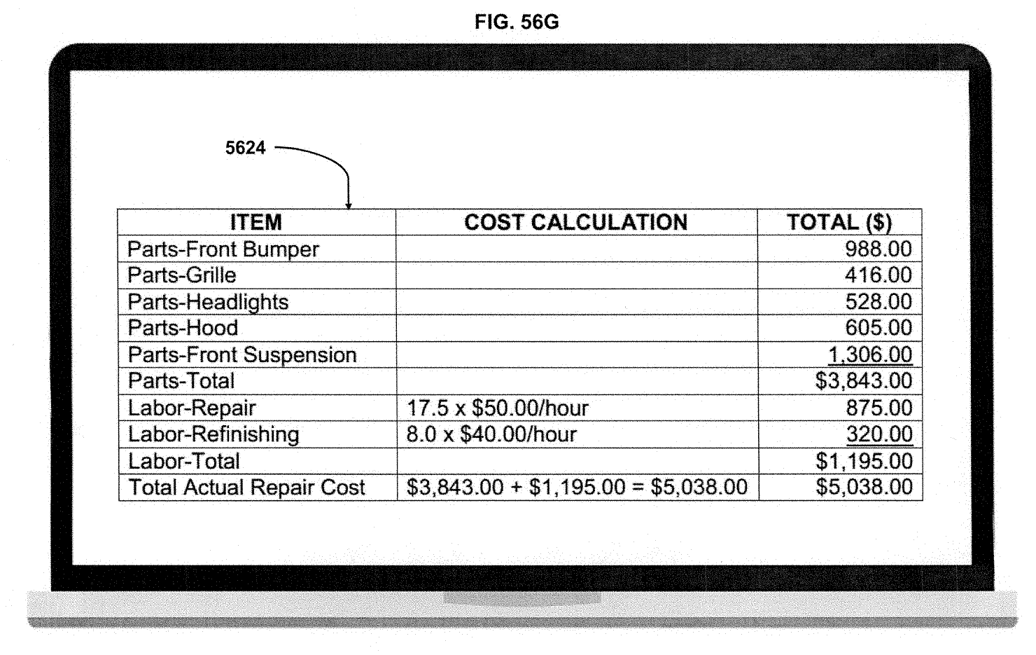

Once the “Final Estimate Report” is saved to the Vehicle Estimating Server 202, Inside Adjuster 208 assigns it to one of a plurality of vehicle collision repair shops, such as Shop 250, according to instructions from the insured or the insurance company. The 2017 O'Reilly repair results in an actual list of parts and the labor required for the repair which Shop Technician 254 reports in a Collision Repair Report. The report is now available to Outside Adjuster 102 as a Comparator Vehicle in future estimates. If Outside Adjuster 102, selects the repaired 2017 O'Reilly as a Comparator Vehicle, its Collision Repair Report will be displayed to him as Boxes 5600, 5602, and 5604 and Table 5606 in FIG. 56, Tables 5608, 5610, and 5612 in FIG. 56A, Table 5614 in FIG. 56B, Table 5616 in FIG. 56C, Table 5618 in FIG. 56D, Table 5620 in FIG. 56E, Table 5622 in FIG. 56F, and Table 5624 in FIG. 56G.

Persons of skill in the art of selecting, connecting, and in the loading and operating the software for computer network hardware would understand that the system and method of using the system described in the preferred embodiment can vary and still remain within the invention herein described. Variations obvious to those persons skilled in the art are included in the invention.

For example, Outside Adjuster 102 could complete the First Estimate and the Final Estimate by filling out written forms. Alternatively, a handheld digital device such as a tablet computer could allow direct entry by hand of data into virtual record sheets. The mode of data entry can vary according to methods known to persons of skill in the art of vehicle collision repair estimating and still be included in the invention described herein.

The computer network shown in FIG. 2 can be arranged in many different ways with lesser or more servers, network switches, routers, and cables and still enable a person with skill in the art to practice the invention.

This written description uses examples to disclose the invention, including the preferred embodiment, and also to enable a person of ordinary skill in the relevant art to practice the invention, including making and using any devices or systems and performing any incorporated methods. The patentable scope of the invention is defined by the claims, and may include other examples that occur to those person of ordinary skill in the art. Such other examples are intended to be within the scope of the claims if they have structural elements that do not differ from the literal language of the claims, or if they include equivalent structural elements with insubstantial differences from the literal language of the claims.

Further, multiple variations and modifications are possible in the embodiments of the invention described here. Although a certain illustrative embodiment of the invention has been shown and described here, a wide range of modifications, changes, and substitutions is contemplated in the foregoing disclosure. In some instances, some features of the present invention may be employed without a corresponding use of the other features; such as for condition reporting and mechanical repair estimating. Accordingly, it is appropriate that the foregoing description be construed broadly and understood as being given by way of illustration and example only, the spirit and scope of the invention being limited only by the appended claims.

I claim:

1. A system for reducing the time to estimate and repair a damaged vehicle, said system comprising:
(a) a plurality of computer servers, a first plurality of computer workstations, a second plurality of computer workstations, a plurality of portable computing devices, a plurality of network printers, a plurality of network switches, and a plurality of routers, wherein;
(1) said plurality of computer servers, said first plurality of computer workstations, said plurality of network printers, said plurality of network switches, and said plurality of routers are connected to each other by a plurality of computer network cables;
(2) said plurality of portable computing devices, and said second plurality of computer workstations are connected to an interne by a wireless technology to the plurality of routers and further connected to the plurality of computer servers by the plurality of the network switches and said plurality of computer network cables;
(b) the plurality of computer servers, the first plurality of computer workstations, the second plurality of computer workstations, and the plurality of portable computing devices, are installed with a network operating system;
(c) the plurality of computer servers, the first plurality of computer workstations, the second plurality of computer workstations, and the plurality of portable computing devices, are programmed with a software for database management;
(d) the plurality of portable computing devices is further programmed with a software for speech recognition;
(e) said software for database management is populated with a plurality of data sets;
(f) said software for database management is programmed with a first algorithm;
(g) the software for database management is programmed with a second algorithm;
(h) the software for database management facilitates a cooperation between said plurality of data sets;
whereby said cooperation results in said reducing the time to estimate and repair said damaged vehicle.

2. The system of claim 1, wherein:
(a) a first one of the plurality of computer servers is a vehicle information server and a first one of the first plurality of computer workstations is an inside adjuster workstation;
(1) said vehicle information server connected to said inside adjuster workstation by a network cable 1;
(b) a second one of the plurality of computer servers is a parts server and a second one of the first plurality of computer workstations is a parts workstation;
(1) said parts server connected to said parts workstation by a network cable 2;
(c) a third one of the plurality of computer servers is a labor server and a third one of the first plurality of computer workstations is a labor workstation;
(1) said labor server connected to said labor workstation by a network cable 3;
(d) a fourth one of the plurality of computer servers is a shop server and a first one of the second plurality of computer workstations is a shop workstation;
(1) said shop workstation connected by a wireless technology to a router 1;
(e) a fifth one of the plurality of computer servers is a vehicle estimating server;
(f) a first one of the plurality of network printers is a network printer 1;
(g) a first one of the plurality of portable computing devices is an outside adjuster's portable computing device;
(1) said outside adjuster's portable computing device connected by said wireless technology to the router 1;
(h) a first one of the plurality of network switches is a network switch 1;
(1) said network switch 1 connected to the router 1 by a network cable 4;
(2) the network switch 1 connected to the vehicle information server by a network cable 5;
(3) the network switch 1 connected to the parts server by a network cable 6;
(4) the network switch 1 connected to the shop server by a network cable 7;
(5) the network switch 1 connected to the vehicle estimating server by a network cable 8;
(6) the network switch 1 connected to the labor server by a network cable 9;
(7) the network switch 1 connected to said network printer 1 by a network cable 10;
(i) the inside adjuster's workstation, the parts workstation, the labor workstation, the shop workstation, the vehicle information server, the parts server, the labor server, the shop server, the vehicle estimating server, the outside adjuster's portable computing device, are programmed with a software for database management;
(j) the outside adjuster's portable computing device is further programmed with a software for speech recognition;
(k) said software for database management programmed with a plurality of data sets, wherein;
(1) said software for database management facilitates a cooperation in the sharing of said plurality of data sets between the inside adjuster's workstation, the parts workstation, the labor workstation, the shop workstation, the vehicle information server, the parts server, the labor server, the shop server, the vehicle estimating server, and the outside adjuster's portable computing device.

3. The system of claim 1, wherein the plurality of data sets is:
(a) a first data set comprises a table containing original equipment manufacturers' models of automobiles they manufacture currently and in the past;
(b) a second data set comprises numerous tables containing images of parts and parts costs in current dollars for a plurality of manufacturers' vehicle makes, models, and model years;
(c) a third data set comprises numerous tables containing images of parts and parts costs in dollars for each of the manufacturers' vehicle makes, models, and model years for vehicles that have been repaired;
(d) a fourth data set comprises numerous tables containing descriptions of repair work commonly associated with collision damage repair, corresponding abbreviations used in estimating reports for the repair work, operations commonly associated with each repair work, and estimating and individual shop labor rates for repair and refinishing;
(e) a fifth data set comprises tables containing an insured's information when an insured's claim is entered;
(f) a sixth data set comprises tables containing details regarding the vehicle whose collision damage is to be repaired;
(g) a seventh data set comprises tables containing the options available on the vehicle whose collision damage is to be repaired;
(h) an eighth data set comprises tables containing the details of the collision, a preliminary assessment of the vehicle's condition before the collision, and an estimate of the collision severity, for the vehicle whose collision damage is to be repaired;
(i) a ninth data set comprises tables containing details regarding the claim for a vehicle whose collision damage has been repaired;
(j) a tenth data set comprises tables containing details regarding the vehicle whose collision damage has been repaired;
(k) an eleventh data set comprises tables containing the options available on the vehicle whose collision damage has been repaired;
(l) a twelfth data set comprises tables containing the details of the collision, a preliminary assessment of the vehicle's condition before the collision, and an estimate of the collision severity, for the vehicle whose collision damage has been repaired;
(m) a thirteenth data set comprises tables containing the actual parts used in the repair, the parts costs, the labor hours and labor rates for repair, painting, and other repair services, and the total cost for the repair for vehicles whose collision damage has been repaired;
(n) a fourteenth data set comprises tables populated by the first algorithm;
(o) a fifteenth data set comprises tables containing the major damaged areas, the parts to repair each damaged area, the parts costs, the labor types, the operations, the labor hours and labor rates for repair, painting, and other repair services, and the total cost of a first estimate for the repair of a damaged vehicle;
(p) a sixteenth data set comprises tables containing the major damaged areas, the parts to repair each damaged area, the parts costs, the labor types, the operations, the labor hours and labor rates for repair, painting, and other repair services, and the total cost of a final estimate for the repair of a damaged vehicle.

4. The system in claim 1, wherein the network operating system is Microsoft Windows Server.

5. The system of claim 1, wherein the software for database management comprises one selected from;
(a) IBM DB2;
(b) Microsoft Access;
(c) Microsoft SQL Server;
(d) Oracle RDBMS.

6. The system of claim 1, wherein the software for speech recognition comprises one selected from;
(a) Nuance Dragon NaturallySpeaking Premium 12;
(b) Windows Speech Recognition;
(c) Google Voice Search;
(d) Dragon NaturallySpeaking Premium;
(e) Tazti.

7. The system of claim 1, wherein the damaged vehicle is selected from a group comprising;
(a) an automobile;
(b) a truck;
(c) a wheeled commercial equipment;
(d) a heavy truck;
(e) a power sport vehicle;
(f) an earth-moving vehicle;
(g) a marine vehicle;
(h) a recreational vehicle; and
(i) a motorcycle.

8. A method for reducing the time to estimate and repair a damaged vehicle, said method comprising the steps of:
(a) assembling a computer network, wherein;
(1) a least one member of said computer network is a portable computing device;
(b) installing the computer network with a network operating system;
(c) installing the computer network with a software for database management;
(d) populating said software for database management with a plurality of data sets;
(e) installing said portable computing device with a software for speech recognition;
(1) providing an outside adjuster with the portable computing device;
(g) enlisting said outside adjuster to make a first estimate to repair said damaged vehicle, wherein;
(1) said first estimate is made by the outside adjuster populating an at least one of said plurality of data sets;
(2) said at least one of the plurality of data sets is populated by the outside adjuster speaking to the portable computing device; and
(3) the first estimate comprises;
(A) a set of first estimate parts, a first estimate of repair hours, a first estimate of refinish hours, and a first estimate of total repair cost;
(h) identifying a set of comparator vehicles based on a first algorithm, wherein;
(1) said set of comparator vehicles have been damaged;
(2) the set of comparator vehicles have been repaired;
(i) selecting a comparator vehicle from the set of comparator vehicles, wherein;
(1) said comparator vehicle is selected based on a second algorithm; and
(2) a set of comparator parts, a set of comparator repair hours, a set of comparator refinish hours, and a total comparator repair cost are known for the comparator vehicle;
(j) enlisting the outside adjuster to iteratively and immediately make a final estimate to repair the damaged vehicle, wherein;
(1) said final estimate is made by the outside adjuster populating an at least another one of said plurality of data sets;
(2) said at least another one of the plurality of data sets is populated by the outside adjuster speaking to the portable computing device;
(3) the final estimate comprises;
(A) a set of final estimate parts, a final estimate of repair hours, a final estimate of refinish hours, and a final estimate of total repair cost;
(4) the final estimate is based in part on said set of comparator parts, said set of comparator repair hours, said set of comparator refinish hours, and said total comparator repair cost; and
(5) the second estimate more accurately estimates the cost to repair the damaged vehicle;
(k) communicating the final estimate made by the outside adjuster to an inside adjuster;
(1) communicating the final estimate to a plurality of vehicle repair shops by said inside adjuster;
(m) selecting by the inside adjuster a vehicle repair shop from said plurality of vehicle repair shops;
(n) repairing the damaged vehicle by said vehicle repair shop, wherein;
(1) the vehicle repair shop makes the repair without a supplement;
(2) the vehicle repair shop records a set of actual parts, an actual number of repair hours, an actual number of refinish hours, and a total actual repair cost;
(o) returning the damaged vehicle to its owner;
(p) adding the damaged vehicle to the set of comparator vehicles, wherein;
(1) the set of comparator vehicles is incrementally increased by the addition of the damaged vehicle;
whereby reducing the time to estimate and repair the damaged vehicle.

9. The method of claim 8, wherein assembling the computer network comprises the steps of:
(a) connecting a first plurality of computer workstations to a plurality of computer servers with;
(1) a plurality of computer network cables; and
(2) a plurality of network switches;
(b) connecting a second plurality of computer workstations to an internet with;
(1) a wireless technology;
(c) connecting a plurality of portable computing devices to said internet with;
(1) said wireless technology;
(d) connecting the internet to a plurality of routers;
(e) connecting said plurality of routers to said computer servers with;
(1) said plurality of computer network cables; and
(2) said plurality of network switches.

10. The method of claim 8, wherein the network operating system is Microsoft Windows Server.

11. The method of claim 8, wherein the software for database management comprises one selected from;
(a) IBM DB2;
(b) Microsoft Access;
(c) Microsoft SQL Server;
(d) Oracle RDBMS.

12. The method of claim 8, wherein the plurality of data sets comprises;
(a) a first data set comprises a table containing original equipment manufacturers' models of automobiles they manufacture currently and in the past;
(b) a second data set comprises numerous tables containing images of parts and parts costs in current dollars for a plurality of manufacturers' vehicle makes, models, and model years;
(c) a third data set comprises numerous tables containing images of parts and parts costs in dollars for each of the manufacturers' vehicle makes, models, and model years for vehicles that have been repaired;
(d) a fourth data set comprises numerous tables containing descriptions of repair work commonly associated with collision damage repair, corresponding abbreviations used in estimating reports for the repair work, operations commonly associated with each repair work, and estimating and individual shop labor rates for repair and refinishing;
(e) a fifth data set comprises tables containing an insured's information when an insured's claim is entered;
(f) a sixth data set comprises tables containing data regarding the vehicle whose collision damage is to be repaired;
(g) a seventh data set comprises tables containing the options available on the vehicle whose collision damage is to be repaired;
(h) an eighth data set comprises tables containing data regarding the collision, a preliminary assessment of the vehicle's condition before the collision, and an estimate of the collision severity, for the vehicle whose collision damage is to be repaired;
(i) a ninth data set comprises tables containing data regarding the claim for a vehicle whose collision damage has been repaired;
(j) a tenth data set comprises tables containing data regarding the vehicle whose collision damage has been repaired;
(k) an eleventh data set comprises tables containing the options available on the vehicle whose collision damage has been repaired;
(l) a twelfth data set comprises tables containing data regarding the collision, a preliminary assessment of the vehicle's condition before the collision, and an estimate of the collision severity, for the vehicle whose collision damage has been repaired;
(m) a thirteenth data set comprises tables containing the actual parts used in the repair, the parts costs, the labor hours and labor rates for repair, painting, and other repair services, and the total cost for the repair for vehicles whose collision damage has been repaired;
(n) a fourteenth data set comprises tables populated by a first algorithm;
(o) a fifteenth data set comprises tables containing the major damaged areas, the parts to repair each damaged area, the parts costs, the labor types, the operations, the labor hours and labor rates for repair, painting, and other repair services, and the total cost of the first estimate for the repair of a damaged vehicle;
(p) a sixteenth data set comprises tables containing the major damaged areas, the parts to repair each damaged area, the parts costs, the labor types, the operations, the labor hours and labor rates for repair, painting, and other repair services, and the total cost of the final estimate for the repair of a damaged vehicle.

13. The method of claim 8, wherein the first algorithm populates the fourteenth data set with data comprising;
(a) a manufacturer's name;
(b) a model year;
(c) an odometer reading in miles on the date of collision;
(d) a curb weight in pounds;
(e) a damage location;
(f) a collision speed;
(g) a driver air-bag deployed;
(h) a passenger air-bag deployed; and
(i) a side air-bag deployed.

14. The method of claim 8, wherein the second algorithm comprises the steps of;
(a) calculating an unknown A, where A equals 10 if the manufacturer of a damaged vehicle and a comparator vehicle are the same, A equals 0 in all other instances;
(b) calculating an unknown B, where B equals 10 if the model of said damaged vehicle and said comparator vehicle are the same, B equals 0 in all other instances;
(c) calculating an unknown C, where C is an integer from 0 to 10, wherein if the year of manufacture of the damaged vehicle and the comparator vehicle are the same C equals 10 and for each one-year the damaged vehicle's year of manufacture differs from the comparator vehicle's year of manufacture 1 is subtracted from 10;
(d) calculating an unknown D, where D is an integer from 0 to 10, wherein if the odometer reading of the damaged vehicle and the comparator vehicle are the same D equals 10 and for each 1,000 miles the damaged vehicle's odometer reading differs from the comparator vehicle's odometer reading 1 is subtracted from 10;
(e) calculating an unknown E, where E is an integer from 0 to 10, wherein if the curb weight of the damaged vehicle and comparator vehicle are the same E equals 10 and for each 100 pounds the damage vehicle's curb weight differs from the comparator vehicle's curb weight 1 is subtracted from 10;
(1) calculating an unknown F, where F is an integer from 0 to 10, wherein if the collision speeds of the damaged vehicle and comparator vehicle are the same F equals 10 and for each 2 miles per hour the damaged vehicle's collision speed differs from the comparator vehicle's collision speed 1 is subtracted from 10;
(g) calculating an unknown G, where G equals 10 if the location of damage on the damaged vehicle and comparator vehicle are the same, G equals 0 in all other instances;
(h) calculating an unknown H, where H equals 10 if the driver air-bag deployed in the damaged vehicle and comparator vehicle, H equals 0 in all other instances;
(i) calculating an unknown I, where I equals 10 if the passenger air-bag deployed in the damaged vehicle and comparator vehicle, I equals 0 in all other instances;
(j) calculating an unknown J, where J equals 10 if the side air-bags deployed in the damaged vehicle and comparator vehicle, J equals 0 in all other instances;
(k) calculating a total rank, wherein the total rank equals the sum of A, B, C, D, E, F, G, H, I, and J.

15. The method of claim 8, wherein the outside adjuster performs the steps of;
(a) making an inspection of the damaged vehicle;
(b) speaking to the portable computing device to enter a set of damaged areas resulting from said inspection;
(c) speaking to the portable computing device to select from the plurality of data sets;
(1) a first plurality of images, wherein;
(A) said first plurality of images comprises said set of damaged areas;
(2) a first plurality of parts, wherein;
(A) said first plurality of parts correspond to the first plurality of images, wherein;
(I) a cost of the first plurality of parts is comprised of;
(a) a cost for original equipment replacement parts;
(b) a cost for aftermarket replacement parts;
(c) a cost for aftermarket certified replacement parts;
(d) a cost for like kind and quality replacement parts;
(3) a first plurality of labor types, wherein;
(A) said first plurality of labor types are those required to repair the set of damaged areas;
(4) a first plurality of operations, wherein;
(A) said first plurality of operations correspond to the first plurality of labor types;
(5) a first plurality of hourly costs, wherein;
(A) said first plurality of operations correspond to the first plurality of labor types;
(d) speaking to the portable computing device to make a first estimate to repair the set of damaged areas by;
(1) parsing the first plurality of images into a series of individual parts to repair the set of damaged areas;
(2) parsing said series of individual parts into groups comprising;
(A) a first group of original equipment replacement parts;
(B) a first group of aftermarket replacement parts;
(C) a first group of aftermarket certified replacement parts;
(D) a first group of kind and quality replacement parts;
(3) parsing the first plurality of labor types into a series of labor types, whereby;
(A) said series of labor types correspond to the series of individual parts;
(4) parsing the first plurality of operations into a series of operations, whereby;
(A) said series of operations correspond to the series of labor types;
(5) calculating a first parts cost by summing;
(A) a first cost of original equipment replacement parts, wherein;
(I) said first cost of original equipment replacement parts is the product of said first group of original equipment replacement parts and said cost for original equipment replacement parts;
(B) a first cost of aftermarket replacement parts, wherein;
(I) said first cost of aftermarket replacement parts is the product of said first group of aftermarket replacement parts and said cost for aftermarket replacement parts;
(C) a first cost of aftermarket certified replacement parts, wherein;
(I) said first cost of aftermarket certified replacement parts is the product of said first group of aftermarket replacement parts times and said cost for aftermarket replacement parts; and
(D) a first cost of like kind and quality replacement parts, wherein;
(I) said first cost of like kind and quality replacement parts is the product of said first group of like kind and quality replacement parts and said cost for like kind and quality replacement parts;
(6) calculating a first repair labor cost;
(7) calculating a first refinishing labor cost;
(8) summing said first parts cost, said first repair labor cost, and first refinishing labor cost;
(e) speaking to the portable computing device to request a display of a plurality of comparator vehicles, wherein;
(1) said plurality of comparator vehicles suffered damage;
(2) said damage was repaired;
(3) a comparator parts cost, a comparator repair labor cost, and a comparator refinishing labor cost to repair the damage is known;
(4) the plurality of comparator vehicles is based on a measure of a set of preselected criteria to match the damaged vehicle;
(f) speaking to the portable computing device to select at least one of the plurality of comparator vehicles based on said set of preselected criteria;
(g) speaking to the portable computing device to make a final estimate to repair the set of damaged areas by;
(1) calculating a final parts cost based on said comparator parts cost;
(2) calculating a final repair labor cost based on said comparator repair labor cost;
(3) calculating a final refinishing labor cost based on said comparator refinishing labor cost;
(4) summing said final parts cost, said final repair labor cost, and final refinishing labor cost;
(h) speaking to the portable computing device to instruct it to save said final estimate to repair the set of damaged areas.

16. A method for reducing the time for an outside adjuster to estimate the cost to repair a damaged vehicle, said method comprising the steps of:
(a) providing said outside adjuster with a portable computing device;
(b) installing said portable computing device with a first software for speech recognition;
(c) installing the portable computing device with a second software to communicate with an internet;
(d) inspecting said damaged vehicle;
(e) identifying a set of areas requiring repair on the damaged vehicle;
(f) speaking to the portable computing device to make an estimate of the cost to repair said set of areas requiring repair;
(g) communicating said estimate to an inside adjuster through said internet;
thereby reducing the time for the outside adjuster to estimate the cost to repair the damaged vehicle.

17. The method of claim 16, wherein the damaged vehicle is one selected from a group comprising;
(a) an automobile;
(b) a truck;
(c) a wheeled commercial equipment;
(d) a heavy truck;
(e) a power sport vehicle;
(f) an earth-moving vehicle;
(g) a marine vehicle;
(h) a recreational vehicle; and
(i) a motorcycle.

18. The method of claim 16, wherein the first software for speech recognition comprises one selected from;
(a) Nuance Dragon NaturallySpeaking Premium 12;
(b) Windows Speech Recognition;
(c) Google Voice Search;
(d) Dragon NaturallySpeaking Premium; or
(e) Tazti.
